(19) United States
(12) Patent Application Publication
(10) Pub. No.: US 2018/0000089 A1
(43) Pub. Date: Jan. 4, 2018

(54) NOVEL MICROBIOCIDES

(71) Applicant: Syngenta Participations AG, Basel (CH)

(72) Inventors: Daniel STIERLI, Stein (CH); Ramya RAJAN, Corlim IIhas (IN); Renaud BEAUDEGNIES, Stein (IN); Peter RENOLD, Stein (CH); Yann AMBACHER, Stein (CH)

(73) Assignee: Syngenta Participations AG, Basel (CH)

(21) Appl. No.: 15/542,684

(22) PCT Filed: Jan. 13, 2016
(86) PCT No.: PCT/EP2016/050578

§ 371 Date: Jul. 11, 2017

(30) Foreign Application Priority Data
Jan. 13, 2015 (IN) 112/DEL/2015

(51) Int. Cl. A01N 55/08; C07F 5/02

(52) U.S. Cl. CPC A01N 55/08; C07F 5/025

(57) ABSTRACT

Compounds of formula (I) are as defined in the claims, and their use in compositions and methods for the control and/or prevention of microbial infection, particularly fungal infection, in plants and to processes for the preparation of these compounds.

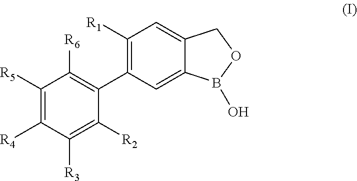

The present invention relates to novel microbiocidally active, in particular fungicidally active, oxoborazoles moiety containing compounds their use in compositions and methods for the control and/or prevention of microbial infection, particularly fungal infection, in plants or plant propagation material, harvested food crops by phytopathogenic microorganisms, preferably fungi and to processes for the preparation of these compounds. Preferably these compounds are used in agriculture or horticulture for controlling or preventing infestation of plants by phytopathogenic microorganisms, preferably fungi.

The incidence of serious microbial infections, particularly fungal infections, either systemic or topical, continues to increase for plants.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield of the crop and consequently, increase the value of the crop. Numerous fungicidal agents have been developed. However, the treatment of fungal infestations continues to be a major problem. Furthermore, fungicide resistance has become a serious problem, rendering these agents ineffective for some agricultural uses. As such, a need exists for the development of new fungicidal compounds with improved antifungal properties. It has been found that novel oxoborazoles with a specific substitution pattern are novel and have improved microbiocidal activity.

The present invention accordingly relates to a method for controlling or preventing for infestation of plants or plant propagation material and/or harvested food crops susceptible to microbial attack by treating plants or plant propagation material and/or harvested food crops with an effective amount of of benzoxaborole derivatives according to formula (I)

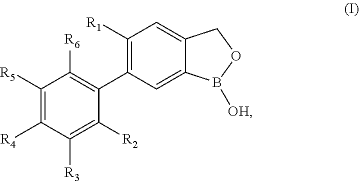

wherein
R₁ is selected from H, fluorine, chlorine, bromine, cyano, nitro, C₁-C₄alkyl which can be substituted by one to five R₉, C₁-C₄alkoxy which can be substituted by one to five R⁹, and C₁-C₄haloalkyl which can be substituted by one to five R₉ₐ;
R₂, R₃, R₄, R₅ and R₆ are independently selected from H, fluorine, chlorine, bromine, cyano, nitro, amino, hydroxyl, C₁-C₆alkyl which can be substituted by one to five R₉, C₁-C₆haloalkyl which can be substituted by one to five R₉ₐ, C₃-C₅cycloalky which can be substituted by one to five R₉, C₂-C₆alkenyl which can be substituted by one to five R₉, C₂-C₆alkynyl which can be substituted by one to five R₉, C₁-C₆alkoxy which can be substituted by one to five R₉, and C₁-C₆haloalkoxy which can be substituted by one to five R₉ₐ;
or R₂, R₃, R₄, R₅ and R₆ are independently selected from —NR₇R₈, C₃-C₆cycloalkyl, —C(O)(OH), —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —C(═N—O—(C₁₋₄ alkyl)-H, and —C(═N—O—(C₁₋₄ alkyl)-C₁-C₄alkyl;
or R₂, R₃, R₄, R₅ and R₆ are independently selected from a -X-(6 to 10 membered-aryl) group which can be substituted by one to five substituents selected halogen, C₁-C₄alkyl, C₁-C₄haloalkyl, C₁-C₄alkoxy, —CN, —NO₂, —NR⁶R⁷, C₃-C₆cycloalkyl;
or R₂, R₃, R₄, R₅ and R₆ are independently selected from a -X-linked-5- or 6-membered heteroaryl group which comprises one or two or three heteroatoms selected from or two N, O and S which can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
or R₂ and R₃, R₃ and R₄, R₄ and R₅, R₅ and R₆ can form a five- or six-membered annellated ring which comprises one or two or three heteroatoms selected from N, O and S and this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R⁷ and R⁸ are independently selected from H, —C₁₋₄alkyl —C₂₋₄alkenyl, —C₂₋₄alkynyl or combine with the interjacent nitrogen to form a five- or six-membered ring which may comprise one or two or three heteroatoms selected from N, O or S atoms in addition to the interjacent nitrogen atom this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R₉ is independently selected from halogen, C₁-C₄alkyl, C₁-C₄haloalkyl, C₁-C₄alkoxy, C₁-C₄haloalkoxy, —OH, —CN, —NO₂;
R₉ₐ is independently selected from C₁-C₄alkyl, C₁-C₄haloalkyl, C₁-C₄alkoxy, C₁-C₄haloalkoxy, —OH, —CN, —NO₂;
X is a direct bond or a bridge selected from —O—, —S(O)ₘ— or —NH—;
m is 0, 1 or 2;
and agronomically acceptable salts and N-oxides of those compounds.

The present invention accordingly further relates to a method for controlling or preventing of infestation of plants or plant propagation material and/or harvested food crops susceptible to microbial attack, preferably susceptible to fungicidal attack, by treating plants or plant propagation material and/or harvested food crops with an effective amount of of benzoxaborole derivatives according to formula (I).

The present invention accordingly further relates to the use of benzoxaborole derivatives according to formula (I) for controlling or preventing infestation of plants or plant propagation material and/or harvested food crops susceptible to microbial attack, preferably susceptible to fungicidal attack.

The present invention accordingly further relates to the use of benzoxaborole derivatives according to formula (I) and salts thereof for controlling or preventing infestation of plants or plant propagation material and/or harvested food crops by treating plants or plant propagation material and/or harvested food crops with an effective amount of an benzoxaborole of general formula (I).

Accordingly the present invention also relates to a method of protecting plant propagation material and organs that grow at a later point in time against damage phytopathogenic diseases, which method comprises applying to said propagation material a fungicidally effective amount of a compound of formula I.

In yet a further aspect of the invention, the invention provides plant propagation material treated with a plant propagation material protecting composition comprising a compound of formula (I).

A preferred embodiment of the invention relates to a method of controlling or preventing damage by phytopathogenic diseases in a growing plant or growing plant tissue said method comprising: applying onto the plant propagation material, before planting or sowing thereof a fungicidial effective amount of a compound of formula (I).

A method of controlling or preventing fungal diseases in a growing plant or growing plant tissue said method comprising: applying onto the plant propagation material before planting or sowing thereof a fungicidial effective amount of a compound of formula (I).

In a preferred embodiment the plant propagation material is a seed or a tuber. In a further preferred embodiment the plant propagation material is a seed. In a further preferred embodiment the plant propagation material is a tuber. Preferably the seeds and tubers (stem tubers and root tubers) according to this application are alive. Preferably the seeds and tubers according to this application are able to germinate.

In a further aspect of the invention, the invention provides a method of controlling or preventing damage by phytopathogenic diseases in a growing plant said method comprising applying onto the seed, before planting or sowing thereof a compound of formula (I).

In a further aspect of the invention, the invention provides a method of protecting plant propagation material and organs that grow at a later point in time against damage by phytopathogenic diseases, which method comprises applying to said propagation material a fungicidally effective amount of a compound of formula (I).

In a further aspect of the invention, the invention provides a plant propagation material comprising compound a compound of formula (I). Preferably the plant propargation material comprising a fungicidial effective amount of a compound of formula (I).

In a further aspect of the invention, the invention provides a coated plant propagation material coated with a compound of formula (I).

In a further aspect of the invention, the invention provides a coated plant propagation material coated with coating comprising a compound of formula (I) as defined in claim 1.

In a further aspect of the invention, the invention provides a plant propagation material comprising an outer coating characterized that the outer coating comprises a compound according to formula (I), preferably a seed comprising an outer coating characterized that the outer coating comprises a compound according to formula (I).

In a further aspect of the invention, the invention relates to the use of a compound of formula (I) in the preparation of a composition for coating a plant propagation material for the prevention or control of plant pathogenic fungi.

In a further aspect of the invention, the invention relates to a method of controlling or preventing infestation of plants or plant propagation material and/or harvested food crops susceptible to microbial attack by providing in a first step a agrochemical compositions according to the present invention comprising a compound of formula (I) and in a second step applying said composition to the plants or the locus thereof.

The compounds of formula (I) are applied by treating plant propagation material with a fungicidally effective amount of a compound of formula I. Preferably, compounds of formula (I) are applied by adhering compounds of formula (I) to plant propagation material in a fungicidally effective amount.

A preferred application method is seed treatment.

Where substituents are indicated as being optionally substituted, this means that they may or may not carry one or more identical or different substituents, e.g. one to three substituents. Normally not more than three such optional substituents are present at the same time. Where a group is indicated as being substituted, e.g. alkyl, this includes those groups that are part of other groups, e.g. the alkyl in alkoxy or phenyl in phenyloxy.

The number of substituents does not exceed the number of available C—H and N—H bonds, for example in the C₁-C₄alkoxy which can substituted by one to five R₉ has only one to three substituents if methoxy is meant.

The term “halogen” refers to fluorine, chlorine, bromine or iodine, preferably fluorine, chlorine or bromine.

Alkyl substituents can be straight-chained or branched. Alkyl on its own or as part of another substituent is, depending upon the number of carbon atoms mentioned, for example, methyl, ethyl, n-propyl, n-butyl, n-pentyl, n-hexyl and the isomers thereof, for example, iso-propyl, iso-butyl, sec-butyl, tert-butyl or iso-amyl.

Cycloalkyl includes cyclopropyl, cyclobutyl, cyclopentyl and cyclohexyl.

Alkenyl substituents can be in the form of straight or branched chains, and the alkenyl moieties, where appropriate, can be of either the (E)- or (Z)-configuration. Examples are vinyl and allyl. The alkenyl groups are preferably C₂-C₆, more preferably C₂-C₄ and most preferably C₂-C₃ alkenyl groups.

Alkynyl substituents can be in the form of straight or branched chains. Examples are ethynyl and propargyl. The alkynyl groups are preferably C₂-C₆, more preferably C₂-C₄ and most preferably C₂-C₃ alkynyl groups.

Haloalkyl groups may contain one or more identical or different halogen atoms and, for example, may stand for CH₂Cl, CHCl₂, CCl₃, CH₂F, CHF₂, CF₃, CF₃CH₂, CH₃CF₂, CF₃CF₂ or CCl₃CCl₂.

Haloalkenyl groups are alkenyl groups, respectively, which are substituted with one or more of the same or different halogen atoms and are, for example, 2,2-difluorovinyl or 1,2-dichloro-2-fluoro-vinyl.

Alkoxy means a radical —OR, where R is alkyl, e.g. as defined above. Alkoxy groups include, but are not limited to, methoxy, ethoxy, 1-methylethoxy, propoxy, butoxy, 1-methylpropoxy and 2-methylpropoxy.

Haloalkoxy means a radical —OR, where R is haloalkyl, e.g. is described above. Haloalkloxy groups include, but are not limited to, CH₂ClO, CHCl₂O, CCl₃O, CH₂FO, CHF₂O—, CF₃O—, CF₃CH₂O—, CH₃CF₂O or CCl₃CCl₂O—.

Cyano means a —CN group.

Amino means an —NH₂ group.

Hydroxyl or hydroxy stands for a —OH group.

Aryl means a ring system which can be mono-, bi- or tricyclic. Examples of such rings include phenyl, naphthalenyl, anthracenyl, indenyl or phenanthrenyl. A preferred aryl group is phenyl. Preferred optional substituents for aryl are halogen, cyano, hydroxyl, amino, nitro, C₁-C₆alkyl, C₁-C₆haloalkyl, C₃-C₆cycloalkyl, C₃-C₆halocycloalkyl, C₁-C₆alkoxy, C₁-C₆haloalkoxy, C₃-C₆cycloalkoxy, C₁-C₆alkylthio, C₁-C₆haloalkylthio, C₃-C₆cycloalkylthio, C₁-C₆alkylsulfinyl, C₁-C₆haloalkylsulfinyl, C₃-C₆cycloalkylsulfinyl, C₁-C₆alkylsulfonyl, C₁-C₆haloalkylsulfonyl, C₃-C₆cycloalkylsulfonyl, C₁-C₆alkylcarbonyl, C₂-C₆alkenyl, C₂-C₆haloalkenyl, C₂-C₆alkenyloxy, C₂-C₆alkenylthio, C₂-C₆haloalkenyloxy, C₂-C₆alkynyl, C₃-C₆cycloalkylC₂-C₆alkynyl, C₂-C₆alkynyloxy, C₂-C₆alkynyloxy, aryl, arylalkyl, aryloxy, arylthio, heteroaryl, heteroarylalkyl, heteroaryloxy and heteroarylthio, in which the aryl and heteroaryl groups are optionally substituted by one or more R⁵.

Heteroaryl stands for aromatic heterocyclic ring systems, which can be mono-, bi- or tricyclic and wherein at least one oxygen, nitrogen or sulfur atom is present as a ring member, which can be accompanied by other oxygen, nitrogen, sulphur atoms as ring members. Monocyclic and bicyclic aromatic ring systems are preferred. For example, monocyclic heteroaryl can be a 5- or 6-membered ring containing one to three heteroatoms selected from oxygen, nitrogen and sulfur, more preferably selected from nitrogen and sulfur. Bicyclic heteroaryl can be a 9- or 10-membered bicyclic ring containing one to five heteroatoms, preferably one to three heteroatoms, selected from oxygen, nitrogen and sulfur. Examples of heteroaryl are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, quinolinyl, isoquinolinyl, phthalazinyl, quinoxalinyl, quinazolinyl, cinnolinyl and naphthyridinyl. Heteroaryl rings do not contain adjacent oxygen ring atoms, adjacent sulfur ring atoms or adjacent oxygen and sulfur ring atoms. Preferred optional substituents for heteroaryl are halogen, cyano, hydroxyl, amino, nitro, C₁-C₆alkyl, C₁-C₆haloalkyl, C₃-C₆cycloalkyl, C₃-C₆halocycloalkyl, C₁-C₆alkoxy, C₁-C₆haloalkoxy, C₃-C₆cycloalkoxy, C₁-C₆alkylthio, C₁-C₆haloalkylthio, C₃-C₆cycloalkylthio, C₁-C₆alkylsulfinyl, C₁-C₆haloalkylsulfinyl, C₃-C₆cycloalkylsulfinyl, C₁-C₆alkylsulfonyl, C₁-C₆haloalkylsulfonyl, C₃-C₆cycloalkylsulfonyl, C₁-C₆alkylcarbonyl, C₂-C₆alkenyl, C₂-C₆haloalkenyl, C₂-C₆alkenyloxy, C₂-C₆alkenylthio, C₂-C₆haloalkenyloxy, C₂-C₆alkynyl, C₃-C₆cycloalkylC₂-C₆alkynyl, C₂-C₆alkynyloxy, C₂-C₆alkynyloxy, aryl, arylalkyl, aryloxy, arylthio, heteroaryl, heteroarylalkyl, heteroaryloxy and heteroarylthio, in which the aryl and heteroaryl groups are optionally substituted by one or more R⁵.

The presence of one or more possible asymmetric carbon atoms in a compound of formula (I) means that the compounds may occur in optically isomeric forms, i.e. enantiomeric or diastereomeric forms. Also atropisomers may occur as a result of restricted rotation about a single bond. Formula (I) is intended to include all those possible isomeric forms and mixtures thereof. The present invention includes all those possible isomeric forms and mixtures thereof for a compound of formula (I). Likewise, formula (I) is intended to include all possible tautomers. The present invention includes all possible tautomeric forms for a compound of formula (I).

In each case, the compounds of formula (I) according to the invention are in free form, in oxidized form as a N-oxide or in salt form, e.g. an agronomically usable salt form.

N-oxides are oxidized forms of tertiary amines or oxidized forms of nitrogen containing heteroaromatic compounds. They are described for instance in the book “Heterocyclic N-oxides” by A. Albini and S. Pietra, CRC Press, Boca Raton 1991.

Suitable salts of the compounds, thus agronomically usable salts of compounds of formula (I) include acid addition salts such as those with an inorganic acid such as hydrochloric, hydrobromic, sulphuric, nitric or phosphoric acid, or an organic carboxylic acid such as oxalic, tartaric, lactic, butyric, toluic, hexanoic or phthalic acid, or a sulphonic acid such as methane, benzene or toluene sulphonic acid. Other examples of organic carboxylic acids include haloacids such as trifluoroacetic acid.

The term “fungicide” as used herein means a compound that controls, modifies, or prevents the growth of fungi. The term “fungicidally effective amount” means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection.

The term “herbicide” as used herein means a compound that controls or modifies the growth of plants.

The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.

The term “insecticide” as used herein means a compound that controls or modifies the growth of insects. The term “insecticidally effective amount” means the quantity of such a compound or combination of such compounds that is capable of killing, controlling, or infecting insects, retarding the growth or reproduction of insects, reducing an insect population, and/or reducing damage to plants caused by insects.

The term “locus” as used herein means fields in or on which plants are growing, or where seeds of cultivated plants are sown, or where seed will be placed into the soil. It includes soil, seeds, and seedlings, as well as established vegetation.

The term “metabolism” as used herein means the conversion or breakdown of a substance from one form to another by a living organism.

The term “nematicide” as used herein means a compound that controls or modifies the growth of nematodes. The term “nematicidally effective amount” means the quantity of such a compound or combination of such compounds that is capable of killing, controlling, or infecting nematodes, retarding the growth or reproduction of nematodes, reducing a nematode population, and/or reducing damage to plants caused by nematodes.

A nematicidally effective amount” as used herein refers to an amount of nematicide capable of killing, controlling, or infecting nematodes, retarding the growth or reproduction of nematodes, reducing a nematode population, and/or reducing damage to plants caused by nematodes The term “plants” refers to all physical parts of a plant, including seeds, seedlings, saplings, roots, tubers, stems, stalks, foliage, and fruits.

The following list provides definitions, including preferred definitions, for substituents R₁, R₂, R₃, R₄, R₅, R₆, R₇, R₈, R₉ and R₉ₐ a with reference to compounds of formula (I). For any one of these substituents, any of the definitions given below can be combined with any definition of any other substituent given below or elsewhere in this document.

The present invention further provides a compound of formula (I)

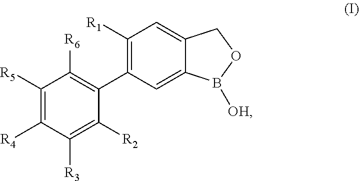

wherein
R₁ is selected from fluorine, chlorine, bromine, cyano, nitro, C₁-C₄alkyl which can be substituted by one to five R₉, C₁-C₄alkoxy which can be substituted by one to five R⁹, and C₁-C₄haloalkyl which can be substituted by one to five R₉ₐ;
R₂, R₃, R₄, R₅ and R₆ are independently selected from H, fluorine, chlorine, bromine, cyano, nitro, amino, hydroxyl, C₁-C₆alkyl which can be substituted by one to five R₉, C₁-C₆haloalkyl which can be substituted by one to five R₉ₐ, C₃-C₅cycloalky which can be substituted by one to five R₉, C₂-C₆alkenyl which can be substituted by one to five R₉, C₂-C₆alkynyl which can be substituted by one to five R₉, C₁-C₆alkoxy which can be substituted by one to five R₉, and C₁-C₆haloalkoxy which can be substituted by one to five R₉ₐ;
or R₂, R₃, R₄, R₅ and R₆ are independently selected from —NR₇R₈, C₃-C₆cycloalkyl, —C(O)(OH), —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —C(═N—O—(C₁₋₄ alkyl)-H, and —C(═N—O—(C₁₋₄ alkyl)-C₁-C₄alkyl;
or R₂, R₃, R₄, R₅ and R₆ are independently selected from a -X-(6 to 10 membered-aryl) group which can be substituted by one to five substituents selected halogen, C₁-C₄alkyl, C₁-C₄haloalkyl, C₁-C₄alkoxy, —CN, —NO₂, —NR⁶R⁷, C₃-C₆cycloalkyl;
or R₂, R₃, R₄, R₅ and R₆ are independently selected from a -X-linked-5- or 6-membered heteroaryl group which comprises one or two or three heteroatoms selected from or two N, O and S which can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
or R₂ and R₃, R₃ and R₄, R₄ and R₅, R₅ and R₆ can form a five- or six-membered annellated ring which comprises one or two or three heteroatoms selected from N, O and S and this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R⁷ and R⁸ are independently selected from H, —C₁₋₄alkyl —C₂₋₄alkenyl, —C₂₋₄alkynyl or combine with the interjacent nitrogen to form a five- or six-membered ring which may comprise one or two or three heteroatoms selected from N, O or S atoms in addition to the interjacent nitrogen atom this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R₉ is independently selected from halogen, C₁-C₄alkyl, C₁-C₄haloalkyl, C₁-C₄alkoxy, C₁-C₄haloalkoxy, —OH, —CN, —NO₂;
R₉ₐ is independently selected from C₁-C₄alkyl, C₁-C₄haloalkyl, C₁-C₄alkoxy, C₁-C₄haloalkoxy, —OH, —CN, —NO₂;
X is a direct bond or a bridge selected from —O—, —S(O)ₘ— or —NH—;
m is 0, 1 or 2;
and agronomically acceptable salts and N-oxides of those compounds.

Preferably R₁ is fluorine, chlorine, bromine, cyano, nitro, C₁-C₄alkyl;

More preferably R₁ is fluorine, chlorine, bromine, cyano;

Most preferably R¹ is fluorine, chlorine

In one embodiment R₂, R₃, R₄, R₅ and R₆ are independently selected from H, fluorine, chlorine, bromine, cyano, nitro, amino, hydroxyl, C₁-C₆alkyl which can be substituted by one to five R₉, C₁-C₆haloalkyl which can be substituted by one to five R₉ₐ, C₃-C₅cycloalky which can be substituted by one to five R₉, C₂-C₆alkenyl which can be substituted by one to five R₉, C₂-C₆alkynyl which can be substituted by one to five R₉, C₁-C₆alkoxy which can be substituted by one to five R₉, and C₁-C₆haloalkoxy which can be substituted by one to five R₉ₐ.

In another embodiment R₂, R₃, R₄, R₅ and R₆ are independently selected from —NR₇R₈, C₃-C₆cycloalkyl, —C(O)(OH), —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —C(═N—O—(C₁₋₄ alkyl)-H, and —C(═N—O—(C₁₋₄ alkyl)-C₁-C₄alkyl.

In another R₂, R₃, R₄, R₅ and R₆ are independently selected from a -X-(6 to 10 membered-aryl) group which can be substituted by one to five substituents selected halogen, C₁-C₄alkyl, C₁-C₄haloalkyl, C₁-C₄alkoxy, —CN, —NO₂, —NR⁶R⁷, C₃-C₆cycloalkyl.

In another embodiment R₂, R₃, R₄, R₅ and R₆ are independently selected from a -X-linked-5- or 6-membered heteroaryl group which comprises one or two or three heteroatoms selected from or two N, O and S which can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl.

In another embodiment R₂ and R₃, R₃ and R₄, R₄ and R₅, R₅ and R₆ can form a five- or six-membered annellated ring which comprises one or two or three heteroatoms selected from N, O and S and this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl.

Preferably R₂, R₃, R₄, R₅ and R₆ independently are H, fluorine, chlorine, bromine, cyano, nitro, amino, or R₂, R₃, R₄, R₅ and R₆ independently are a -X-phenyl can be substituted by one to five substituents selected from F, Cl, Br,

or R₂, R₃, R₄, R₅ and R₆ independently are a -X-linked-5- or 6-membered heteroaryl group which comprises one or two or three heteroatoms selected from or two N, O and S, can be substituted by one to five substituents selected from halogen, C₁-C₄alkyl, C₃-C₆cycloalkyl,
or R₂ and R₃, R₃ and R₄, R₄ and R₅, R₅ and R₆ can form a five- or six-membered annellated ring which comprises one or two or three heteroatoms selected from or two N, O and S and this heterocyclic ring can be substituted by one to five substituents selected from C₁-C₄alkyl, C₃-C₆cycloalkyl.

More preferably R₂, R₃, R₄, R₅ and R₆ are independently selected from H, fluorine, chlorine, cyano, or R₂, R₃, R₄, R₅ and R₆ independently are a -X-linked-5- or 6-membered heteroaryl group which comprises one or two or three heteroatoms selected from or two N, O and S can be substituted by one to five substituents selected from C₁-C₄alkyl, C₃-C₆cycloalkyl,

or R₂ and R₃, R₃ and R₄, R₄ and R₅, R₅ and R₆ can form a five- or six-membered annellated ring which comprises one or two or three heteroatoms selected from or two N, O and S can be substituted by one to five substituents selected from C₃-C₆cycloalkyl.

Preferably R⁷ and R⁸ are independently selected from H, —C₁₋₄alkyl- or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring can be substituted by halogen, C₁-C₄alky,

Preferably X designates a direct bond or —NH—.

The invention further relates to a compound according to the formula (VIII)

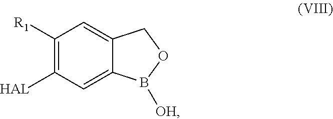

wherein HAL is halogen;
and R₁ is H, fluorine, chlorine, bromine, cyano, nitro, C₁-C₄alkyl, C₁-C₄alkoxy, C₁-C₄haloalkyl;
preferably HAL is fluorine, chlorine, bromine or idodine;
more preferably preferably HAL is idodine;
Preferably R₁ is fluorine, chlorine, bromine, cyano, nitro, C₁-C₄alkyl;
More preferably R₁ is fluorine, chlorine, bromine, cyano;
Most preferably R¹ is fluorine, chlorine.
In one preferred embodiment HAL is iodine;
and R₁ is H, fluorine, chlorine, bromine, cyano, nitro, C₁-C₄alkyl, C₁-C₄alkoxy, C₁-C₄haloalkyl;
preferably HAL is fluorine, chlorine, bromine or idodine;
more preferably preferably HAL is idodine.

The following tables 1 to 343 illustrate further compounds according to the invention:

Table 1 provides 392 compounds of formula (I) wherein R₂ is CN, R₃ is CN, R₄ is CN, and R₁, R₅ and R₆ are as defined in Table P.
Table 2 provides 392 compounds of formula (I) wherein R₂ is OH, R₃ is CN, R₄ is CN, and R₁, R₅ and R₆ are as defined in Table P.
Table 3 provides 392 compounds of formula (I) wherein R₂ is F, R₃ is CN, R₄ is CN, and R₁, R₅ and R₆ are as defined in Table P.
Table 4 provides 392 compounds of formula (I) wherein R₂ is Cl, R₃ is CN, R₄ is CN, and R₁, R₅ and R₆ are as defined in Table P.
Table 5 provides 392 compounds of formula (I) wherein R₂ is Br, R₃ is CN, R₄ is CN, and R₁, R₅ and R₆ are as defined in Table P.
Table 6 provides 392 compounds of formula (I) wherein R₂ is H, R₃ is CN, R₄ is CN, and R₁, R₅ and R₆ are as defined in Table P.
Table 7 provides 392 compounds of formula (I) wherein R₂ is NO₂, R₃ is CN, R₄ is CN, and R₁, R₅ and R₆ are as defined in Table P.
Table 8 provides 392 compounds of formula (I) wherein R₂ is CN, R₃ is OH, R₄ is CN, and R₁, R₅ and R₆ are as defined in Table P.
Table 9 provides 392 compounds of formula (I) wherein R₂ is OH, R₃ is OH, R₄ is CN, and R₁, R₅ and R₆ are as defined in Table P.
Table 10 provides 392 compounds of formula (I) wherein R₂ is F, R₃ is OH, R₄ is CN, and R₁, R₅ and R₆ are as defined in Table P.
Table 11 provides 392 compounds of formula (I) wherein R₂ is Cl, R₃ is OH, R₄ is CN, and R₁, R₅ and R₆ are as defined in Table P.
Table 12 provides 392 compounds of formula (I) wherein R₂ is Br, R₃ is OH, R₄ is CN, and R₁, R₅ and R₆ are as defined in Table P.
Table 13 provides 392 compounds of formula (I) wherein R₂ is H, R₃ is OH, R₄ is CN, and R₁, R₅ and R₆ are as defined in Table P.
Table 14 provides 392 compounds of formula (I) wherein R₂ is NO₂, R₃ is OH, R₄ is CN, and R₁, R₅ and R₆ are as defined in Table P.
Table 15 provides 392 compounds of formula (I) wherein R₂ is CN, R₃ is F, R₄ is CN, and R₁, R₅ and R₆ are as defined in Table P.
Table 16 provides 392 compounds of formula (I) wherein R₂ is OH, R₃ is F, R₄ is CN, and R₁, R₅ and R₆ are as defined in Table P.
Table 17 provides 392 compounds of formula (I) wherein R₂ is F, R₃ is F, R₄ is CN, and R₁, R₅ and R₆ are as defined in Table P.
Table 18 provides 392 compounds of formula (I) wherein R₂ is Cl, R₃ is F, R₄ is CN, and R₁, R₅ and R₆ are as defined in Table P.
Table 19 provides 392 compounds of formula (I) wherein R₂ is Br, R₃ is F, R₄ is CN, and R₁, R₅ and R₆ are as defined in Table P.
Table 20 provides 392 compounds of formula (I) wherein R₂ is H, R₃ is F, R₄ is CN, and R₁, R₅ and R₆ are as defined in Table P.
Table 21 provides 392 compounds of formula (I) wherein R₂ is NO₂, R₃ is F, R₄ is CN, and R₁, R₅ and R₆ are as defined in Table P.
Table 22 provides 392 compounds of formula (I) wherein R₂ is CN, R₃ is Cl, R₄ is CN, and R₁, R₅ and R₆ are as defined in Table P.
Table 23 provides 392 compounds of formula (I) wherein R₂ is OH, R₃ is Cl, R₄ is CN, and R₁, R₅ and R₆ are as defined in Table P.
Table 24 provides 392 compounds of formula (I) wherein R₂ is F, R₃ is Cl, R₄ is CN, and R₁, R₅ and R₆ are as defined in Table P.
Table 25 provides 392 compounds of formula (I) wherein R₂ is Cl, R₃ is Cl, R₄ is CN, and R₁, R₅ and R₆ are as defined in Table P.
Table 26 provides 392 compounds of formula (I) wherein R₂ is Br, R₃ is Cl, R₄ is CN, and R₁, R₅ and R₆ are as defined in Table P.
Table 27 provides 392 compounds of formula (I) wherein R₂ is H, R₃ is Cl, R₄ is CN, and R₁, R₅ and R₆ are as defined in Table P.
Table 28 provides 392 compounds of formula (I) wherein R₂ is NO₂, R₃ is Cl, R₄ is CN, and R₁, R₅ and R₆ are as defined in Table P.
Table 29 provides 392 compounds of formula (I) wherein R₂ is CN, R₃ is Br, R₄ is CN, and R₁, R₅ and R₆ are as defined in Table P.
Table 30 provides 392 compounds of formula (I) wherein R₂ is OH, R₃ is Br, R₄ is CN, and R₁, R₅ and R₆ are as defined in Table P.
Table 31 provides 392 compounds of formula (I) wherein R₂ is F, R₃ is Br, R₄ is CN, and R₁, R₅ and R₆ are as defined in Table P.
Table 32 provides 392 compounds of formula (I) wherein R₂ is Cl, R₃ is Br, R₄ is CN, and R₁, R₅ and R₆ are as defined in Table P.
Table 33 provides 392 compounds of formula (I) wherein R₂ is Br, R₃ is Br, R₄ is CN, and R₁, R₅ and R₆ are as defined in Table P.
Table 34 provides 392 compounds of formula (I) wherein R₂ is H, R₃ is Br, R₄ is CN, and R₁, R₅ and R₆ are as defined in Table P.
Table 35 provides 392 compounds of formula (I) wherein R₂ is NO₂, R₃ is Br, R₄ is CN, and R₁, R₅ and R₆ are as defined in Table P.
Table 36 provides 392 compounds of formula (I) wherein R₂ is CN, R₃ is H, R₄ is CN, and R₁, R₅ and R₆ are as defined in Table P.
Table 37 provides 392 compounds of formula (I) wherein R₂ is OH, R₃ is H, R₄ is CN, and R₁, R₅ and R₆ are as defined in Table P.
Table 38 provides 392 compounds of formula (I) wherein R₂ is F, R₃ is H, R₄ is CN, and R₁, R₅ and R₆ are as defined in Table P.
Table 39 provides 392 compounds of formula (I) wherein R₂ is Cl, R₃ is H, R₄ is CN, and R₁, R₅ and R₆ are as defined in Table P.
Table 40 provides 392 compounds of formula (I) wherein R₂ is Br, R₃ is H, R₄ is CN, and R₁, R₅ and R₆ are as defined in Table P.
Table 41 provides 392 compounds of formula (I) wherein R₂ is H, R₃ is H, R₄ is CN, and R₁, R₅ and R₆ are as defined in Table P.
Table 42 provides 392 compounds of formula (I) wherein R₂ is NO₂, R₃ is H, R₄ is CN, and R₁, R₅ and R₆ are as defined in Table P.
Table 43 provides 392 compounds of formula (I) wherein R₂ is CN, R₃ is NO₂, R₄ is CN, and R₁, R₅ and R₆ are as defined in Table P.
Table 44 provides 392 compounds of formula (I) wherein R₂ is OH, R₃ is NO₂, R₄ is CN, and R₁, R₅ and R₆ are as defined in Table P.
Table 45 provides 392 compounds of formula (I) wherein R₂ is F, R₃ is NO₂, R₄ is CN, and R₁, R₅ and R₆ are as defined in Table P.
Table 46 provides 392 compounds of formula (I) wherein R₂ is Cl, R₃ is NO₂, R₄ is CN, and R₁, R₅ and R₆ are as defined in Table P.
Table 47 provides 392 compounds of formula (I) wherein R₂ is Br, R₃ is NO₂, R₄ is CN, and R₁, R₅ and R₆ are as defined in Table P.
Table 48 provides 392 compounds of formula (I) wherein R₂ is H, R₃ is NO₂, R₄ is CN, and R₁, R₅ and R₆ are as defined in Table P.
Table 49 provides 392 compounds of formula (I) wherein R₂ is NO₂, R₃ is NO₂, R₄ is CN, and R₁, R₅ and R₆ are as defined in Table P.
Table 50 provides 392 compounds of formula (I) wherein R₂ is CN, R₃ is CN, R₄ is OH, and R₁, R₅ and R₆ are as defined in Table P.
Table 51 provides 392 compounds of formula (I) wherein R₂ is OH, R₃ is CN, R₄ is OH, and R₁, R₅ and R₆ are as defined in Table P.
Table 52 provides 392 compounds of formula (I) wherein R₂ is F, R₃ is CN, R₄ is OH, and R₁, R₅ and R₆ are as defined in Table P.
Table 53 provides 392 compounds of formula (I) wherein R₂ is Cl, R₃ is CN, R₄ is OH, and R₁, R₅ and R₆ are as defined in Table P.
Table 54 provides 392 compounds of formula (I) wherein R₂ is Br, R₃ is CN, R₄ is OH, and R₁, R₅ and R₆ are as defined in Table P.
Table 55 provides 392 compounds of formula (I) wherein R₂ is H, R₃ is CN, R₄ is OH, and R₁, R₅ and R₆ are as defined in Table P.
Table 56 provides 392 compounds of formula (I) wherein R₂ is NO₂, R₃ is CN, R₄ is OH, and R₁, R₅ and R₆ are as defined in Table P.
Table 57 provides 392 compounds of formula (I) wherein R₂ is CN, R₃ is OH, R₄ is OH, and R₁, R₅ and R₆ are as defined in Table P.
Table 58 provides 392 compounds of formula (I) wherein R₂ is OH, R₃ is OH, R₄ is OH, and R₁, R₅ and R₆ are as defined in Table P.
Table 59 provides 392 compounds of formula (I) wherein R₂ is F, R₃ is OH, R₄ is OH, and R₁, R₅ and R₆ are as defined in Table P.
Table 60 provides 392 compounds of formula (I) wherein R₂ is Cl, R₃ is OH, R₄ is OH, and R₁, R₅ and R₆ are as defined in Table P.
Table 61 provides 392 compounds of formula (I) wherein R₂ is Br, R₃ is OH, R₄ is OH, and R₁, R₅ and R₆ are as defined in Table P.
Table 62 provides 392 compounds of formula (I) wherein R₂ is H, R₃ is OH, R₄ is OH, and R₁, R₅ and R₆ are as defined in Table P.
Table 63 provides 392 compounds of formula (I) wherein R₂ is NO₂, R₃ is OH, R₄ is OH, and R₁, R₅ and R₆ are as defined in Table P.
Table 64 provides 392 compounds of formula (I) wherein R₂ is CN, R₃ is F, R₄ is OH, and R₁, R₅ and R₆ are as defined in Table P.
Table 65 provides 392 compounds of formula (I) wherein R₂ is OH, R₃ is F, R₄ is OH, and R₁, R₅ and R₆ are as defined in Table P.
Table 66 provides 392 compounds of formula (I) wherein R₂ is F, R₃ is F, R₄ is OH, and R₁, R₅ and R₆ are as defined in Table P.
Table 67 provides 392 compounds of formula (I) wherein R₂ is Cl, R₃ is F, R₄ is OH, and R₁, R₅ and R₆ are as defined in Table P.
Table 68 provides 392 compounds of formula (I) wherein R₂ is Br, R₃ is F, R₄ is OH, and R₁, R₅ and R₆ are as defined in Table P.
Table 69 provides 392 compounds of formula (I) wherein R₂ is H, R₃ is F, R₄ is OH, and R₁, R₅ and R₆ are as defined in Table P.
Table 70 provides 392 compounds of formula (I) wherein R₂ is NO₂, R₃ is F, R₄ is OH, and R₁, R₅ and R₆ are as defined in Table P.
Table 71 provides 392 compounds of formula (I) wherein R₂ is CN, R₃ is Cl, R₄ is OH, and R₁, R₅ and R₆ are as defined in Table P.
Table 72 provides 392 compounds of formula (I) wherein R₂ is OH, R₃ is Cl, R₄ is OH, and R₁, R₅ and R₆ are as defined in Table P.
Table 73 provides 392 compounds of formula (I) wherein R₂ is F, R₃ is Cl, R₄ is OH, and R₁, R₅ and R₆ are as defined in Table P.
Table 74 provides 392 compounds of formula (I) wherein R₂ is Cl, R₃ is Cl, R₄ is OH, and R₁, R₅ and R₆ are as defined in Table P.
Table 75 provides 392 compounds of formula (I) wherein R₂ is Br, R₃ is Cl, R₄ is OH, and R₁, R₅ and R₆ are as defined in Table P.
Table 76 provides 392 compounds of formula (I) wherein R₂ is H, R₃ is Cl, R₄ is OH, and R₁, R₅ and R₆ are as defined in Table P.
Table 77 provides 392 compounds of formula (I) wherein R₂ is NO₂, R₃ is Cl, R₄ is OH, and R₁, R₅ and R₆ are as defined in Table P.
Table 78 provides 392 compounds of formula (I) wherein R₂ is CN, R₃ is Br, R₄ is OH, and R₁, R₅ and R₆ are as defined in Table P.
Table 79 provides 392 compounds of formula (I) wherein R₂ is OH, R₃ is Br, R₄ is OH, and R₁, R₅ and R₆ are as defined in Table P.
Table 80 provides 392 compounds of formula (I) wherein R₂ is F, R₃ is Br, R₄ is OH, and R₁, R₅ and R₆ are as defined in Table P.
Table 81 provides 392 compounds of formula (I) wherein R₂ is Cl, R₃ is Br, R₄ is OH, and R₁, R₅ and R₆ are as defined in Table P.
Table 82 provides 392 compounds of formula (I) wherein R₂ is Br, R₃ is Br, R₄ is OH, and R₁, R₅ and R₆ are as defined in Table P.
Table 83 provides 392 compounds of formula (I) wherein R₂ is H, R₃ is Br, R₄ is OH, and R₁, R₅ and R₆ are as defined in Table P.
Table 84 provides 392 compounds of formula (I) wherein R₂ is NO₂, R₃ is Br, R₄ is OH, and R₁, R₅ and R₆ are as defined in Table P.
Table 85 provides 392 compounds of formula (I) wherein R₂ is CN, R₃ is H, R₄ is OH, and R₁, R₅ and R₆ are as defined in Table P.
Table 86 provides 392 compounds of formula (I) wherein R₂ is OH, R₃ is H, R₄ is OH, and R₁, R₅ and R₆ are as defined in Table P.
Table 87 provides 392 compounds of formula (I) wherein R₂ is F, R₃ is H, R₄ is OH, and R₁, R₅ and R₆ are as defined in Table P.
Table 88 provides 392 compounds of formula (I) wherein R₂ is Cl, R₃ is H, R₄ is OH, and R₁, R₅ and R₆ are as defined in Table P.
Table 89 provides 392 compounds of formula (I) wherein R₂ is Br, R₃ is H, R₄ is OH, and R₁, R₅ and R₆ are as defined in Table P.
Table 90 provides 392 compounds of formula (I) wherein R₂ is H, R₃ is H, R₄ is OH, and R₁, R₅ and R₆ are as defined in Table P.
Table 91 provides 392 compounds of formula (I) wherein R₂ is NO₂, R₃ is H, R₄ is OH, and R₁, R₅ and R₆ are as defined in Table P.
Table 92 provides 392 compounds of formula (I) wherein R₂ is CN, R₃ is NO₂, R₄ is OH, and R₁, R₅ and R₆ are as defined in Table P.
Table 93 provides 392 compounds of formula (I) wherein R₂ is OH, R₃ is NO₂, R₄ is OH, and R₁, R₅ and R₆ are as defined in Table P.
Table 94 provides 392 compounds of formula (I) wherein R₂ is F, R₃ is NO₂, R₄ is OH, and R₁, R₅ and R₆ are as defined in Table P.
Table 95 provides 392 compounds of formula (I) wherein R₂ is Cl, R₃ is NO₂, R₄ is OH, and R₁, R₅ and R₆ are as defined in Table P.
Table 96 provides 392 compounds of formula (I) wherein R₂ is Br, R₃ is NO₂, R₄ is OH, and R₁, R₅ and R₆ are as defined in Table P.
Table 97 provides 392 compounds of formula (I) wherein R₂ is H, R₃ is NO₂, R₄ is OH, and R₁, R₅ and R₆ are as defined in Table P.
Table 98 provides 392 compounds of formula (I) wherein R₂ is NO₂, R₃ is NO₂, R₄ is OH, and R₁, R₅ and R₆ are as defined in Table P.
Table 99 provides 392 compounds of formula (I) wherein R₂ is CN, R₃ is CN, R₄ is F, and R₁, R₅ and R₆ are as defined in Table P.
Table 100 provides 392 compounds of formula (I) wherein R₂ is OH, R₃ is CN, R₄ is F, and R₁, R₅ and R₆ are as defined in Table P.
Table 101 provides 392 compounds of formula (I) wherein R₂ is F, R₃ is CN, R₄ is F, and R₁, R₅ and R₆ are as defined in Table P.
Table 102 provides 392 compounds of formula (I) wherein R₂ is Cl, R₃ is CN, R₄ is F, and R₁, R₅ and R₆ are as defined in Table P.
Table 103 provides 392 compounds of formula (I) wherein R₂ is Br, R₃ is CN, R₄ is F, and R₁, R₅ and R₆ are as defined in Table P.
Table 104 provides 392 compounds of formula (I) wherein R₂ is H, R₃ is CN, R₄ is F, and R₁, R₅ and R₆ are as defined in Table P.
Table 105 provides 392 compounds of formula (I) wherein R₂ is NO₂, R₃ is CN, R₄ is F, and R₁, R₅ and R₆ are as defined in Table P.
Table 106 provides 392 compounds of formula (I) wherein R₂ is CN, R₃ is OH, R₄ is F, and R₁, R₅ and R₆ are as defined in Table P.
Table 107 provides 392 compounds of formula (I) wherein R₂ is OH, R₃ is OH, R₄ is F, and R₁, R₅ and R₆ are as defined in Table P.
Table 108 provides 392 compounds of formula (I) wherein R₂ is F, R₃ is OH, R₄ is F, and R₁, R₅ and R₆ are as defined in Table P.
Table 109 provides 392 compounds of formula (I) wherein R₂ is Cl, R₃ is OH, R₄ is F, and R₁, R₅ and R₆ are as defined in Table P.
Table 110 provides 392 compounds of formula (I) wherein R₂ is Br, R₃ is OH, R₄ is F, and R₁, R₅ and R₆ are as defined in Table P.
Table 111 provides 392 compounds of formula (I) wherein R₂ is H, R₃ is OH, R₄ is F, and R₁, R₅ and R₆ are as defined in Table P.
Table 112 provides 392 compounds of formula (I) wherein R₂ is NO₂, R₃ is OH, R₄ is F, and R₁, R₅ and R₆ are as defined in Table P.
Table 113 provides 392 compounds of formula (I) wherein R₂ is CN, R₃ is F, R₄ is F, and R₁, R₅ and R₆ are as defined in Table P.
Table 114 provides 392 compounds of formula (I) wherein R₂ is OH, R₃ is F, R₄ is F, and R₁, R₅ and R₆ are as defined in Table P.
Table 115 provides 392 compounds of formula (I) wherein R₂ is F, R₃ is F, R₄ is F, and R₁, R₅ and R₆ are as defined in Table P.
Table 116 provides 392 compounds of formula (I) wherein R₂ is Cl, R₃ is F, R₄ is F, and R₁, R₅ and R₆ are as defined in Table P.
Table 117 provides 392 compounds of formula (I) wherein R₂ is Br, R₃ is F, R₄ is F, and R₁, R₅ and R₆ are as defined in Table P.
Table 118 provides 392 compounds of formula (I) wherein R₂ is H, R₃ is F, R₄ is F, and R₁, R₅ and R₆ are as defined in Table P.
Table 119 provides 392 compounds of formula (I) wherein R₂ is NO₂, R₃ is F, R₄ is F, and R₁, R₅ and R₆ are as defined in Table P.
Table 120 provides 392 compounds of formula (I) wherein R₂ is CN, R₃ is Cl, R₄ is F, and R₁, R₅ and R₆ are as defined in Table P.
Table 121 provides 392 compounds of formula (I) wherein R₂ is OH, R₃ is Cl, R₄ is F, and R₁, R₅ and R₆ are as defined in Table P.
Table 122 provides 392 compounds of formula (I) wherein R₂ is F, R₃ is Cl, R₄ is F, and R₁, R₅ and R₆ are as defined in Table P.
Table 123 provides 392 compounds of formula (I) wherein R₂ is Cl, R₃ is Cl, R₄ is F, and R₁, R₅ and R₆ are as defined in Table P.
Table 124 provides 392 compounds of formula (I) wherein R₂ is Br, R₃ is Cl, R₄ is F, and R₁, R₅ and R₆ are as defined in Table P.
Table 125 provides 392 compounds of formula (I) wherein R₂ is H, R₃ is Cl, R₄ is F, and R₁, R₅ and R₆ are as defined in Table P.
Table 126 provides 392 compounds of formula (I) wherein R₂ is NO₂, R₃ is Cl, R₄ is F, and R₁, R₅ and R₆ are as defined in Table P.
Table 127 provides 392 compounds of formula (I) wherein R₂ is CN, R₃ is Br, R₄ is F, and R₁, R₅ and R₆ are as defined in Table P.
Table 128 provides 392 compounds of formula (I) wherein R₂ is OH, R₃ is Br, R₄ is F, and R₁, R₅ and R₆ are as defined in Table P.
Table 129 provides 392 compounds of formula (I) wherein R₂ is F, R₃ is Br, R₄ is F, and R₁, R₅ and R₆ are as defined in Table P.
Table 130 provides 392 compounds of formula (I) wherein R₂ is Cl, R₃ is Br, R₄ is F, and R₁, R₅ and R₆ are as defined in Table P.
Table 131 provides 392 compounds of formula (I) wherein R₂ is Br, R₃ is Br, R₄ is F, and R₁, R₅ and R₆ are as defined in Table P.
Table 132 provides 392 compounds of formula (I) wherein R₂ is H, R₃ is Br, R₄ is F, and R₁, R₅ and R₆ are as defined in Table P.
Table 133 provides 392 compounds of formula (I) wherein R₂ is NO₂, R₃ is Br, R₄ is F, and R₁, R₅ and R₆ are as defined in Table P.
Table 134 provides 392 compounds of formula (I) wherein R₂ is CN, R₃ is H, R₄ is F, and R₁, R₅ and R₆ are as defined in Table P.
Table 135 provides 392 compounds of formula (I) wherein R₂ is OH, R₃ is H, R₄ is F, and R₁, R₅ and R₆ are as defined in Table P.
Table 136 provides 392 compounds of formula (I) wherein R₂ is F, R₃ is H, R₄ is F, and R₁, R₅ and R₆ are as defined in Table P.
Table 137 provides 392 compounds of formula (I) wherein R₂ is Cl, R₃ is H, R₄ is F, and R₁, R₅ and R₆ are as defined in Table P.
Table 138 provides 392 compounds of formula (I) wherein R₂ is Br, R₃ is H, R₄ is F, and R₁, R₅ and R₆ are as defined in Table P.
Table 139 provides 392 compounds of formula (I) wherein R₂ is H, R₃ is H, R₄ is F, and R₁, R₅ and R₆ are as defined in Table P.
Table 140 provides 392 compounds of formula (I) wherein R₂ is NO₂, R₃ is H, R₄ is F, and R₁, R₅ and R₆ are as defined in Table P.
Table 141 provides 392 compounds of formula (I) wherein R₂ is CN, R₃ is NO₂, R₄ is F, and R₁, R₅ and R₆ are as defined in Table P.
Table 142 provides 392 compounds of formula (I) wherein R₂ is OH, R₃ is NO₂, R₄ is F, and R₁, R₅ and R₆ are as defined in Table P.
Table 143 provides 392 compounds of formula (I) wherein R₂ is F, R₃ is NO₂, R₄ is F, and R₁, R₅ and R₆ are as defined in Table P.
Table 144 provides 392 compounds of formula (I) wherein R₂ is Cl, R₃ is NO₂, R₄ is F, and R₁, R₅ and R₆ are as defined in Table P.
Table 145 provides 392 compounds of formula (I) wherein R₂ is Br, R₃ is NO₂, R₄ is F, and R₁, R₅ and R₆ are as defined in Table P.
Table 146 provides 392 compounds of formula (I) wherein R₂ is H, R₃ is NO₂, R₄ is F, and R₁, R₅ and R₆ are as defined in Table P.
Table 147 provides 392 compounds of formula (I) wherein R₂ is NO₂, R₃ is NO₂, R₄ is F, and R₁, R₅ and R₆ are as defined in Table P.
Table 148 provides 392 compounds of formula (I) wherein R₂ is CN, R₃ is CN, R₄ is Cl, and R₁, R₅ and R₆ are as defined in Table P.
Table 149 provides 392 compounds of formula (I) wherein R₂ is OH, R₃ is CN, R₄ is Cl, and R₁, R₅ and R₆ are as defined in Table P.
Table 150 provides 392 compounds of formula (I) wherein R₂ is F, R₃ is CN, R₄ is Cl, and R₁, R₅ and R₆ are as defined in Table P.
Table 151 provides 392 compounds of formula (I) wherein R₂ is Cl, R₃ is CN, R₄ is Cl, and R₁, R₅ and R₆ are as defined in Table P.
Table 152 provides 392 compounds of formula (I) wherein R₂ is Br, R₃ is CN, R₄ is Cl, and R₁, R₅ and R₆ are as defined in Table P.
Table 153 provides 392 compounds of formula (I) wherein R₂ is H, R₃ is CN, R₄ is Cl, and R₁, R₅ and R₆ are as defined in Table P.
Table 154 provides 392 compounds of formula (I) wherein R₂ is NO₂, R₃ is CN, R₄ is Cl, and R₁, R₅ and R₆ are as defined in Table P.
Table 155 provides 392 compounds of formula (I) wherein R₂ is CN, R₃ is OH, R₄ is Cl, and R₁, R₅ and R₆ are as defined in Table P.
Table 156 provides 392 compounds of formula (I) wherein R₂ is OH, R₃ is OH, R₄ is Cl, and R₁, R₅ and R₆ are as defined in Table P.
Table 157 provides 392 compounds of formula (I) wherein R₂ is F, R₃ is OH, R₄ is Cl, and R₁, R₅ and R₆ are as defined in Table P.
Table 158 provides 392 compounds of formula (I) wherein R₂ is Cl, R₃ is OH, R₄ is Cl, and R₁, R₅ and R₆ are as defined in Table P.
Table 159 provides 392 compounds of formula (I) wherein R₂ is Br, R₃ is OH, R₄ is Cl, and R₁, R₅ and R₆ are as defined in Table P.
Table 160 provides 392 compounds of formula (I) wherein R₂ is H, R₃ is OH, R₄ is Cl, and R₁, R₅ and R₆ are as defined in Table P.
Table 161 provides 392 compounds of formula (I) wherein R₂ is NO₂, R₃ is OH, R₄ is Cl, and R₁, R₅ and R₆ are as defined in Table P.
Table 162 provides 392 compounds of formula (I) wherein R₂ is CN, R₃ is F, R₄ is Cl, and R₁, R₅ and R₆ are as defined in Table P.
Table 163 provides 392 compounds of formula (I) wherein R₂ is OH, R₃ is F, R₄ is Cl, and R₁, R₅ and R₆ are as defined in Table P.
Table 164 provides 392 compounds of formula (I) wherein R₂ is F, R₃ is F, R₄ is Cl, and R₁, R₅ and R₆ are as defined in Table P.
Table 165 provides 392 compounds of formula (I) wherein R₂ is Cl, R₃ is F, R₄ is Cl, and R₁, R₅ and R₆ are as defined in Table P.
Table 166 provides 392 compounds of formula (I) wherein R₂ is Br, R₃ is F, R₄ is Cl, and R₁, R₅ and R₆ are as defined in Table P.
Table 167 provides 392 compounds of formula (I) wherein R₂ is H, R₃ is F, R₄ is Cl, and R₁, R₅ and R₆ are as defined in Table P.
Table 168 provides 392 compounds of formula (I) wherein R₂ is NO₂, R₃ is F, R₄ is Cl, and R₁, R₅ and R₆ are as defined in Table P.
Table 169 provides 392 compounds of formula (I) wherein R₂ is CN, R₃ is Cl, R₄ is Cl, and R₁, R₅ and R₆ are as defined in Table P.
Table 170 provides 392 compounds of formula (I) wherein R₂ is OH, R₃ is Cl, R₄ is Cl, and R₁, R₅ and R₆ are as defined in Table P.
Table 171 provides 392 compounds of formula (I) wherein R₂ is F, R₃ is Cl, R₄ is Cl, and R₁, R₅ and R₆ are as defined in Table P.
Table 172 provides 392 compounds of formula (I) wherein R₂ is Cl, R₃ is Cl, R₄ is Cl, and R₁, R₅ and R₆ are as defined in Table P.
Table 173 provides 392 compounds of formula (I) wherein R₂ is Br, R₃ is Cl, R₄ is Cl, and R₁, R₅ and R₆ are as defined in Table P.
Table 174 provides 392 compounds of formula (I) wherein R₂ is H, R₃ is Cl, R₄ is Cl, and R₁, R₅ and R₆ are as defined in Table P.
Table 175 provides 392 compounds of formula (I) wherein R₂ is NO₂, R₃ is Cl, R₄ is Cl, and R₁, R₅ and R₆ are as defined in Table P.
Table 176 provides 392 compounds of formula (I) wherein R₂ is CN, R₃ is Br, R₄ is Cl, and R₁, R₅ and R₆ are as defined in Table P.
Table 177 provides 392 compounds of formula (I) wherein R₂ is OH, R₃ is Br, R₄ is Cl, and R₁, R₅ and R₆ are as defined in Table P.
Table 178 provides 392 compounds of formula (I) wherein R₂ is F, R₃ is Br, R₄ is Cl, and R₁, R₅ and R₆ are as defined in Table P.
Table 179 provides 392 compounds of formula (I) wherein R₂ is Cl, R₃ is Br, R₄ is Cl, and R₁, R₅ and R₆ are as defined in Table P.
Table 180 provides 392 compounds of formula (I) wherein R₂ is Br, R₃ is Br, R₄ is Cl, and R₁, R₅ and R₆ are as defined in Table P.
Table 181 provides 392 compounds of formula (I) wherein R₂ is H, R₃ is Br, R₄ is Cl, and R₁, R₅ and R₆ are as defined in Table P.
Table 182 provides 392 compounds of formula (I) wherein R₂ is NO₂, R₃ is Br, R₄ is Cl, and R₁, R₅ and R₆ are as defined in Table P.
Table 183 provides 392 compounds of formula (I) wherein R₂ is CN, R₃ is H, R₄ is Cl, and R₁, R₅ and R₆ are as defined in Table P.
Table 184 provides 392 compounds of formula (I) wherein R₂ is OH, R₃ is H, R₄ is Cl, and R₁, R₅ and R₆ are as defined in Table P.
Table 185 provides 392 compounds of formula (I) wherein R₂ is F, R₃ is H, R₄ is Cl, and R₁, R₅ and R₆ are as defined in Table P.
Table 186 provides 392 compounds of formula (I) wherein R₂ is Cl, R₃ is H, R₄ is Cl, and R₁, R₅ and R₆ are as defined in Table P.
Table 187 provides 392 compounds of formula (I) wherein R₂ is Br, R₃ is H, R₄ is Cl, and R₁, R₅ and R₆ are as defined in Table P.
Table 188 provides 392 compounds of formula (I) wherein R₂ is H, R₃ is H, R₄ is Cl, and R₁, R₅ and R₆ are as defined in Table P.
Table 189 provides 392 compounds of formula (I) wherein R₂ is NO₂, R₃ is H, R₄ is Cl, and R₁, R₅ and R₆ are as defined in Table P.
Table 190 provides 392 compounds of formula (I) wherein R₂ is CN, R₃ is NO₂, R₄ is Cl, and R₁, R₅ and R₆ are as defined in Table P.
Table 191 provides 392 compounds of formula (I) wherein R₂ is OH, R₃ is NO₂, R₄ is Cl, and R₁, R₅ and R₆ are as defined in Table P.
Table 192 provides 392 compounds of formula (I) wherein R₂ is F, R₃ is NO₂, R₄ is Cl, and R₁, R₅ and R₆ are as defined in Table P.
Table 193 provides 392 compounds of formula (I) wherein R₂ is Cl, R₃ is NO₂, R₄ is Cl, and R₁, R₅ and R₆ are as defined in Table P.
Table 194 provides 392 compounds of formula (I) wherein R₂ is Br, R₃ is NO₂, R₄ is Cl, and R₁, R₅ and R₆ are as defined in Table P.
Table 195 provides 392 compounds of formula (I) wherein R₂ is H, R₃ is NO₂, R₄ is Cl, and R₁, R₅ and R₆ are as defined in Table P.
Table 196 provides 392 compounds of formula (I) wherein R₂ is NO₂, R₃ is NO₂, R₄ is Cl, and R₁, R₅ and R₆ are as defined in Table P.
Table 197 provides 392 compounds of formula (I) wherein R₂ is CN, R₃ is CN, R₄ is Br, and R₁, R₅ and R₆ are as defined in Table P.
Table 198 provides 392 compounds of formula (I) wherein R₂ is OH, R₃ is CN, R₄ is Br, and R₁, R₅ and R₆ are as defined in Table P.
Table 199 provides 392 compounds of formula (I) wherein R₂ is F, R₃ is CN, R₄ is Br, and R₁, R₅ and R₆ are as defined in Table P.
Table 200 provides 392 compounds of formula (I) wherein R₂ is Cl, R₃ is CN, R₄ is Br, and R₁, R₅ and R₆ are as defined in Table P.
Table 201 provides 392 compounds of formula (I) wherein R₂ is Br, R₃ is CN, R₄ is Br, and R₁, R₅ and R₆ are as defined in Table P.
Table 202 provides 392 compounds of formula (I) wherein R₂ is H, R₃ is CN, R₄ is Br, and R₁, R₅ and R₆ are as defined in Table P.
Table 203 provides 392 compounds of formula (I) wherein R₂ is NO₂, R₃ is CN, R₄ is Br, and R₁, R₅ and R₆ are as defined in Table P.
Table 204 provides 392 compounds of formula (I) wherein R₂ is CN, R₃ is OH, R₄ is Br, and R₁, R₅ and R₆ are as defined in Table P.
Table 205 provides 392 compounds of formula (I) wherein R₂ is OH, R₃ is OH, R₄ is Br, and R₁, R₅ and R₆ are as defined in Table P.
Table 206 provides 392 compounds of formula (I) wherein R₂ is F, R₃ is OH, R₄ is Br, and R₁, R₅ and R₆ are as defined in Table P.
Table 207 provides 392 compounds of formula (I) wherein R₂ is Cl, R₃ is OH, R₄ is Br, and R₁, R₅ and R₆ are as defined in Table P.
Table 208 provides 392 compounds of formula (I) wherein R₂ is Br, R₃ is OH, R₄ is Br, and R₁, R₅ and R₆ are as defined in Table P.
Table 209 provides 392 compounds of formula (I) wherein R₂ is H, R₃ is OH, R₄ is Br, and R₁, R₅ and R₆ are as defined in Table P.
Table 210 provides 392 compounds of formula (I) wherein R₂ is NO₂, R₃ is OH, R₄ is Br, and R₁, R₅ and R₆ are as defined in Table P.
Table 211 provides 392 compounds of formula (I) wherein R₂ is CN, R₃ is F, R₄ is Br, and R₁, R₅ and R₆ are as defined in Table P.
Table 212 provides 392 compounds of formula (I) wherein R₂ is OH, R₃ is F, R₄ is Br, and R₁, R₅ and R₆ are as defined in Table P.
Table 213 provides 392 compounds of formula (I) wherein R₂ is F, R₃ is F, R₄ is Br, and R₁, R₅ and R₆ are as defined in Table P.
Table 214 provides 392 compounds of formula (I) wherein R₂ is Cl, R₃ is F, R₄ is Br, and R₁, R₅ and R₆ are as defined in Table P.
Table 215 provides 392 compounds of formula (I) wherein R₂ is Br, R₃ is F, R₄ is Br, and R₁, R₅ and R₆ are as defined in Table P.
Table 216 provides 392 compounds of formula (I) wherein R₂ is H, R₃ is F, R₄ is Br, and R₁, R₅ and R₆ are as defined in Table P.
Table 217 provides 392 compounds of formula (I) wherein R₂ is NO₂, R₃ is F, R₄ is Br, and R₁, R₅ and R₆ are as defined in Table P.
Table 218 provides 392 compounds of formula (I) wherein R₂ is CN, R₃ is Cl, R₄ is Br, and R₁, R₅ and R₆ are as defined in Table P.
Table 219 provides 392 compounds of formula (I) wherein R₂ is OH, R₃ is Cl, R₄ is Br, and R₁, R₅ and R₆ are as defined in Table P.
Table 220 provides 392 compounds of formula (I) wherein R₂ is F, R₃ is Cl, R₄ is Br, and R₁, R₅ and R₆ are as defined in Table P.
Table 221 provides 392 compounds of formula (I) wherein R₂ is Cl, R₃ is Cl, R₄ is Br, and R₁, R₅ and R₆ are as defined in Table P.
Table 222 provides 392 compounds of formula (I) wherein R₂ is Br, R₃ is Cl, R₄ is Br, and R₁, R₅ and R₆ are as defined in Table P.
Table 223 provides 392 compounds of formula (I) wherein R₂ is H, R₃ is Cl, R₄ is Br, and R₁, R₅ and R₆ are as defined in Table P.
Table 224 provides 392 compounds of formula (I) wherein R₂ is NO₂, R₃ is Cl, R₄ is Br, and R₁, R₅ and R₆ are as defined in Table P.
Table 225 provides 392 compounds of formula (I) wherein R₂ is CN, R₃ is Br, R₄ is Br, and R₁, R₅ and R₆ are as defined in Table P.
Table 226 provides 392 compounds of formula (I) wherein R₂ is OH, R₃ is Br, R₄ is Br, and R₁, R₅ and R₆ are as defined in Table P.
Table 227 provides 392 compounds of formula (I) wherein R₂ is F, R₃ is Br, R₄ is Br, and R₁, R₅ and R₆ are as defined in Table P.
Table 228 provides 392 compounds of formula (I) wherein R₂ is Cl, R₃ is Br, R₄ is Br, and R₁, R₅ and R₆ are as defined in Table P.
Table 229 provides 392 compounds of formula (I) wherein R₂ is Br, R₃ is Br, R₄ is Br, and R₁, R₅ and R₆ are as defined in Table P.
Table 230 provides 392 compounds of formula (I) wherein R₂ is H, R₃ is Br, R₄ is Br, and R₁, R₅ and R₆ are as defined in Table P.
Table 231 provides 392 compounds of formula (I) wherein R₂ is NO₂, R₃ is Br, R₄ is Br, and R₁, R₅ and R₆ are as defined in Table P.
Table 232 provides 392 compounds of formula (I) wherein R₂ is CN, R₃ is H, R₄ is Br, and R₁, R₅ and R₆ are as defined in Table P.
Table 233 provides 392 compounds of formula (I) wherein R₂ is OH, R₃ is H, R₄ is Br, and R₁, R₅ and R₆ are as defined in Table P.
Table 234 provides 392 compounds of formula (I) wherein R₂ is F, R₃ is H, R₄ is Br, and R₁, R₅ and R₆ are as defined in Table P.
Table 235 provides 392 compounds of formula (I) wherein R₂ is Cl, R₃ is H, R₄ is Br, and R₁, R₅ and R₆ are as defined in Table P.
Table 236 provides 392 compounds of formula (I) wherein R₂ is Br, R₃ is H, R₄ is Br, and R₁, R₅ and R₆ are as defined in Table P.
Table 237 provides 392 compounds of formula (I) wherein R₂ is H, R₃ is H, R₄ is Br, and R₁, R₅ and R₆ are as defined in Table P.
Table 238 provides 392 compounds of formula (I) wherein R₂ is NO₂, R₃ is H, R₄ is Br, and R₁, R₅ and R₆ are as defined in Table P.
Table 239 provides 392 compounds of formula (I) wherein R₂ is CN, R₃ is NO₂, R₄ is Br, and R₁, R₅ and R₆ are as defined in Table P.
Table 240 provides 392 compounds of formula (I) wherein R₂ is OH, R₃ is NO₂, R₄ is Br, and R₁, R₅ and R₆ are as defined in Table P.
Table 241 provides 392 compounds of formula (I) wherein R₂ is F, R₃ is NO₂, R₄ is Br, and R₁, R₅ and R₆ are as defined in Table P.
Table 242 provides 392 compounds of formula (I) wherein R₂ is Cl, R₃ is NO₂, R₄ is Br, and R₁, R₅ and R₆ are as defined in Table P.
Table 243 provides 392 compounds of formula (I) wherein R₂ is Br, R₃ is NO₂, R₄ is Br, and R₁, R₅ and R₆ are as defined in Table P.
Table 244 provides 392 compounds of formula (I) wherein R₂ is H, R₃ is NO₂, R₄ is Br, and R₁, R₅ and R₆ are as defined in Table P.
Table 245 provides 392 compounds of formula (I) wherein R₂ is NO₂, R₃ is NO₂, R₄ is Br, and R₁, R₅ and R₆ are as defined in Table P.
Table 246 provides 392 compounds of formula (I) wherein R₂ is CN, R₃ is CN, R₄ is H, and R₁, R₅ and R₆ are as defined in Table P.
Table 247 provides 392 compounds of formula (I) wherein R₂ is OH, R₃ is CN, R₄ is H, and R₁, R₅ and R₆ are as defined in Table P.
Table 248 provides 392 compounds of formula (I) wherein R₂ is F, R₃ is CN, R₄ is H, and R₁, R₅ and R₆ are as defined in Table P.
Table 249 provides 392 compounds of formula (I) wherein R₂ is Cl, R₃ is CN, R₄ is H, and R₁, R₅ and R₆ are as defined in Table P.
Table 250 provides 392 compounds of formula (I) wherein R₂ is Br, R₃ is CN, R₄ is H, and R₁, R₅ and R₆ are as defined in Table P.
Table 251 provides 392 compounds of formula (I) wherein R₂ is H, R₃ is CN, R₄ is H, and R₁, R₅ and R₆ are as defined in Table P.
Table 252 provides 392 compounds of formula (I) wherein R₂ is NO₂, R₃ is CN, R₄ is H, and R₁, R₅ and R₆ are as defined in Table P.
Table 253 provides 392 compounds of formula (I) wherein R₂ is CN, R₃ is OH, R₄ is H, and R₁, R₅ and R₆ are as defined in Table P.
Table 254 provides 392 compounds of formula (I) wherein R₂ is OH, R₃ is OH, R₄ is H, and R₁, R₅ and R₆ are as defined in Table P.
Table 255 provides 392 compounds of formula (I) wherein R₂ is F, R₃ is OH, R₄ is H, and R₁, R₅ and R₆ are as defined in Table P.
Table 256 provides 392 compounds of formula (I) wherein R₂ is Cl, R₃ is OH, R₄ is H, and R₁, R₅ and R₆ are as defined in Table P.
Table 257 provides 392 compounds of formula (I) wherein R₂ is Br, R₃ is OH, R₄ is H, and R₁, R₅ and R₆ are as defined in Table P.
Table 258 provides 392 compounds of formula (I) wherein R₂ is H, R₃ is OH, R₄ is H, and R₁, R₅ and R₆ are as defined in Table P.
Table 259 provides 392 compounds of formula (I) wherein R₂ is NO₂, R₃ is OH, R₄ is H, and R₁, R₅ and R₆ are as defined in Table P.
Table 260 provides 392 compounds of formula (I) wherein R₂ is CN, R₃ is F, R₄ is H, and R₁, R₅ and R₆ are as defined in Table P.
Table 261 provides 392 compounds of formula (I) wherein R₂ is OH, R₃ is F, R₄ is H, and R₁, R₅ and R₆ are as defined in Table P.
Table 262 provides 392 compounds of formula (I) wherein R₂ is F, R₃ is F, R₄ is H, and R₁, R₅ and R₆ are as defined in Table P.
Table 263 provides 392 compounds of formula (I) wherein R₂ is Cl, R₃ is F, R₄ is H, and R₁, R₅ and R₆ are as defined in Table P.
Table 264 provides 392 compounds of formula (I) wherein R₂ is Br, R₃ is F, R₄ is H, and R₁, R₅ and R₆ are as defined in Table P.
Table 265 provides 392 compounds of formula (I) wherein R₂ is H, R₃ is F, R₄ is H, and R₁, R₅ and R₆ are as defined in Table P.
Table 266 provides 392 compounds of formula (I) wherein R₂ is NO₂, R₃ is F, R₄ is H, and R₁, R₅ and R₆ are as defined in Table P.
Table 267 provides 392 compounds of formula (I) wherein R₂ is CN, R₃ is Cl, R₄ is H, and R₁, R₅ and R₆ are as defined in Table P.
Table 268 provides 392 compounds of formula (I) wherein R₂ is OH, R₃ is Cl, R₄ is H, and R₁, R₅ and R₆ are as defined in Table P.
Table 269 provides 392 compounds of formula (I) wherein R₂ is F, R₃ is Cl, R₄ is H, and R₁, R₅ and R₆ are as defined in Table P.
Table 270 provides 392 compounds of formula (I) wherein R₂ is Cl, R₃ is Cl, R₄ is H, and R₁, R₅ and R₆ are as defined in Table P.
Table 271 provides 392 compounds of formula (I) wherein R₂ is Br, R₃ is Cl, R₄ is H, and R₁, R₅ and R₆ are as defined in Table P.
Table 272 provides 392 compounds of formula (I) wherein R₂ is H, R₃ is Cl, R₄ is H, and R₁, R₅ and R₆ are as defined in Table P.
Table 273 provides 392 compounds of formula (I) wherein R₂ is NO₂, R₃ is Cl, R₄ is H, and R₁, R₅ and R₆ are as defined in Table P.
Table 274 provides 392 compounds of formula (I) wherein R₂ is CN, R₃ is Br, R₄ is H, and R₁, R₅ and R₆ are as defined in Table P.
Table 275 provides 392 compounds of formula (I) wherein R₂ is OH, R₃ is Br, R₄ is H, and R₁, R₅ and R₆ are as defined in Table P.
Table 276 provides 392 compounds of formula (I) wherein R₂ is F, R₃ is Br, R₄ is H, and R₁, R₅ and R₆ are as defined in Table P.
Table 277 provides 392 compounds of formula (I) wherein R₂ is Cl, R₃ is Br, R₄ is H, and R₁, R₅ and R₆ are as defined in Table P.
Table 278 provides 392 compounds of formula (I) wherein R₂ is Br, R₃ is Br, R₄ is H, and R₁, R₅ and R₆ are as defined in Table P.
Table 279 provides 392 compounds of formula (I) wherein R₂ is H, R₃ is Br, R₄ is H, and R₁, R₅ and R₆ are as defined in Table P.
Table 280 provides 392 compounds of formula (I) wherein R₂ is NO₂, R₃ is Br, R₄ is H, and R₁, R₅ and R₆ are as defined in Table P.
Table 281 provides 392 compounds of formula (I) wherein R₂ is CN, R₃ is H, R₄ is H, and R₁, R₅ and R₆ are as defined in Table P.
Table 282 provides 392 compounds of formula (I) wherein R₂ is OH, R₃ is H, R₄ is H, and R₁, R₅ and R₆ are as defined in Table P.
Table 283 provides 392 compounds of formula (I) wherein R₂ is F, R₃ is H, R₄ is H, and R₁, R₅ and R₆ are as defined in Table P.
Table 284 provides 392 compounds of formula (I) wherein R₂ is Cl, R₃ is H, R₄ is H, and R₁, R₅ and R₆ are as defined in Table P.
Table 285 provides 392 compounds of formula (I) wherein R₂ is Br, R₃ is H, R₄ is H, and R₁, R₅ and R₆ are as defined in Table P.
Table 286 provides 392 compounds of formula (I) wherein R₂ is H, R₃ is H, R₄ is H, and R₁, R₅ and R₆ are as defined in Table P.
Table 287 provides 392 compounds of formula (I) wherein R₂ is NO₂, R₃ is H, R₄ is H, and R₁, R₅ and R₆ are as defined in Table P.
Table 288 provides 392 compounds of formula (I) wherein R₂ is CN, R₃ is NO₂, R₄ is H, and R₁, R₅ and R₆ are as defined in Table P.
Table 289 provides 392 compounds of formula (I) wherein R₂ is OH, R₃ is NO₂, R₄ is H, and R₁, R₅ and R₆ are as defined in Table P.
Table 290 provides 392 compounds of formula (I) wherein R₂ is F, R₃ is NO₂, R₄ is H, and R₁, R₅ and R₆ are as defined in Table P.
Table 291 provides 392 compounds of formula (I) wherein R₂ is Cl, R₃ is NO₂, R₄ is H, and R₁, R₅ and R₆ are as defined in Table P.
Table 292 provides 392 compounds of formula (I) wherein R₂ is Br, R₃ is NO₂, R₄ is H, and R₁, R₅ and R₆ are as defined in Table P.
Table 293 provides 392 compounds of formula (I) wherein R₂ is H, R₃ is NO₂, R₄ is H, and R₁, R₅ and R₆ are as defined in Table P.
Table 294 provides 392 compounds of formula (I) wherein R₂ is NO₂, R₃ is NO₂, R₄ is H, and R₁, R₅ and R₆ are as defined in Table P.
Table 295 provides 392 compounds of formula (I) wherein R₂ is CN, R₃ is CN, R₄ is NO₂, and R₁, R₅ and R₆ are as defined in Table P.
Table 296 provides 392 compounds of formula (I) wherein R₂ is OH, R₃ is CN, R₄ is NO₂, and R₁, R₅ and R₆ are as defined in Table P.
Table 297 provides 392 compounds of formula (I) wherein R₂ is F, R₃ is CN, R₄ is NO₂, and R₁, R₅ and R₆ are as defined in Table P.
Table 298 provides 392 compounds of formula (I) wherein R₂ is Cl, R₃ is CN, R₄ is NO₂, and R₁, R₅ and R₆ are as defined in Table P.
Table 299 provides 392 compounds of formula (I) wherein R₂ is Br, R₃ is CN, R₄ is NO₂, and R₁, R₅ and R₆ are as defined in Table P.
Table 300 provides 392 compounds of formula (I) wherein R₂ is H, R₃ is CN, R₄ is NO₂, and R₁, R₅ and R₆ are as defined in Table P.
Table 301 provides 392 compounds of formula (I) wherein R₂ is NO₂, R₃ is CN, R₄ is NO₂, and R₁, R₅ and R₆ are as defined in Table P.
Table 302 provides 392 compounds of formula (I) wherein R₂ is CN, R₃ is OH, R₄ is NO₂, and R₁, R₅ and R₆ are as defined in Table P.
Table 303 provides 392 compounds of formula (I) wherein R₂ is OH, R₃ is OH, R₄ is NO₂, and R₁, R₅ and R₆ are as defined in Table P.
Table 304 provides 392 compounds of formula (I) wherein R₂ is F, R₃ is OH, R₄ is NO₂, and R₁, R₅ and R₆ are as defined in Table P.
Table 305 provides 392 compounds of formula (I) wherein R₂ is Cl, R₃ is OH, R₄ is NO₂, and R₁, R₅ and R₆ are as defined in Table P.
Table 306 provides 392 compounds of formula (I) wherein R₂ is Br, R₃ is OH, R₄ is NO₂, and R₁, R₅ and R₆ are as defined in Table P.
Table 307 provides 392 compounds of formula (I) wherein R₂ is H, R₃ is OH, R₄ is NO₂, and R₁, R₅ and R₆ are as defined in Table P.
Table 308 provides 392 compounds of formula (I) wherein R₂ is NO₂, R₃ is OH, R₄ is NO₂, and R₁, R₅ and R₆ are as defined in Table P.
Table 309 provides 392 compounds of formula (I) wherein R₂ is CN, R₃ is F, R₄ is NO₂, and R₁, R₅ and R₆ are as defined in Table P.
Table 310 provides 392 compounds of formula (I) wherein R₂ is OH, R₃ is F, R₄ is NO₂, and R₁, R₅ and R₆ are as defined in Table P.
Table 311 provides 392 compounds of formula (I) wherein R₂ is F, R₃ is F, R₄ is NO₂, and R₁, R₅ and R₆ are as defined in Table P.
Table 312 provides 392 compounds of formula (I) wherein R₂ is Cl, R₃ is F, R₄ is NO₂, and R₁, R₅ and R₆ are as defined in Table P.
Table 313 provides 392 compounds of formula (I) wherein R₂ is Br, R₃ is F, R₄ is NO₂, and R₁, R₅ and R₆ are as defined in Table P.
Table 314 provides 392 compounds of formula (I) wherein R₂ is H, R₃ is F, R₄ is NO₂, and R₁, R₅ and R₆ are as defined in Table P.
Table 315 provides 392 compounds of formula (I) wherein R₂ is NO₂, R₃ is F, R₄ is NO₂, and R₁, R₅ and R₆ are as defined in Table P.
Table 316 provides 392 compounds of formula (I) wherein R₂ is CN, R₃ is Cl, R₄ is NO₂, and R₁, R₅ and R₆ are as defined in Table P.
Table 317 provides 392 compounds of formula (I) wherein R₂ is OH, R₃ is Cl, R₄ is NO₂, and R₁, R₅ and R₆ are as defined in Table P.
Table 318 provides 392 compounds of formula (I) wherein R₂ is F, R₃ is Cl, R₄ is NO₂, and R₁, R₅ and R₆ are as defined in Table P.
Table 319 provides 392 compounds of formula (I) wherein R₂ is Cl, R₃ is Cl, R₄ is NO₂, and R₁, R₅ and R₆ are as defined in Table P.
Table 320 provides 392 compounds of formula (I) wherein R₂ is Br, R₃ is Cl, R₄ is NO₂, and R₁, R₅ and R₆ are as defined in Table P.
Table 321 provides 392 compounds of formula (I) wherein R₂ is H, R₃ is Cl, R₄ is NO₂, and R₁, R₅ and R₆ are as defined in Table P.
Table 322 provides 392 compounds of formula (I) wherein R₂ is NO₂, R₃ is Cl, R₄ is NO₂, and R₁, R₅ and R₆ are as defined in Table P.
Table 323 provides 392 compounds of formula (I) wherein R₂ is CN, R₃ is Br, R₄ is NO₂, and R₁, R₅ and R₆ are as defined in Table P.
Table 324 provides 392 compounds of formula (I) wherein R₂ is OH, R₃ is Br, R₄ is NO₂, and R₁, R₅ and R₆ are as defined in Table P.
Table 325 provides 392 compounds of formula (I) wherein R₂ is F, R₃ is Br, R₄ is NO₂, and R₁, R₅ and R₆ are as defined in Table P.
Table 326 provides 392 compounds of formula (I) wherein R₂ is Cl, R₃ is Br, R₄ is NO₂, and R₁, R₅ and R₆ are as defined in Table P.
Table 327 provides 392 compounds of formula (I) wherein R₂ is Br, R₃ is Br, R₄ is NO₂, and R₁, R₅ and R₆ are as defined in Table P.
Table 328 provides 392 compounds of formula (I) wherein R₂ is H, R₃ is Br, R₄ is NO₂, and R₁, R₅ and R₆ are as defined in Table P.
Table 329 provides 392 compounds of formula (I) wherein R₂ is NO₂, R₃ is Br, R₄ is NO₂, and R₁, R₅ and R₆ are as defined in Table P.
Table 330 provides 392 compounds of formula (I) wherein R₂ is CN, R₃ is H, R₄ is NO₂, and R₁, R₅ and R₆ are as defined in Table P.
Table 331 provides 392 compounds of formula (I) wherein R₂ is OH, R₃ is H, R₄ is NO₂, and R₁, R₅ and R₆ are as defined in Table P.
Table 332 provides 392 compounds of formula (I) wherein R₂ is F, R₃ is H, R₄ is NO₂, and R₁, R₅ and R₆ are as defined in Table P.
Table 333 provides 392 compounds of formula (I) wherein R₂ is Cl, R₃ is H, R₄ is NO₂, and R₁, R₅ and R₆ are as defined in Table P.
Table 334 provides 392 compounds of formula (I) wherein R₂ is Br, R₃ is H, R₄ is NO₂, and R₁, R₅ and R₆ are as defined in Table P.
Table 335 provides 392 compounds of formula (I) wherein R₂ is H, R₃ is H, R₄ is NO₂, and R₁, R₅ and R₆ are as defined in Table P.
Table 336 provides 392 compounds of formula (I) wherein R₂ is NO₂, R₃ is H, R₄ is NO₂, and R₁, R₅ and R₆ are as defined in Table P.
Table 337 provides 392 compounds of formula (I) wherein R₂ is CN, R₃ is NO₂, R₄ is NO₂, and R₁, R₅ and R₆ are as defined in Table P.
Table 338 provides 392 compounds of formula (I) wherein R₂ is OH, R₃ is NO₂, R₄ is NO₂, and R₁, R₅ and R₆ are as defined in Table P.
Table 339 provides 392 compounds of formula (I) wherein R₂ is F, R₃ is NO₂, R₄ is NO₂, and R₁, R₅ and R₆ are as defined in Table P.
Table 340 provides 392 compounds of formula (I) wherein R₂ is Cl, R₃ is NO₂, R₄ is NO₂, and R₁, R₅ and R₆ are as defined in Table P.
Table 341 provides 392 compounds of formula (I) wherein R₂ is Br, R₃ is NO₂, R₄ is NO₂, and R₁, R₅ and R₆ are as defined in Table P.
Table 342 provides 392 compounds of formula (I) wherein R₂ is H, R₃ is NO₂, R₄ is NO₂, and R₁, R₅ and R₆ are as defined in Table P.
Table 343 provides 392 compounds of formula (I) wherein R₂ is NO₂, R₃ is NO₂, R₄ is NO₂, and R₁, R₅ and R₆ are as defined in Table P.

TABLE P

| entry | R₁ | R₅ | R₆ |
|---|---|---|---|
| 1 | methoxy | CN | CN |
| 2 | ethoxy | CN | CN |
| 3 | CN | CN | CN |
| 4 | OH | CN | CN |
| 5 | F | CN | CN |
| 6 | Cl | CN | CN |
| 7 | Br | CN | CN |
| 8 | H | CN | CN |
| 9 | methoxy | OH | CN |
| 10 | ethoxy | OH | CN |
| 11 | CN | OH | CN |
| 12 | OH | OH | CN |
| 13 | F | OH | CN |
| 14 | Cl | OH | CN |
| 15 | Br | OH | CN |
| 16 | H | OH | CN |
| 17 | methoxy | F | CN |
| 18 | ethoxy | F | CN |
| 19 | CN | F | CN |
| 20 | OH | F | CN |
| 21 | F | F | CN |
| 22 | Cl | F | CN |
| 23 | Br | F | CN |
| 24 | H | F | CN |
| 25 | methoxy | Cl | CN |
| 26 | ethoxy | Cl | CN |
| 27 | CN | Cl | CN |
| 28 | OH | Cl | CN |
| 29 | F | Cl | CN |
| 30 | Cl | Cl | CN |
| 31 | Br | Cl | CN |
| 32 | H | Cl | CN |
| 33 | methoxy | Br | CN |
| 34 | ethoxy | Br | CN |
| 35 | CN | Br | CN |
| 36 | OH | Br | CN |
| 37 | F | Br | CN |
| 38 | Cl | Br | CN |
| 39 | Br | Br | CN |
| 40 | H | Br | CN |
| 41 | methoxy | H | CN |
| 42 | ethoxy | H | CN |
| 43 | CN | H | CN |
| 44 | OH | H | CN |
| 45 | F | H | CN |
| 46 | Cl | H | CN |
| 47 | Br | H | CN |
| 48 | H | H | CN |
| 49 | methoxy | NO₂ | CN |
| 50 | ethoxy | NO₂ | CN |
| 51 | CN | NO₂ | CN |
| 52 | OH | NO₂ | CN |
| 53 | F | NO₂ | CN |
| 54 | Cl | NO₂ | CN |
| 55 | Br | NO₂ | CN |
| 56 | H | NO₂ | CN |
| 57 | methoxy | CN | OH |
| 58 | ethoxy | CN | OH |
| 59 | CN | CN | OH |
| 60 | OH | CN | OH |
| 61 | F | CN | OH |
| 62 | Cl | CN | OH |
| 63 | Br | CN | OH |
| 64 | H | CN | OH |
| 65 | methoxy | OH | OH |
| 66 | ethoxy | OH | OH |
| 67 | CN | OH | OH |
| 68 | OH | OH | OH |
| 69 | F | OH | OH |
| 70 | Cl | OH | OH |
| 71 | Br | OH | OH |
| 72 | H | OH | OH |
| 73 | methoxy | F | OH |
| 74 | ethoxy | F | OH |
| 75 | CN | F | OH |
| 76 | OH | F | OH |
| 77 | F | F | OH |
| 78 | Cl | F | OH |
| 79 | Br | F | OH |
| 80 | H | F | OH |
| 81 | methoxy | Cl | OH |
| 82 | ethoxy | Cl | OH |
| 83 | CN | Cl | OH |
| 84 | OH | Cl | OH |
| 85 | F | Cl | OH |
| 86 | Cl | Cl | OH |
| 87 | Br | Cl | OH |
| 88 | H | Cl | OH |
| 89 | methoxy | Br | OH |
| 90 | ethoxy | Br | OH |
| 91 | CN | Br | OH |
| 92 | OH | Br | OH |
| 93 | F | Br | OH |
| 94 | Cl | Br | OH |
| 95 | Br | Br | OH |
| 96 | H | Br | OH |
| 97 | methoxy | H | OH |
| 98 | ethoxy | H | OH |
| 99 | CN | H | OH |
| 100 | OH | H | OH |
| 101 | F | H | OH |
| 102 | Cl | H | OH |
| 103 | Br | H | OH |
| 104 | H | H | OH |
| 105 | methoxy | NO₂ | OH |
| 106 | ethoxy | NO₂ | OH |
| 107 | CN | NO₂ | OH |
| 108 | OH | NO₂ | OH |
| 109 | F | NO₂ | OH |
| 110 | Cl | NO₂ | OH |
| 111 | Br | NO₂ | OH |
| 112 | H | NO₂ | OH |
| 113 | methoxy | CN | F |
| 114 | ethoxy | CN | F |
| 115 | CN | CN | F |
| 116 | OH | CN | F |
| 117 | F | CN | F |
| 118 | Cl | CN | F |
| 119 | Br | CN | F |
| 120 | H | CN | F |
| 121 | methoxy | OH | F |
| 122 | ethoxy | OH | F |
| 123 | CN | OH | F |
| 124 | OH | OH | F |
| 125 | F | OH | F |
| 126 | Cl | OH | F |
| 127 | Br | OH | F |
| 128 | H | OH | F |
| 129 | methoxy | F | F |
| 130 | ethoxy | F | F |
| 131 | CN | F | F |
| 132 | OH | F | F |
| 133 | F | F | F |
| 134 | Cl | F | F |
| 135 | Br | F | F |
| 136 | H | F | F |
| 137 | methoxy | Cl | F |
| 138 | ethoxy | Cl | F |
| 139 | CN | Cl | F |
| 140 | OH | Cl | F |
| 141 | F | Cl | F |
| 142 | Cl | Cl | F |
| 143 | Br | Cl | F |
| 144 | H | Cl | F |
| 145 | methoxy | Br | F |
| 146 | ethoxy | Br | F |
| 147 | CN | Br | F |
| 148 | OH | Br | F |
| 149 | F | Br | F |
| 150 | Cl | Br | F |
| 151 | Br | Br | F |
| 152 | H | Br | F |
| 153 | methoxy | H | F |
| 154 | ethoxy | H | F |
| 155 | CN | H | F |
| 156 | OH | H | F |
| 157 | F | H | F |
| 158 | Cl | H | F |
| 159 | Br | H | F |
| 160 | H | H | F |
| 161 | methoxy | NO₂ | F |
| 162 | ethoxy | NO₂ | F |
| 163 | CN | NO₂ | F |
| 164 | OH | NO₂ | F |
| 165 | F | NO₂ | F |
| 166 | Cl | NO₂ | F |
| 167 | Br | NO₂ | F |
| 168 | H | NO₂ | F |
| 169 | methoxy | CN | Cl |
| 170 | ethoxy | CN | Cl |
| 171 | CN | CN | Cl |
| 172 | OH | CN | Cl |
| 173 | F | CN | Cl |
| 174 | Cl | CN | Cl |
| 175 | Br | CN | Cl |
| 176 | H | CN | Cl |
| 177 | methoxy | OH | Cl |
| 178 | ethoxy | OH | Cl |
| 179 | CN | OH | Cl |
| 180 | OH | OH | Cl |
| 181 | F | OH | Cl |
| 182 | Cl | OH | Cl |
| 183 | Br | OH | Cl |
| 184 | H | OH | Cl |
| 185 | methoxy | F | Cl |
| 186 | ethoxy | F | Cl |
| 187 | CN | F | Cl |
| 188 | OH | F | Cl |
| 189 | F | F | Cl |
| 190 | Cl | F | Cl |
| 191 | Br | F | Cl |
| 192 | H | F | Cl |
| 193 | methoxy | Cl | Cl |
| 194 | ethoxy | Cl | Cl |
| 195 | CN | Cl | Cl |
| 196 | OH | Cl | Cl |
| 197 | F | Cl | Cl |
| 198 | Cl | Cl | Cl |
| 199 | Br | Cl | Cl |
| 200 | H | Cl | Cl |
| 201 | methoxy | Br | Cl |
| 202 | ethoxy | Br | Cl |
| 203 | CN | Br | Cl |
| 204 | OH | Br | Cl |
| 205 | F | Br | Cl |
| 206 | Cl | Br | Cl |
| 207 | Br | Br | Cl |
| 208 | H | Br | Cl |
| 209 | methoxy | H | Cl |
| 210 | ethoxy | H | Cl |
| 211 | CN | H | Cl |
| 212 | OH | H | Cl |
| 213 | F | H | Cl |
| 214 | Cl | H | Cl |
| 215 | Br | H | Cl |
| 216 | H | H | Cl |
| 217 | methoxy | NO₂ | Cl |
| 218 | ethoxy | NO₂ | Cl |
| 219 | CN | NO₂ | Cl |
| 220 | OH | NO₂ | Cl |
| 221 | F | NO₂ | Cl |
| 222 | Cl | NO₂ | Cl |
| 223 | Br | NO₂ | Cl |
| 224 | H | NO₂ | Cl |
| 225 | methoxy | CN | Br |
| 226 | ethoxy | CN | Br |
| 227 | CN | CN | Br |
| 228 | OH | CN | Br |
| 229 | F | CN | Br |
| 230 | Cl | CN | Br |
| 231 | Br | CN | Br |
| 232 | H | CN | Br |
| 233 | methoxy | OH | Br |
| 234 | ethoxy | OH | Br |
| 235 | CN | OH | Br |
| 236 | OH | OH | Br |
| 237 | F | OH | Br |
| 238 | Cl | OH | Br |
| 239 | Br | OH | Br |
| 240 | H | OH | Br |
| 241 | methoxy | F | Br |
| 242 | ethoxy | F | Br |
| 243 | CN | F | Br |
| 244 | OH | F | Br |
| 245 | F | F | Br |
| 246 | Cl | F | Br |
| 247 | Br | F | Br |
| 248 | H | F | Br |
| 249 | methoxy | Cl | Br |
| 250 | ethoxy | Cl | Br |
| 251 | CN | Cl | Br |
| 252 | OH | Cl | Br |
| 253 | F | Cl | Br |
| 254 | Cl | Cl | Br |
| 255 | Br | Cl | Br |
| 256 | H | Cl | Br |
| 257 | methoxy | Br | Br |
| 258 | ethoxy | Br | Br |
| 259 | CN | Br | Br |
| 260 | OH | Br | Br |
| 261 | F | Br | Br |
| 262 | Cl | Br | Br |
| 263 | Br | Br | Br |
| 264 | H | Br | Br |
| 265 | methoxy | H | Br |
| 266 | ethoxy | H | Br |
| 267 | CN | H | Br |
| 268 | OH | H | Br |
| 269 | F | H | Br |
| 270 | Cl | H | Br |
| 271 | Br | H | Br |
| 272 | H | H | Br |
| 273 | methoxy | NO₂ | Br |
| 274 | ethoxy | NO₂ | Br |
| 275 | CN | NO₂ | Br |
| 276 | OH | NO₂ | Br |
| 277 | F | NO₂ | Br |
| 278 | Cl | NO₂ | Br |
| 279 | Br | NO₂ | Br |
| 280 | H | NO₂ | Br |
| 281 | methoxy | CN | H |
| 282 | ethoxy | CN | H |
| 283 | CN | CN | H |
| 284 | OH | CN | H |
| 285 | F | CN | H |
| 286 | Cl | CN | H |
| 287 | Br | CN | H |
| 288 | H | CN | H |
| 289 | methoxy | OH | H |
| 290 | ethoxy | OH | H |
| 291 | CN | OH | H |
| 292 | OH | OH | H |
| 293 | F | OH | H |
| 294 | Cl | OH | H |
| 295 | Br | OH | H |
| 296 | H | OH | H |
| 297 | methoxy | F | H |
| 298 | ethoxy | F | H |
| 299 | CN | F | H |
| 300 | OH | F | H |
| 301 | F | F | H |
| 302 | Cl | F | H |
| 303 | Br | F | H |
| 304 | H | F | H |
| 305 | methoxy | Cl | H |
| 306 | ethoxy | Cl | H |
| 307 | CN | Cl | H |
| 308 | OH | Cl | H |
| 309 | F | Cl | H |
| 310 | Cl | Cl | H |
| 311 | Br | Cl | H |
| 312 | H | Cl | H |
| 313 | methoxy | Br | H |
| 314 | ethoxy | Br | H |
| 315 | CN | Br | H |
| 316 | OH | Br | H |
| 317 | F | Br | H |
| 318 | Cl | Br | H |
| 319 | Br | Br | H |
| 320 | H | Br | H |
| 321 | methoxy | H | H |
| 322 | ethoxy | H | H |
| 323 | CN | H | H |
| 324 | OH | H | H |
| 325 | F | H | H |
| 326 | Cl | H | H |
| 327 | Br | H | H |
| 328 | H | H | H |
| 329 | methoxy | NO₂ | H |
| 330 | ethoxy | NO₂ | H |
| 331 | CN | NO₂ | H |
| 332 | OH | NO₂ | H |
| 333 | F | NO₂ | H |
| 334 | Cl | NO₂ | H |
| 335 | Br | NO₂ | H |
| 336 | H | NO₂ | H |
| 337 | methoxy | CN | NO₂ |
| 338 | ethoxy | CN | NO₂ |
| 339 | CN | CN | NO₂ |
| 340 | OH | CN | NO₂ |
| 341 | F | CN | NO₂ |
| 342 | Cl | CN | NO₂ |
| 343 | Br | CN | NO₂ |
| 344 | H | CN | NO₂ |
| 345 | methoxy | OH | NO₂ |
| 346 | ethoxy | OH | NO₂ |
| 347 | CN | OH | NO₂ |
| 348 | OH | OH | NO₂ |
| 349 | F | OH | NO₂ |
| 350 | Cl | OH | NO₂ |
| 351 | Br | OH | NO₂ |
| 352 | H | OH | NO₂ |
| 353 | methoxy | F | NO₂ |
| 354 | ethoxy | F | NO₂ |
| 355 | CN | F | NO₂ |
| 356 | OH | F | NO₂ |
| 357 | F | F | NO₂ |
| 358 | Cl | F | NO₂ |
| 359 | Br | F | NO₂ |
| 360 | H | F | NO₂ |
| 361 | methoxy | Cl | NO₂ |
| 362 | ethoxy | Cl | NO₂ |
| 363 | CN | Cl | NO₂ |
| 364 | OH | Cl | NO₂ |
| 365 | F | Cl | NO₂ |
| 366 | Cl | Cl | NO₂ |
| 367 | Br | Cl | NO₂ |
| 368 | H | Cl | NO₂ |
| 369 | methoxy | Br | NO₂ |
| 370 | ethoxy | Br | NO₂ |
| 371 | CN | Br | NO₂ |
| 372 | OH | Br | NO₂ |
| 373 | F | Br | NO₂ |
| 374 | Cl | Br | NO₂ |
| 375 | Br | Br | NO₂ |
| 376 | H | Br | NO₂ |
| 377 | methoxy | H | NO₂ |
| 378 | ethoxy | H | NO₂ |
| 379 | CN | H | NO₂ |
| 380 | OH | H | NO₂ |
| 381 | F | H | NO₂ |
| 382 | Cl | H | NO₂ |
| 383 | Br | H | NO₂ |
| 384 | H | H | NO₂ |
| 385 | methoxy | NO₂ | NO₂ |
| 386 | ethoxy | NO₂ | NO₂ |
| 387 | CN | NO₂ | NO₂ |
| 388 | OH | NO₂ | NO₂ |
| 389 | F | NO₂ | NO₂ |
| 390 | Cl | NO₂ | NO₂ |
| 391 | Br | NO₂ | NO₂ |
| 392 | H | NO₂ | NO₂ |

Compounds described in the present invention can be prepared using commercially available starting materials or known intermediates using synthetic methods known in the art or described herein.

The following general chemistry routes were used as indicated in generating the examples and can be applied, using the knowledge of one of skill in the art, to other appropriate compounds to obtain additional analogues

The compounds of formula (I)

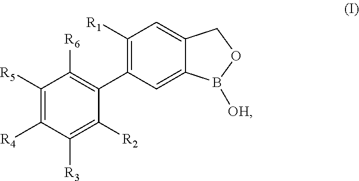

may be prepared by reacting a compound of formula II

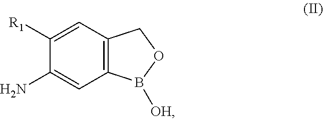

wherein R₁ are as defined under formula I with a compound of formula Ill

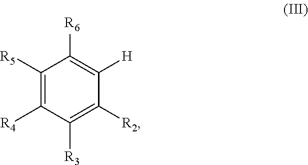

in which R₂, R₃, R₄, R₅, and R₆ are as defined under formula I.

The compounds of formula (I) and the respective starting materials may be obtained according to the processes of Schemes 1 to 5.

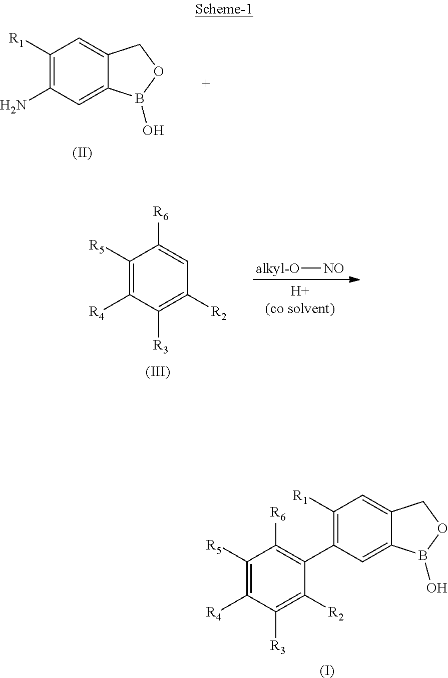

Some compounds of formula (III) are known and commercially available. The reaction for the preparation of compounds of formula (I) according scheme-1 is advantageously carried out directly in liquid compounds of formula (III) without co-solvents. If compounds of formula (III) are solids, the reactions for preparation of compounds of formula (I) are carried out in solvents. Such solvents are alcohols such as methanol, ethanol, n-propanol, i-propanol, nitriles, such as acetonitrile, propionitrile chlorinated hydrocarbons such as dichloromethane, trichloromethane, tetrachloromethane ethers such as diethyl ether, ethylene glycol dimethyl ether, diethylene glycol dimethyl ether, tetrahydrofuran or dioxane amides such as N,N-dimethylformamide, diethylformamide or N-methylpyrrolidinone. Alkylnitrites are preferably ethyl nitrite, n-Butyl nitrite tert-butyl nitrite, amyl nitrite, isoamyl nitrite. The reaction temperatures are advantageously between 0° C. and 60° C. The reaction times can be shortened by adding a few drops of acids as reaction catalyst. Suitable acids are, in particular, trifluoroacetic acid, HBr and HCl.

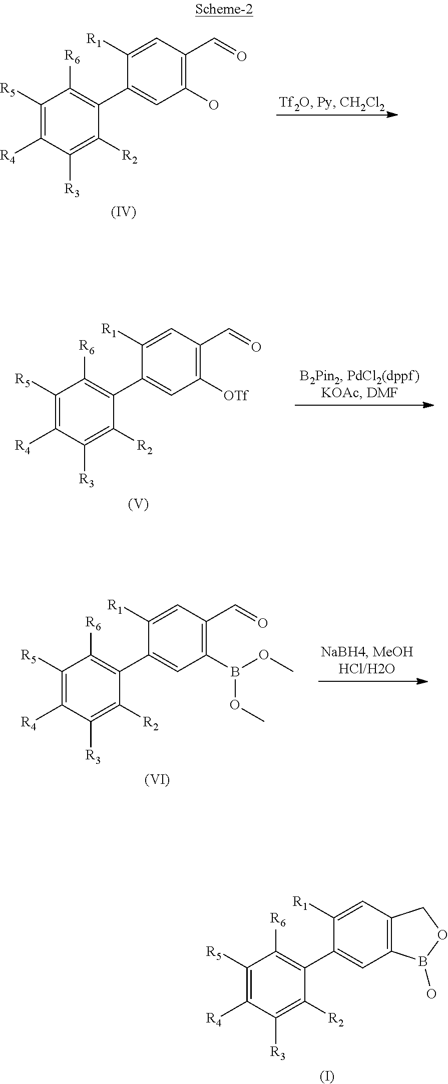

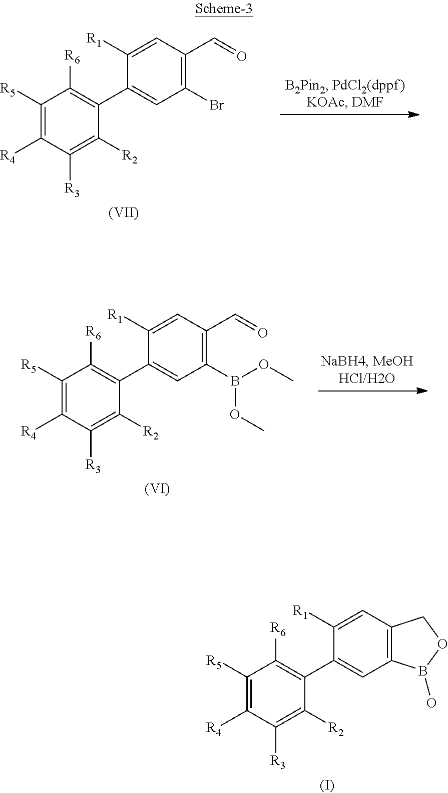

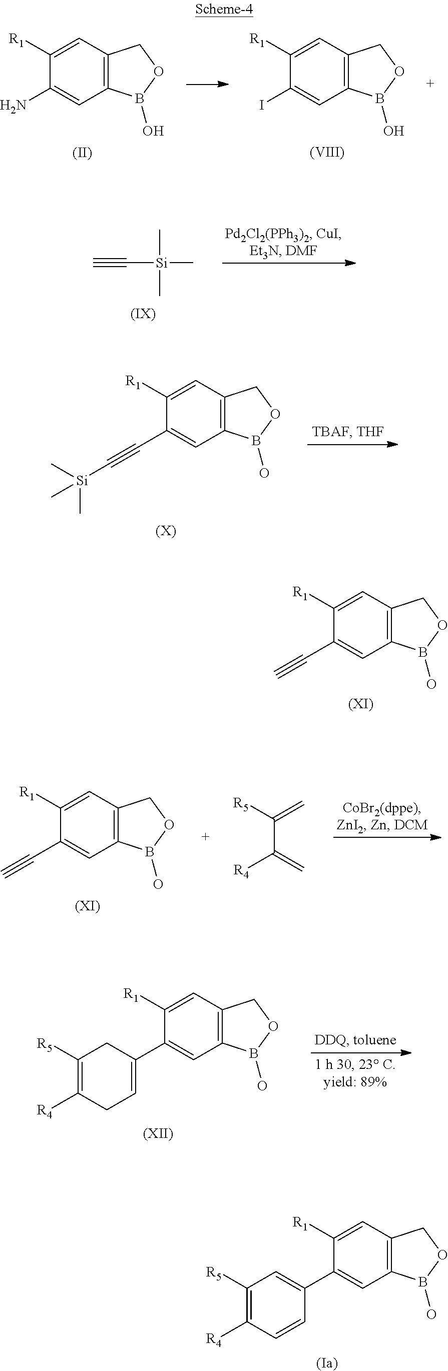

Compounds of formula (XII) may be made in analogy to known methods via cobalt-catalysed [4+2]cycloaddition published in Synthesis, 2011, (6), 972-978, followed by oxidation/aromatization to obtain compounds of formula (Ia).

Intermediates of the formula (XI) can be prepared by methods known in the art by reacting compounds of formula VIII with an alkynyl compound of formula IX as described in reaction scheme 4. It will be appreciated by those skilled in the art that this addition can be carried out with a number of different conditions.

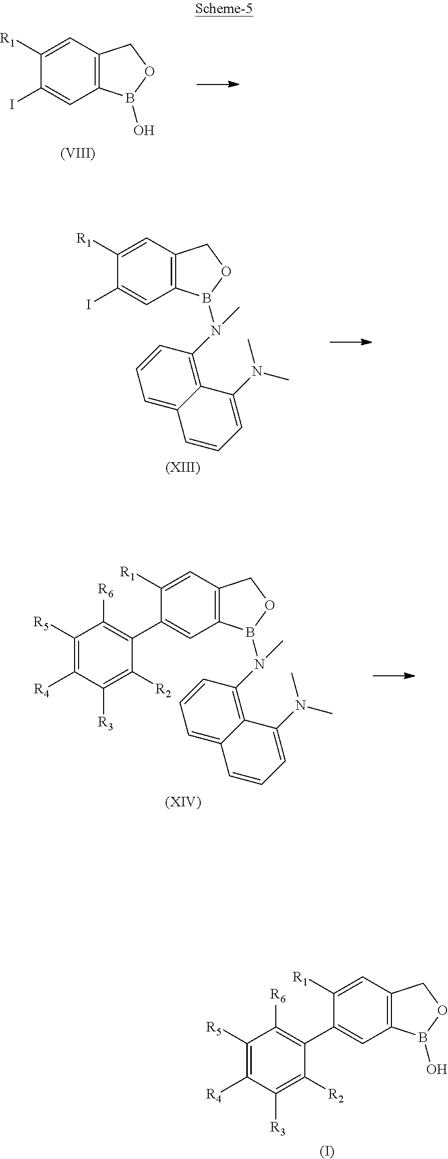

The intermediates of formula III

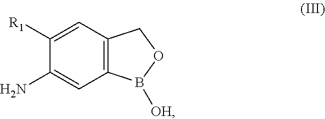

wherein R₁ is defined under formula I, preferably wherein R₁ is F (CAS Registry Number: 943311-50-0), R, is Cl (CAS Registry Number: 947165-43-7), are known, and described in the literature, for example in Bioorganic & Medicinal Chemistry Letters, 20(24), 7317-7322; 2010, or Journal of Molecular Biology, 390(2), 196-207; 2009 or Bioorganic & Medicinal Chemistry Letters, 21(7), 2048-2054; 2011.

The compounds of formula (I) of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound.

Compounds of formula (I) and fungicidal compositions containing them may be used to control plant diseases caused by a broad spectrum of fungal plant pathogens in the Basidiomycete, Ascomycete, Oomycete and/or Deuteromycete, Blasocladiomycete, Chrytidiomycete, Glomeromycete and/or Mucoromycete classes.

They are effective in controlling a broad spectrum of plant diseases, such as foliar pathogens of ornamental, turf, vegetable, field, cereal, and fruit crops.

These pathogens may include: Oomycetes, including Phytophthora diseases such as those caused by Phytophthora capsici, Phytophthora infestans, Phytophthora sojae, Phytophthora fragariae, Phytophthora nicotianae, Phytophthora cinnamomi, Phytophthora citricola, Phytophthora citrophthora and Phytophthora erythroseptica; Pythium diseases such as those caused by Pythium aphanidermatum, Pythium arrhenomanes, Pythium graminicola, Pythium irregulare and Pythium ultimum; diseases caused by Peronosporales such as Peronospora destructor, Peronospora parasitica, Plasmopara viticola, Plasmopara halstedii, Pseudoperonospora cubensis, Albugo candida, Sclerophthora macrospora and Bremia lactucae; and others such as Aphanomyces cochlioides, Labyrinthula zosterae, Peronosclerospora sorghi and Sclerospora graminicola.

Ascomycetes, including blotch, spot, blast or blight diseases and/or rots for example those caused by Pleosporales such as Stemphylium solani, Stagonospora tainanensis, Spilocaea oleaginea, Setosphaeria turcica, Pyrenochaeta lycoperisici, Pleospora herbarum, Phoma destructiva, Phaeosphaeria herpotrichoides, Phaeocryptocus gaeumannii, Ophiosphaerella graminicola, Ophiobolus graminis, Leptosphaeria maculans, Hendersonia creberrima, Helminthosporium triticirepentis, Setosphaeria turcica, Drechslera glycines, Didymella bryoniae, Cycloconium oleagineum, Corynespora cassiicola, Cochliobolus sativus, Bipolaris cactivora, Venturia inaequalis, Pyrenophora teres, Pyrenophora tritici-repentis, Alternaria alternata, Alternaria brassicicola, Alternaria solani and Alternaria tomatophila, Capnodiales such as Septoria tritici, Septoria nodorum, Septoria glycines, Cercospora arachidicola, Cercospora sojina, Cercospora zeae-maydis, Cercosporella capsellae and Cercosporella herpotrichoides, Cladosporium carpophilum, Cladosporium effusum, Passalora fulva, Cladosporium oxysporum, Dothistroma septosporum, Isariopsis clavispora, Mycosphaerella fijiensis, Mycosphaerella graminicola, Mycovellosiella koepkeii, Phaeoisariopsis bataticola, Pseudocercospora vitis, Pseudocercosporella herpotrichoides, Ramularia beticola, Ramularia collo-cygni, Magnaporthales such as Gaeumannomyces graminis, Magnaporthe grisea, Pyricularia oryzae, Diaporthales such as Anisogramma anomala, Apiognomonia errabunda, Cytospora platani, Diaporthe phaseolorum, Discula destructiva, Gnomonia fructicola, Greeneria uvicola, Melanconium juglandinum, Phomopsis viticola, Sirococcus clavigignenti-juglandacearum, Tubakia dryina, Dicarpella spp., Valsa ceratosperma, and others such as Actinothyrium graminis, Ascochyta pisi, Aspergillus flavus, Aspergillus fumigatus, Aspergillus nidulans, Asperisporium caricae, Blumeriella jaapii, Candida spp., Capnodium ramosum, Cephaloascus spp., Cephalosporium gramineum, Ceratocystis paradoxa, Chaetomium spp., Hymenoscyphus pseudoalbidus, Coccidioides spp., Cylindrosporium padi, Diplocarpon malae, Drepanopeziza campestris, Elsinoe ampelina, Epicoccum nigrum, Epidermophyton spp., Eutypa lata, Geotrichum candidum, Gibellina cerealis, Gloeocercospora sorghi, Gloeodes pomigena, Gloeosporium perennans; Gloeotinia temulenta, Griphospaeria corticola, Kabatiella lini, Leptographium microsporum, Leptosphaerulinia crassiasca, Lophodermium seditiosum, Marssonina graminicola, Microdochium nivale, Monilinia fructicola, Monographella albescens, Monosporascus cannonballus, Naemacyclus spp., Ophiostoma novo-ulmi, Paracoccidioides brasiliensis, Penicillium expansum, Pestalotia rhododendri, Petriellidium spp., Pezicula spp., Phialophora gregata, Phyllachora pomigena, Phymatotrichum omnivora, Physalospora abdita, Plectosporium tabacinum, Polyscytalum pustulans, Pseudopeziza medicaginis, Pyrenopeziza brassicae, Ramulispora sorghi, Rhabdocline pseudotsugae, Rhynchosporium secalis, Sacrocladium oryzae, Scedosporium spp., Schizothyrium pomi, Sclerotinia sclerotiorum, Sclerotinia minor; Sclerotium spp., Typhula ishikariensis, Seimatosporium mariae, Lepteutypa cupressi, Septocyta ruborum, Sphaceloma perseae, Sporonema phacidioides, Stigmina palmivora, Tapesia yallundae, Taphrina bullata, Thielviopsis basicola, Trichoseptoria fructigena, Zygophiala jamaicensis; powdery mildew diseases for example those caused by Erysiphales such as Blumeria graminis, Erysiphe polygoni, Uncinula necator, Sphaerotheca fuligena, Podosphaera leucotricha, Podospaera macularis Golovinomyces cichoracearum, Leveillula taurica, Microsphaera diffusa, Oidiopsis gossypii, Phyllactinia guttata and Oidium arachidis; molds for example those caused by Botryosphaeriales such as Dothiorella aromatica, Diplodia seriata, Guignardia bidwellii, Botrytis cinerea, Botryotinia allii, Botryotinia fabae, Fusicoccum amygdali, Lasiodiplodia theobromae, Macrophoma theicola, Macrophomina phaseolina, Phyllosticta cucurbitacearum; anthracnoses for example those caused by Glommerelales such as Colletotrichum gloeosporioides, Colletotrichum lagenarium, Colletotrichum gossypii, Glomerella cingulata, and Colletotrichum graminicola; and wilts or blights for example those caused by Hypocreales such as Acremonium strictum, Claviceps purpurea, Fusarium culmorum, Fusarium graminearum, Fusarium virguliforme, Fusarium oxysporum, Fusarium subglutinans, Fusarium oxysporum f. sp. cubense, Gerlachia nivale, Gibberella fujikuroi, Gibberella zeae, Gliocladium spp., Myrothecium verrucaria, Nectria ramulariae, Trichoderma viride, Trichothecium roseum, and Verticillium theobromae.

Basidiomycetes, including smuts for example those caused by Ustilaginales such as Ustilaginoidea virens, Ustilago nuda, Ustilago tritici, Ustilago zeae, rusts for example those caused by Pucciniales such as Cerotelium fici, Chrysomyxa arctostaphyli, Coleosporium ipomoeae, Hemileia vastatrix, Puccinia arachidis, Puccinia cacabata, Puccinia graminis, Puccinia recondita, Puccinia sorghi, Puccinia hordei, Puccinia striiformis f. sp. Hordei, Puccinia striiformis f. sp. Secalis, Pucciniastrum coryli, or Uredinales such as Cronartium ribicola, Gymnosporangium juniperi-viginianae, Melampsora medusae, Phakopsora pachyrhizi, Phragmidium mucronatum, Physopella ampelosidis, Tranzschelia discolor and Uromyces viciae-fabae; and other rots and diseases such as those caused by Cryptococcus spp., Exobasidium vexans, Marasmiellus inoderma, Mycena spp., Sphacelotheca reiliana, Typhula ishikariensis, Urocystis agropyri, Itersonilia perplexans, Corticium invisum, Laetisaria fuciformis, Waitea circinata, Rhizoctonia solani, Thanetephorus cucurmeris, Entyloma dahliae, Entylomella microspora, Neovossia moliniae and Tilletia caries.

Blastocladiomycetes, such as Physoderma maydis.

Mucoromycetes, such as Choanephora cucurbitarum; Mucor spp.; Rhizopus arrhizus,

As well as diseases caused by other species and genera closely related to those listed above.

In addition to their fungicidal activity, the compounds and compositions comprising them may also have activity against bacteria such as Erwinia amylovora, Erwinia caratovora, Xanthomonas campestris, Pseudomonas syringae, Streptomyces scabies and other related species as well as certain protozoa.

Compounds of formula (I) may be mixed with one or more of compounds selected from those in the following chemical or functional classes:—1,2,4-thiadiazoles, 2,6-dinitroanilines, acylalanines, aliphatic nitrogenous compounds, amidines, aminopyrimidinols, anilides, anilino-pyrimidines, anthraquinones, antibiotics, aryl-phenylketones, benzamides, benzene-sulfonamides, benzimidazoles, benzothiazoles, benzothiodiazoles, benzothiophenes, benzoylpyridines, benzthiadiazoles, benzylcarbamates, butylamines, carbamates, carboxamides, carpropamids, chloronitriles, cinnamic acid amides, copper containing compounds, cyanoacetamideoximes, cyanoacrylates, cyanoimidazoles, cyanomethylene-thiazolidines, dicarbonitriles, dicarboxamides, dicarboximides, dimethylsulphamates, dinitrophenol carbonates, dinitrophenysl, dinitrophenyl crotonates, diphenyl phosphates, dithiino compounds, dithiocarbamates, dithioethers, dithiolanes, ethyl-amino-thiazole carboxamides, ethyl-phosphonates, furan carboxamides, glucopyranosyls, glucopyranoxyls, glutaronitriles, guanidines, herbicides/plant growth regulatosr, hexopyranosyl antibiotics, hydroxy(2-amino)pyrimidines, hydroxyanilides, hydroxyisoxazoles, imidazoles, imidazolinones, insecticides/plant growth regulators, isobenzofuranones, isoxazolidinyl-pyridines, isoxazolines, maleimides, mandelic acid amides, mectin derivatives, morpholines, norpholines, n-phenyl carbamates, organotin compounds, oxathiin carboxamides, oxazoles, oxazolidine-diones, phenols, phenoxy quinolines, phenyl-acetamides, phenylamides, phenylbenzamides, phenyl-oxo-ethyl-thiophenes amides, phenylpyrroles, phenylureas, phosphorothiolates, phosphorus acids, phthalamic acids, phthalimides, picolinamides, piperazines, piperidines, plant extracts, polyoxins, propionamides, pthalimides, pyrazole-4-carboxamides, pyrazolinones, pyridazinones, pyridines, pyridine carboxamides, pyridinyl-ethyl benzamides, pyrimdinamines, pyrimidines, pyrimidine-amines, pyrimidione-hydrazone, pyrrolidines, pyrrolquinoliones, quinazolinones, quinolines, quinoline derivatives, quinoline-7-carboxylic acids, quinoxalines, spiroketalamines, strobilurins, sulfamoyl triazoles, sulphamides, tetrazolyloximes, thiadiazines, thiadiazole carboxamides, thiazole carboxanides, thiocyanates, thiophene carboxamides, toluamides, triazines, triazobenthiazoles, triazoles, triazole-thiones, triazolo-pyrimidylamine, valinamide carbamates, ammonium methyl phosphonates, arsenic-containing compounds, benyimidazolylcarbamates, carbonitriles, carboxanilides, carboximidamides, carboxylic phenylamides, diphenyl pyridines, furanilides, hydrazine carboxamides, imidazoline acetates, isophthalates, isoxazolones, mercury salts, organomercury compounds, organophosphates, oxazolidinediones, pentylsulfonyl benzenes, phenyl benzamides, phosphonothionates, phosphorothioates, pyridyl carboxamides, pyridyl furfuryl ethers, pyridyl methyl ethers, SDHIs, thiadiazinanethiones, thiazolidines.

Particularly preferred fungicidal combinations include the following where “I” designates compounds of formula (I) or an individual compound selected from the table T1: I+(.+/−.)-cis-1-(4-chlorophenyl)-2-(1H-1,2,4-triazol-1-yl)-cycloheptanol (huanjunzuo), I+(2RS)-2-bromo-2-(bromomethyl)glutaronitrile (bromothalonil), I+(E)-N-methyl-2-[2-(2, 5-dimethylphenoxymethyl) phenyl]-2-methoxy-iminoacetamide, (mandestrobin), I+1-(5-bromo-2-pyridyl)-2-(2,4-difluorophenyl)-1,1-difluoro-3-(1,2,4-triazol-1-yl)propan-2-ol, I+1-methylcyclopropene, I+2-methyl-[[4-methoxy-2-[[[(3S,7R,8R,9S)-9-methyl-8-(2-methyl-1-oxopropoxy)-2,6-dioxo-7-(phenylmethyl)-1,5-dioxonan-3-yl]amino]carbonyl]-3-pyridinyl]oxy]propanoic acid methyl ester, I+2-(1-tert-butyl)-1-(2-chlorophenyl)-3-(1,2,4-triazol-1-yl)-propan-2-ol (TCDP), I+2,4-D, I+2,4-DB, I+2,6-dichloro-N-(4-trifluoromethylbenzyl)-benzamide, I+2,6-dimethyl-[1,4]dithiino[2,3-c:5,6-c′]dipyrrole-1,3,5,7(2H,6H)-tetraone, I+2-[[(1R,5S)-5-[(4-fluorophenyl)methyl]-1-hydroxy-2,2-dimethyl-cyclopentyl]methyl]-4H-1,2,4-triazole-3-thione I+2-[[3-(2-chlorophenyl)-2-(2,4-difluorophenyl)oxiran-2-yl]methyl]-4H-1,2,4-triazole-3-thione I+ametoctradin (imidium), I+2-[2-[(7,8-difluoro-2-methyl-3-quinolyl)oxy]-6-fluoro-phenyl]propan-2-ol I+2-[2-fluoro-6-[(8-fluoro-2-methyl-3-quinolyl)oxy]phenyl]propan-2-ol I+cyflufenamid, I+2-benzyl-4-chlorophenol (Chlorophene), I+3-(difluoromethyl)-N-(7-fluoro-1,1,3,3-tetramethyl-indan-4-yl)-1-methyl-pyrazole-4-carboxamide I+diclocymet, I+3-(difluoromethyl)-N-methoxy-1-methyl-N-[1-methyl-2-(2,4,6-trichlorophenyl)ethyl]pyrazole-4-carboxamide, I+3′-chloro-2-methoxy-N-[(3RS)-tetrahydro-2-oxofuran-3-yl]acet-2′,6′-xylidide (clozylacon), I+3-iodo-2-propinyl n-butylcarbamate (IPBC), I+4,4,5-trifluoro-3,3-dimethyl-1-(3-quinolyl)isoquinoline I+4,4-difluoro-3,3-dimethyl-1-(3-quinolyl)isoquinoline I+5-fluoro-3,3,4,4-tetramethyl-1-(3-quinolyl)isoquinoline I+9-fluoro-2,2-dimethyl-5-(3-quinolyl)-3H-1,4-benzoxazepine I+tebufloquin, I+4-CPA, I+5-fluoro-2-(p-tolylmethoxy)pyrimidin-4-amine I+ferimzone, I+acibenzolar, I+acibenzolar-S-methyl, I+allyl alcohol, I+ametoctradin, I+amisulbrom, I+anilazine, I+aureofungin, I+azaconazole, I+azafenidin, I+azithiram, I+azoxystrobin, I+benalaxyl, I+benalaxyl-M, I+benalaxyl-M (kiralaxyl), I+benomyl, I+benthiavalicarb, I+benthiazole (TCMTB), I+benzalkonium chloride, I+benzamorf, I+benzovindiflupyr (solatenol), I+bethoxazin, I+biphenyl, I+bitertanol (biloxazol), I+bixafen, I+BLAD, I+blasticidin-S, I+Bordeaux mixture, I+boscalid, I+bromuconazole, I+bupirimate, I+but-3-ynyl N-[6-[[(Z)-[(1-methyltetrazol-5-yl)-phenyl-methylene]amino]oxymethyl]-2-pyridyl]carbamate I+dazomet, I+butylamine, I+calcium polysulfide, I+captafol, I+captan, I+carbaryl, I+carbendazim, I+carbendazim chlorhydrate, I+carboxin, I+CAS 517875-34-2 (DAS777), I+chinomethionate, I+chinomethionate (oxythioquinox, quinoxymethionate), I+chitosan, I+chlobenthiazone, I+chlorfenazole, I+chlormequat, I+chloroneb, I+chloropicrin, I+chlorothalonil, I+chlozolinate, I+climbazole, I+clofencet, I+copper acetate, I+copper carbonate, I+copper hydroxide, I+copper naphthenate, I+copper oleate, I+copper oxychloride, I+copper oxyquinolate, I+copper silicate, I+copper sulphate, I+copper tallate, I+coumoxystrobin, I+cresol, I+cuprous oxide, I+cyazofamid, I+cyclafuramid, I+cymoxanil, I+cyproconazole, I+cyprodinil, I+daracide, I+dichlofluanid, I+dichlorophen (dichlorophene), I+dichlorprop, I+diclomezine, I+dicloran, I+diethofencarb, I+difenoconazole, I+difenzoquat, I+diflumetorim, I+dimetachlone (dimethaclone), I+dimetconazole, I+dimethipin, I+dimethirimol, I+dimethomorph, I+dimoxystrobin, I+dingjunezuo (Jun Si Qi), I+diniconazole, I+diniconazole-M, I+, I+dinobuton, I+dinocap, I+dinocton, I+dinopenton, I+diphenylamine, I+dipyrithione, I+ditalimfos, I+dithianon, I+dithioether, I+dodemorph, I+dodicin, I+dodine, I+doguadine, I+drazoxolon, I+edifenphos, I+endothal, I+enestroburin, enoxastrobin I+fenamistrobin, I+epoxiconazole, I+etaconazole, I+etem, I+ethaboxam, I+ethephon, I+ethoxyquin, I+famoxadone, I+fenamidone, I+fenarimol, I+fenbuconazole, I+fenfuram, I+fenhexamid, I+fenoxanil, I+fenpiclonil, I+fenpropidin, I+fenpropimorph, I+fenpyrazamine, I+fentin acetate, I+fentin hydroxide, I+ferbam, I+fluazinam, I+fludioxonil, I+flufenoxystrobin, I+flumetralin, I+flumorph, I+fluopicolide, I+fluopicolide (flupicolide), I+fluopyram, I+fluoroimide, I+fluoxastrobin, I+fluquinconazole, I+flusilazole, I+flusulfamide, I+flutianil, I+flutolanil, I+flutriafol, I+fluxapyroxad, I+folpet, I+forchlorfenuron, I+fosetyl, I+fuberidazole, I+furalaxyl, I+furametpyr, I+gibberellic acid, I+gibberellins, I+guazatine, I+hexachlorobenzene, I+hexaconazole, I+hymexazol, I+hymexazole, hydroxyisoxazole I+imazalil, I+I+etridiazole, I+imazalil, I+imazalil sulphate, I+imibenconazole, I+iminoctadine, I+iminoctadine triacetate, I+iodocarb (isopropanyl butylcarbamate), I+ipconazole, I+iprobenfos, I+iprodione, I+iprovalicarb, I+isofetamid, I+isopropanyl butylcarbamate (iodocarb), I+isoprothiolane, I+isopyrazam, I+isotianil, I+kasugamycin, I+kresoxim-methyl, I+KSF-1002, I+maleic hydrazide, I+mancozeb, I+mandestrobin, I+mandipropamid, I+maneb, I+mepanipyrim, I+mepiquat, I+mepronil, I+meptyldinocap, I+metalaxyl, I+metalaxyl-M (mefenoxam), I+metam, I+metaminostrobin, I+metconazole, I+methyl bromide, I+methyl iodide, I+methyl isothiocyanate, I+metiram (polyram), I+metiram-zinc, I+metominostrobin, I+metrafenone, I+m-phenylphenol, I+myclobutanil, I+N′-(2,5-Dimethyl-4-phenoxy-phenyl)-N-ethyl-N-methyl-formamidine, I+N′-[4-(4,5-Dichloro-thiazol-2-yloxy)-2,5-dimethyl-phenyl]-N-ethyl-N-methyl-formamidine, I+N′-[4-[[3-[(4-chlorophenyl)methyl]-1,2,4-thiadiazol-5-yl]oxy]-2,5-dimethyl-phenyl]-N-ethyl-N-methyl-formamidine, I+ethirimol, I+N-(2-p-chlorobenzoylethyl)-hexaminium chloride, I+N-[(5-chloro-2-isopropyl-phenyl)methyl]-N-cyclopropyl-3-(difluoromethyl)-5-fluoro-1-methyl-pyrazole-4-carboxamide I+N-cyclopropyl-3-(difluoromethyl)-5-fluoro-N-[(2-isopropylphenyl)methyl]-1-methyl-pyrazole-4-carboxamide I+carpropamid, I+nabam, I+naphthalene acetamide, I+NNF-0721, I+octhilinone, I+ofurace, I+orysastrobin, I+osthol, I+oxadixyl, I+oxasulfuron, I+oxathiapiprolin, I+oxine-copper, I+oxolinic acid, I+oxpoconazole, I+oxycarboxin, I+paclobutrazol, I+pefurazoate, I+penconazole, I+pencycuron, I+penflufen, I+penthiopyrad, I+phenamacril, I+phosdiphen, I+phosetyl-Al, I+phosetyl-Al (fosetyl-al), I+phosphorus acids, I+phthalide (fthalide), I+picarbutrazox, I+picoxystrobin, I+piperalin, I+polycarbamate, I+polyoxin D (polyoxrim), I+p-phenylphenol, I+probenazole, I+prochloraz, I+procymidone, I+prohexadione, I+prohexadione-calcium, I+propamidine, I+propamocarb, I+propiconazole, I+propineb, I+propionic acid, I+proquinazid, I+prothioconazole, I+pyraclostrobin, I+pyrametostrobin, I+pyraoxystrobin, I+pyrazophos, I+pyribencarb (KIF-7767), I+pyrifenox, I+pyrimethanil, I+pyriofenone (IKF-309), I+pyroquilon, I+quinoxyfen, I+quintozene, I+sedaxane, I+silthiofam, I+simeconazole, I+spiroxamine, I+streptomycin, I+sulphur, I+tebuconazole, I+tebufloquin, I+tecloftalam, I+tecnazene, (TCNB), I+tetraconazole, I+thiabendazole, I+thicyofen, I+thidiazuron, I+thifluzamide, I+thiophanate-methyl, I+thiram, I+tiadinil, I+tioxymid, I+tolclofos-methyl, I+tolprocarb, I+tolylfluanid, I+triadimefon, I+triadimenol, I+triazoxide, I+tribromophenol (TBP), I+tribufos (tributyl phosphorotrithioate), I+triclopyricarb, I+tricyclazole, I+tridemorph, I+trifloxystrobin, I+triflumizole, I+triforine, I+trinexapac, I+triticonazole, I+uniconazole, I+validamycin, I+valifenalate, I+vapam, I+vapam (metam sodium), I+vinclozolin, I+zineb, I+ziram, I+zoxamide, I+a-naphthalene acetic acid.

Compounds of this invention can also be mixed with one or more further pesticides including insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

Examples of such agricultural protectants with which compounds of this invention can be formulated are:

Insecticides such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron;

Bactericides such as streptomycin;

Acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and

Biological agents such as Bacillus thuringiensis, Bacillus thuringiensis delta endotoxin, baculovirus, and entomopathogenic bacteria, virus and fungi.

Plant disease control is ordinarily accomplished by applying an effective amount of a compound of this invention either pre- or post-infection, to the portion of the plant to be protected such as the roots, stems, foliage, fruit, seeds, tubers or bulbs, or to the media (soil or sand) in which the plants to be protected are growing. The compounds may also be applied to seeds to protect the seeds and seedlings developing from the seeds. The compounds may also be applied through irrigation water to treat plants.

The present invention envisages application of the compounds of the invention to plant propagation material prior to, during, or after planting, or any combination of these.

Although active ingredients can be applied to plant propagation material in any physiological state, a common approach is to use seeds in a sufficiently durable state to incurr no damage during the treatment process. Typically, seed would have been harvested from the field; removed from the plant; and separated from any cob, stalk, outer husk, and surrounding pulp or other non-seed plant material. Seed would preferably also be biologically stable to the extent that treatment would not cause biological damage to the seed. It is believed that treatment can be applied to seed at any time between seed harvest and sowing of seed including during the sowing process.

Methods for applying or treating active ingredients on to plant propagation material or to the locus of planting are known in the art and include dressing, coating, pelleting and soaking as well as nursery tray application, in furrow application, soil drenching, soil injection, drip irrigation, application through sprinklers or central pivot, or incorporation into soil (broad cast or in band). Alternatively or in addition active ingredients may be applied on a suitable substrate sown together with the plant propagation material.

Rates of application for these compounds can be influenced by many factors of the environment and should be determined under actual use conditions. Foliage can normally be protected when treated at a rate of from less than about 1 g/ha to about 5,000 g/ha of active ingredient. Seed and seedlings can normally be protected when seed is treated at a rate of from about 0.1 to about 10 g per kilogram of seed.

Crops of useful plants in which the composition according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, e.g. imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I® and LibertyLink®.

Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi.

An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

The compounds according to the invention can be used as pesticidal agents in unmodified form, but they are generally formulated into compositions in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood N.J. (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The inventive compositions generally comprise from 0.1 to 99% by weight, especially from 0.1 to 95% by weight, of compounds of the present invention and from 1 to 99.9% by weight of a formulation adjuvant which preferably includes from 0 to 25% by weight of a surface-active substance. Whereas commercial products may preferably be formulated as concentrates, the end user will normally employ dilute formulations.

The rates of application vary within wide limits and depend on the nature of the soil, the method of application, the crop plant, the pest to be controlled, the prevailing climatic conditions, and other factors governed by the method of application, the time of application and the target crop. As a general guideline compounds may be applied at a rate of from 1 to 2000 I/ha, especially from 10 to 1000 I/ha.

Preferred formulations can have the following compositions (weight %):

### Emulsifiable Concentrates:

active ingredient: 1 to 95%, preferably 60 to 90%
surface-active agent: 1 to 30%, preferably 5 to 20%
liquid carrier: 1 to 80%, preferably 1 to 35%

### Dusts:

active ingredient: 0.1 to 10%, preferably 0.1 to 5%
solid carrier: 99.9 to 90%, preferably 99.9 to 99%

### Suspension Concentrates:

active ingredient: 5 to 75%, preferably 10 to 50%
water: 94 to 24%, preferably 88 to 30%
surface-active agent: 1 to 40%, preferably 2 to 30%

### Wettable Powders:

active ingredient: 0.5 to 90%, preferably 1 to 80%
surface-active agent: 0.5 to 20%, preferably 1 to 15%
solid carrier: 5 to 95%, preferably 15 to 90%

### Granules:

active ingredient: 0.1 to 30%, preferably 0.1 to 15%
solid carrier: 99.5 to 70%, preferably 97 to 85%

The following Examples further illustrate, but do not limit, the invention.

| Wettable powders | a) | b) | c) |
|---|---|---|---|
| active ingredients | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

Emulsifiable concentrate

| | |
|---|---|
| active ingredients | 10% |
| octylphenol polyethylene glycol ether | 3% |
| (4-5 mol of ethylene oxide) | |
| calcium dodecylbenzenesulfonate | 3% |
| castor oil polyglycol ether | 4% |
| (35 mol of ethylene oxide) | |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

| Extruder granules | |
|---|---|
| Active ingredients | 15% |
| sodium lignosulfonate | 2% |
| carboxymethylcellulose | 1% |
| Kaolin | 82% |

The combination is mixed and ground with the adjuvants, and the mixture is moistened with water.

The mixture is extruded and then dried in a stream of air.

Coated granules

| | |
|---|---|
| Active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

Suspension concentrate

| | |
|---|---|
| active ingredients | 40% |
| propylene glycol | 10% |
| nonylphenol polyethylene glycol ether | 6% |
| (15 mol of ethylene oxide) | |
| Sodium lignosulfonate | 10% |
| carboxymethylcellulose | 1% |
| silicone oil (in the form of a 75% | 1% |
| emulsion in water) | |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of | 0.5% |
| a 20% solution in water) | |
| monoazo-pigment calcium salt | 5% |
| Silicone oil (in the form of a 75% | 0.2% |
| emulsion in water) | |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Slow Release Capsule Suspension

28 parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

The Examples which follow serve to illustrate the invention. The compounds of the invention can be distinguished from known compounds by virtue of greater efficacy at low application rates, which can be verified by the person skilled in the art using the experimental procedures outlined in the Examples, using lower application rates if necessary, for example 50 ppm, 12.5 ppm, 6 ppm, 3 ppm, 1.5 ppm or 0.8 ppm.

### PREPARATION EXAMPLES

The following examples illustrate the above-described invention in greater detail without limiting it.

### Example 1: Synthesis of (2-formyl-5-phenyl-phenyl) trifluoromethanesulfonate

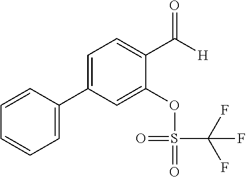 [SMILES: O=Cc1ccc(-c2ccccc2)cc1OS(=O)(=O)C(F)(F)F]

To a stirred solution of 2-hydroxy-4-phenyl-benzaldehyde (4.80 g, 23.0 mmol, 95 mass %) and pyridine (2.0 equiv., 46.0 mmol, 99.8 mass %) in dichloromethane (15 mL/mmol, 99.9 mass %) at 0° C. under argon, was added triflic anhydride (1.50 equiv., 34.5 mmol, 98 mass %). The mixture was stirred for 30 min at 0° C. and 1 h at 20° C. Water was added to the mixture which was transferred in an extracting funnel. Organics were washed again with water and brine, dried and evaporated to afford (2-formyl-5-phenyl-phenyl) trifluoromethanesulfonate (8.0 g, 22 mmol, 90 mass %, 95% Yield) as a brown solid.

LC-MS: rt 1.12 min −

### Example 2: Synthesis of 4-phenyl-2-(4,4,5,5-tetramethyl-1,3,2-dioxaborolan-2-yl)benzaldehyde

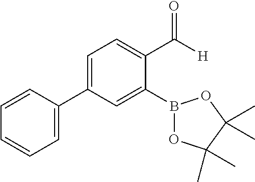 [SMILES: CC1(C)OB(c2cc(-c3ccccc3)ccc2C=O)OC1(C)C]

To a solution of (2-formyl-5-phenyl-phenyl) trifluoromethanesulfonate (8.0 g, 22 mmol, 90 mass %) in dioxane (12 mL/mmol, 99.5 mass %), was added bis(pinacolato)diboron (Pin₂B2) (1.10 equiv., 24 mmol, 98 mass %), potassium acetate (1.50 equiv., 33 mmol, 99.0 mass %) and [1,1′-Bis(diphenylphosphino)ferrocene]dichloropalladium(II) complex with dichloromethane (0.050 equiv., 1.1 mmol, 98 mass %) under nitrogen. The solution was stirred at 80° C. for 18 h. Most of the solvent was removed under reduced pressure. The residue was dissolved in ethyl acetate and the organic phase was washed with water, water (pH 3), water and brine. It was then dried over sodium sulfate, filtered over celite pad and evaporated to afford the crude which was subject to flash chromatography over silicagel (80 g prepacked column) with cyclohexane/ethyl acetate 95:5 to 8:2 as eluent. After evaporation of fractions the solid obtained was recrystallized in cyclohexane. 4-phenyl-2-(4,4,5,5-tetramethyl-1,3,2-dioxaborolan-2-yl)benzaldehyde (5.6 g, 18 mmol, 95 mass %, 83% Yield) was obtained as a white solid.

LC-MS: rt 0.79 min −

### Example 3: Synthesis of 1-hydroxy-6-phenyl-3H-2,1-benzoxaborole compound No 1

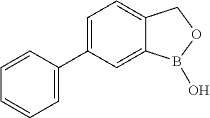 [SMILES: OB1OCc2ccc(-c3ccccc3)cc21]

4-phenyl-2-(4,4,5,5-tetramethyl-1,3,2-dioxaborolan-2-yl)benzaldehyde (2.10 g, 6.68 mmol, 98 mass %) was dissolved in methanol (7.0 mL/mmol, 99.5 mass %) and sodium borohydride (7.0 equiv., 46.7 mmol, 96 mass %) was added portionwise (9×200 mg). Strong gas bubbling and exothermic (up to 15° C.) was observed. The mixture was stirred 1 h at 5° C. and let stirred overnight at 23° C. The mixture was cooled down to 5° C. and 20 mL 4M hydrochloric acid was added carefully. A white solid precipitated in the mixture which was stirred 1 h at 23° C. Water was added. The white solid was filtered off, washed with water and dried. 1-hydroxy-6-phenyl-3H-2,1-benzoxaborole (1.38 g, 6.57 mmol, 97 mass %, 98.4% Yield) was obtained as a white solid.

LC-MS: rt 0.91 min −

¹H NMR (400 MHz, DMSO-d₆) δ ppm 5.04 (s, 2H), 7.32-7.43 (m, 1H), 7.44-7.56 (m, 3H), 7.65 (d, J=7.70 Hz, 2H), 7.76 (dd, J=7.89, 1.65 Hz, 1H), 7.99 (s, 1H), 9.22 (s, 1H).

### Example 4: Synthesis of 5-chloro-1-hydroxy-6-iodo-3H-2,1-benzoxaborole

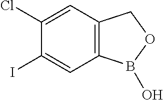 [SMILES: OB1OCc2cc(Cl)c(I)cc21]

To a solution of PTSA monohydrate (2.5 equiv., 200 mmol, 99 mass %) in acetonitrile (5.0 mL/mmol, 99.5 mass %) was added 5-chloro-1-hydroxy-3H-2,1-benzoxaborol-6-amine (15.0 g, 80.2 mmol, 98 mass %) and the grey suspension obtained was stirred for 10 min at 20° C. The mixture was cooled to 17-20° C. and a solution of sodium nitrite (2.0 equiv., 160 mmol, 99 mass %) and potassium iodide (2.1 equiv., 168 mmol, 99 mass %) in water (0.60 mL/mmol, 100 mass %) was added drop wise (1 h) via dropping funnel. During addition the mixture turned dark brown quickly, gas release was observed and mixture became thicker (stirring to be increased a lot). The mixture was stirred 1 h at 20° C. Water (350 mL), sat. sodium hydrogen carbonate (50 mL), 2M sodium thiosulfate (50 mL) was added to the stirred mixture. The crude was extracted three times with ethyl acetate. Combined organics were washed with water, dried over sodium sulfate, evaporated under reduced pressure to afford the crude as red solid. The crude was triturated in isopropanol/water, filtered again and dried in the vacuum oven. 5-chloro-1-hydroxy-6-iodo-3H-2,1-benzoxaborole (18.2 g, 59 mmol, 95 mass %, 73% Yield) was obtained as a yellow solid.

¹H NMR (400 MHz, DMSO-d₆) δ ppm 4.93 (s, 2H), 7.70 (s, 1H), 8.28 (s, 1H), 9.29-9.46 (m, 1H).

### Example 5: Synthesis of 2-(5-chloro-1-hydroxy-3H-2,1-benzoxaborol-6-yl)ethynyl-trimethyl-silane

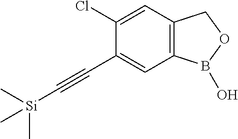 [SMILES: C[Si](C)(C)C#Cc1cc2c(cc1Cl)COB2O]

5-chloro-1-hydroxy-6-iodo-3H-2,1-benzoxaborole (2.50 g, 8.07 mmol, 95 mass %) was dissolved in degased dimethylformamide (8.0 mL/mmol, 830 mmol, 99.7 mass %) and were added respectively ethynyl(trimethyl)silane (4.0 equiv., 32.3 mmol, 98 mass %), copper iodide (0.050 equiv., 0.404 mmol, 98 mass %), PdCl2(PPh3)2 (0.10 equiv., 0.807 mmol, 99 mass %) and triethylamine (6.0 equiv., 48.4 mmol, 98 mass %). The mixture was stirred for 2 h at 23° C. under argon. The crude was poured in ammonium chloride solution (300 mL) and extracted with ethyl acetate (3×100 mL). Organics were washed with water (2×100 mL−pH 4), and brine (100 mL) dried over sodium sulfate and evaporated under reduced pressure. The crude was subject to flash chromatography over silica gel with dichloromethane/methanol 99:1 to 95:5 as eluant. 2-(5-chloro-1-hydroxy-3H-2,1-benzoxaborol-6-yl)ethynyl-trimethyl-silane (2.8 g, 5.7 mmol, 54 mass %, 71% Yield) was obtained as a solid.

LC-MS: rt 1.12 min −

¹H NMR (400 MHz, DMSO-d₆) δ ppm 0.24 (s, 9H), 5.00 (s, 2H), 7.64 (s, 1H), 7.89 (s, 1H), 9.34 (s, 1H).

### Example 6: Synthesis of 5-chloro-6-ethynyl-1-hydroxy-3H-2,1-benzoxaborole

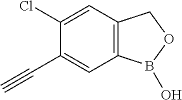

2-(5-chloro-1-hydroxy-3H-2,1-benzoxaborol-6-yl)ethynyl-trimethyl-silane (2.10 g, 4.29 mmol, 54 mass %) was dissolved in tetrahydrofuran (5.0 mL/mmol, 100 mass %) and TBAF (2.0 equiv., 8.57 mmol, 1.0 mol/L) was added to the stirred mixture which was stirred for 2 h at 23° C. The mixture was poured in sodium hydrogen carbonate solution and brine and extracted with ethyl acetate three times. Combined organics were evaporated and dissolved again in ethyl acetate. This organic phase was washed with water (pH 4) then dried over sodium sulfate and evaporated under reduced pressure to afford the crude as a red solid. The crude was subject to reverse phase column chromatography. 5-chloro-6-ethynyl-1-hydroxy-3H-2,1-benzoxaborole (334 mg, 1.736 mmol, 98 mass %, 40% Yield) was obtained as a solid.

LC-MS: rt 0.82 min −

### Example 7: Synthesis of 5-chloro-6-cyclohexa-1,4-dien-1-yl-1-hydroxy-3H-2,1-benzoxaborole

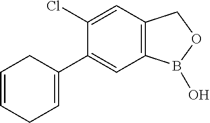 [SMILES: OB1OCc2cc(Cl)c(C3=CCC=CC3)cc21]

To a stirred suspension of CoBr2(dppe) (0.10 equiv., 0.104 mmol, 97 mass %), Zn powder (0.10 equiv., 0.104 mmol, 99.99 mass %) and Znl₂ (0.20 equiv., 0.208 mmol, 99.99 mass %) in dichloromethane (5 mL/mmol, 99.9 mass %) at 23° C. under argon atmosphere, 5-chloro-6-ethynyl-1-hydroxy-3H-2,1-benzoxaborole (0.200 g, 1.04 mmol, 98 mass %) was added and buta-1,3-diene (99.5 mass %) was let bubbling slowly directly to the solution for 5 h. Gas bomb of butadiene was closed and the mixture was stirred overnight at 23° C. The mixture was filtered over celite (washed with DCM and DCM/methanol), evaporated and the green residue subject to flash chromatography over silica gel (24 g prepacked column) with dichloromethane/methanol 99:1 to 95:5 as eluent. 5-chloro-6-cyclohexa-1,4-dien-1-yl-1-hydroxy-3H-2,1-benzoxaborole (115 mg, 0.467 mmol, 98 mass %, 45% Yield) was obtained as a white solid.

¹H NMR (400 MHz, DMSO-d₆) δ ppm 2.78-2.95 (m, 4H), 4.97 (s, 2H), 5.65 (d, J=1.47 Hz, 1H), 5.73-5.85 (m, 2H), 7.51 (s, 1H), 7.57 (s, 1H), 9.21-9.29 (m, 1H).

### Example 8: Synthesis of 5-chloro-1-hydroxy-6-phenyl-3H-2, 1-benzoxaborole compound No 3

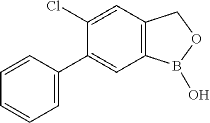 [SMILES: OB1OCc2cc(Cl)c(-c3ccccc3)cc21]

5-chloro-6-cyclohexa-1,4-dien-1-yl-1-hydroxy-3H-2,1-benzoxaborole (0.090 g, 0.37 mmol, 98 mass %) was dissolved in toluene (10 mL/mmol, 99.9 mass %) and DDQ (1.10 equiv., 0.40 mmol, 98 mass %) was added. The mixture was stirred 1 h30 at 23° C. The mixture was evaporated under reduced pressure and subject to flash chromatography over silicagel (40 g prepacked column) with dichloromethane/methanol 100:0 to 95:5 as eluant. Fraction were combined and evaporated to afford 5-chloro-1-hydroxy-6-phenyl-3H-2,1-benzoxaborole (84 mg, 0.3264 mmol, 95 mass %, 89% Yield) was recovered as a light yellow solid.

LC-MS: rt 0.98 min

¹H NMR (400 MHz, DMSO-d₆) δ ppm 5.03 (s, 2H) 7.39-7.44 (m, 3H) 7.45-7.50 (m, 2H) 7.65 (s, 1H) 7.71 (s, 1H) 9.32 (s, 1H).

### Example 9: Synthesis of 5-chloro-1-hydroxy-6-(2-methoxyphenyl)-3H-2,1-benzoxaborole compound No 7 and 5-chloro-1-hydroxy-6-(4-methoxyphenyl)-3H-2,1-benzoxaborole compound No 8

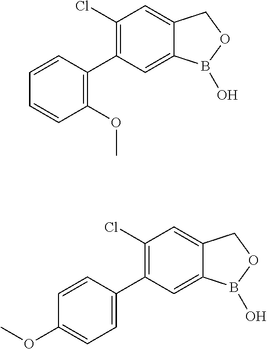 [SMILES: COc1ccccc1-c1cc2c(cc1Cl)COB2O ; COc1ccc(-c2cc3c(cc2Cl)COB3O)cc1]

Under argon, 5-chloro-1-hydroxy-3H-2,1-benzoxaborol-6-amine (0.95 g, 5.00 mmol, 97 mass %) was suspended in anisole (3.0 mL/mmol, 136 mmol, 99 mass %). One drop of trifluoro acetic acid (0.050 equiv., 0.250 mmol, 99.5 mass %) was added, temperature of the mixture was increased to 45° C. and tert-butyl nitrite (1.5 equiv., 7.50 mmol, 90 mass %) was added dropwise. The colour of the suspension turned from grey to red/brown, solubilisation occurred and bubbling was observed. It was stirred for 40 min at 45° C. Anisole was removed by concentration under reduced pressure. The red oily residue was dissolved in ethyl acetate and the organic phase was washed with water (pH 2) and then water. The phase was dried and evaporated under reduced pressure to afford the crude as red oil (1.50 g). The crude was purified by reverse phase column chromatography.

5-chloro-1-hydroxy-6-(2-methoxyphenyl)-3H-2,1-benzoxaborole (348 mg, 1.204 mmol, 95 mass %, 24% Yield) was recovered as a brown solid.

LC-MS: rt 0.95 min −

¹H NMR (400 MHz, chloroform-d) δ ppm 3.78 (s, 3H), 5.11 (s, 2H), 5.49 (br. s., 1H), 6.93-7.07 (m, 2H), 7.18 (dd, J=7.34, 1.47 Hz, 1H), 7.34-7.43 (m, 1H), 7.45 (s, 1H), 7.66 (s, 1H) 5-chloro-1-hydroxy-6-(4-methoxyphenyl)-3H-2,1-benzoxaborole (249 mg, 0.8164 mmol, 90 mass %, 16% Yield) was recovered as a brown solid.

LC-MS: rt 0.97 min −

¹H NMR (400 MHz, chloroform-d) 6 ppm 3.86 (s, 3H), 5.11 (s, 2H), 5.46 (br. s., 1H), 6.94-6.99 (d, J=8.80 Hz, 2H), 7.37 (d, J=8.44 Hz, 2H), 7.46 (s, 1H), 7.69 (s, 1H)

### Example 10: Synthesis of N-[2-(5-chloro-1-hydroxy-3H-2,1-benzoxaborol-6-yl)-4-fluoro-phenyl]acetamide compound No 19 and N-[3-(5-chloro-1-hydroxy-3H-2,1-benzoxaborol-6-yl)-4-fluoro-phenyl]acetamide compound No 20

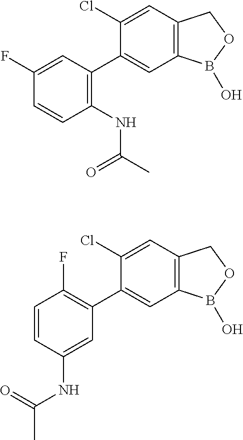 [SMILES: CC(=O)Nc1ccc(F)cc1-c1cc2c(cc1Cl)COB2O ; CC(=O)Nc1ccc(F)c(-c2cc3c(cc2Cl)COB3O)c1]

5-chloro-1-hydroxy-3H-2,1-benzoxaborol-6-amine (0.19 g, 1.0 mmol, 97 mass %) was suspended in acetonitrile (5.0 mL/mmol, 95 mmol, 99.9 mass %) and N-(4-fluorophenyl)acetamide (8.0 equiv., 8.0 mmol, 95 mass %) was added. Temperature of the mixture was increased to 45° C. and hydrobromic acid, 48% in water (0.05 equiv., 0.050 mmol, 48 mass %) was added followed by tert-butyl nitrite (1.50 equiv., 1.5 mmol, 90 mass %) at once. The mixture was stirred for 2 h at 45° C. The mixture was fully evaporated to afford the crude which was subject to reverse phase column chromatography.

N-[2-(5-chloro-1-hydroxy-3H-2,1-benzoxaborol-6-yl)-4-fluoro-phenyl]acetamide (27 mg, 0.081 mmol, 95 mass %, 8% Yield) was recovered as a solid.

LC-MS: rt 0.81 min 320/322 ES+[M+H]+

¹⁹F NMR (377 MHz, DMSO-d₆) δ ppm −117.94 (s, 1F)

¹H NMR (400 MHz, DMSO-d₆) δ ppm 1.82 (s, 3H), 5.04 (s, 2H), 7.08 (dd, J=9.17, 2.93 Hz, 1H), 7.24 (td, J=8.62, 2.93 Hz, 1H), 7.54-7.68 (m, 3H), 9.01 (s, 1H), 9.35 (br. s., 1H)

N-[3-(5-chloro-1-hydroxy-3H-2,1-benzoxaborol-6-yl)-4-fluoro-phenyl]acetamide (6.7 mg, 0.016 mmol, 75 mass %, 2% Yield) was recovered as a solid.

LC-MS: rt 0.82 min 320/322 ES+[M+H]+

¹⁹F NMR (377 MHz, DMSO-d₆) δ ppm −121.24 (s, 1F)

¹H NMR (400 MHz, DMSO-d₆) δ ppm 2.04 (s, 3H), 5.05 (s, 2H), 7.26 (t, J=9.17 Hz, 1H), 7.39 (d, J=7.70 Hz, 1H), 7.56-7.65 (m, 2H), 7.69 (d, J=7.34 Hz, 1H), 9.29 (s, 1H), 9.34 (s, 1H)

### Example 11: Synthesis of 5-chloro-1-hydroxy-6-phenyl-3H-2,1-benzoxaborole compound No 3

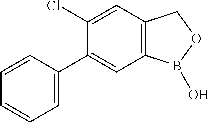 [SMILES: OB1OCc2cc(Cl)c(-c3ccccc3)cc21]

5-chloro-1-hydroxy-3H-2,1-benzoxaborol-6-amine (9.45 g, 50.0 mmol, 97 mass %) was suspended in benzene (125 mL, 2.5 mL/mmol, 99.5 mass %) and ethanol (10 mL). TFA (0.20 mL, 0.050 equiv., 99.5 mass %) was added, temperature of the mixture was increased to 45° C. and tert-butyl nitrite (10.0 mL, 1.50 equiv., 90 mass %) dissolved in ethanol (15 mL) was added dropwise via the dropping funnel (40 min). Gas release and exothermic (to 50° C.) observed. It was stirred for 1 h at 45° C. Solvent was removed by concentration under reduced pressure and the crude was subject to flash chromatography over silicagel (110 g prepacked column) with dichloromethane/methanol 99.5:0.5 to 97:3 as eluant. The yellow solid obtained was recrystallized in cyclohexane. 5-chloro-1-hydroxy-6-phenyl-3H-2,1-benzoxaborole (4.07 g, 98 mass %, 35% Yield) was recovered as a white crystalline solid.

LC-MS: rt 1.00 min −

¹H NMR (400 MHz, DMSO-d₆) δ ppm 5.03 (s, 2H), 7.38-7.44 (m, 3H), 7.45-7.52 (m, 2H), 7.65 (s, 1H), 7.71 (s, 1H), 9.31 (s, 1H)

### Example 12: Synthesis of 5-fluoro-1-hydroxy-6-iodo-3H-2,1-benzoxaborole

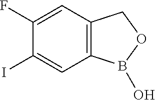 [SMILES: OB1OCc2cc(F)c(I)cc21]

To a solution of p-toluenesulfonic acid (PTSA) monohydrate (3 equiv., 35.9396 mmol, 100 mass %) in acetonitrile (25.0 mL, 99.5 mass %) was added 5-fluoro-1-hydroxy-3H-2,1-benzoxaborol-6-amine (2.0 g, 11.9798 mmol, 100 mass %) and the grey suspension obtained was stirred for 10 min at 20° C. The mixture was cooled to 0° C. and a solution of sodium nitrite (2.0 equiv., 23.9597 mmol, 99 mass %) and potassium iodide (2.5 equiv., 29.9496 mmol, 99 mass %) in water (5 mL, 100 mass %) was added drop wise (1 h) via dropping funnel. During addition the mixture turned dark brown quickly, gas release was observed and mixture became thicker (stirring to be increased a lot). The mixture was stirred 1 h at 20° C. Water (50 mL), sat. Sodium hydrogen carbonate (25 mL), 2M sodium thiosulfate (25 mL) was added to the stirred mixture. The crude was extracted three times with ethyl acetate. Combined organics were washed with water, dried over sodium sulfate, evaporated under reduced pressure to afford the crude as red solid. The crude was subject to flash chromatography over silica gel (12 g pre packed column) with Cyclohexane/Ethylacetate 99.5:0.5 to 20:80 as eluent to obtain 5-fluoro-1-hydroxy-6-iodo-3H-2,1-benzoxaborole (1.4 g, 5 mmol, 100 mass %, 42% Yield) was obtained as a white solid.

¹H NMR (400 MHz, DMSO-d₆) δ ppm 4.94 (s, 2H), 7.36 (s, 1H), 8.16 (s, 1H), 9.32 (s, 1H)

LCMS: rt 1.72 min 276.8−ESI

### Example 13: Synthesis of N8-(5-fluoro-6-iodo-3H-2,1-benzoxaborol-1-yl)-N1,N1,N8-trimethyl-naphthalene-1,8-diamine

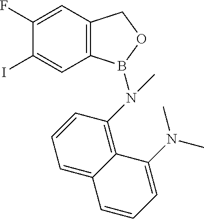 [SMILES: CN(C)c1cccc2cccc(N(C)B3OCc4cc(F)c(I)cc43)c12]

To a stirred solution of 5-fluoro-1-hydroxy-6-iodo-3H-2,1-benzoxaborole (1.38 g 4.9 mmol, 95 mass %) in toluene (100 mL, 99.9 mass %) was added N1,N1,N8-trimethylnaphthalene-1,8-diamine (1.0 equiv., 4.9 mmol, 99.8 mass %) at 23° C. under argon. The reaction mass was stirred for 1 h at 120° C. accompanied by azeotropic removal of water. Toluene was distilled to obtain the crude. The crude mass was washed with ethyl acetate to afford (N8-(5-fluoro-6-iodo-3H-2,1-benzoxaborol-1-yl)-N1,N1,N8-trimethyl-naphthalene-1,8-diamine (1.6 g, 3.5 mmol, 95 mass %, 70% Yield) as a pale yellow solid.

¹H NMR (400 MHz, DMSO-d6) δ ppm 2.68-2.75 (m, 6H) 2.80 (s, 3H) 5.01 (s, 2H) 6.18 (br. s., 1H) 6.53 (d, J=7.78 Hz, 1H) 7.07 (d, J=8.78 Hz, 1H) 7.16 (d, J=7.53 Hz, 1H) 7.40-7.56 (m, 3H) 7.85 (dd, J=7.78, 1.25 Hz, 1H)

LC-MS: rt 2.19-2.32 min −460.9

### Example 14: Synthesis of N8-[5-fluoro-6-(3-methoxyphenyl)-3H-2,1-benzoxaborol-1-yl]-N1,N1,N8-trimethyl-naphthalene-1,8-diamine

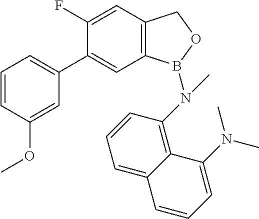 [SMILES: COc1cccc(-c2cc3c(cc2F)COB3N(C)c2cccc3cccc(N(C)C)c23)c1]

To a solution of N8-(5-fluoro-6-iodo-3H-2,1-benzoxaborol-1-yl)-N1,N1,N8-trimethyl-naphthalene-1,8-diamine (0.3 g, 0.7 mmol, 95 mass %) in tetrahydrofuran (5 mL, 99.5 mass %), was added (3-methoxyphenyl)boronic acid (1.10 equiv., 0.77 mmol, 98 mass %), cesium carbonate (2 equiv., 1 mmol, 99.0 mass %) and Bis(tri-t-butyl-phosphine)palladium(0) (0.050 equiv., 0.03 mmol, 98 mass %) under nitrogen. The solution was stirred at 60° C. for 18 h. The solvent was removed by concentration under reduced pressure. The residue was dissolved in ethyl acetate and the organic phase was washed with water and brine. It was then dried over sodium sulfate, filtered over celite pad and evaporated to dryness to obtain the crude mass. The crude was subject to flash chromatography over silica gel (4 g pre-packed column) with Cyclohexane/Ethylacetate 99.5:0.5 to 80:20 as eluent to obtain N8-[5-fluoro-6-(3-methoxyphenyl)-3H-2,1-benzoxaborol-1-yl]-N1,N1,N8-trimethyl-naphthalene-1,8-diamine (0.2 g, 0.5 mmol, 95 mass %, 70% Yield) as a off white solid.

1H NMR (400 MHz, DMSO-d6) δ ppm 2.71-2.79 (m, 6H) 2.81-2.84 (m, 3H) 3.65 (s, 3H) 5.02-5.09 (m, 2H) 5.87-5.99 (m, 1H) 6.42-6.55 (m, 2H) 6.60-6.65 (m, 1H) 6.74-6.82 (m, 1H) 7.03-7.13 (m, 2H) 7.16-7.22 (m, 1H) 7.34-7.40 (m, 1H) 7.44-7.50 (m, 1H) 7.52-7.58 (m, 1H) 7.79-7.86 (m, 1H)

### Example 15: Synthesis of 5-fluoro-6-(3-methoxy-phenyl)-3H-benzo[c][1,2] oxaborol-1-ol compound No 27

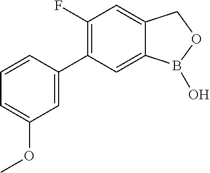 [SMILES: COc1cccc(-c2cc3c(cc2F)COB3O)c1]

To a stirred solution of N8-[5-fluoro-6-(3-methoxyphenyl)-3H-2,1-benzoxaborol-1-yl]-N1,N1,N8-trimethyl-naphthalene-1,8-diamine (0.12 g, 0.27 mmol, 95 mass %) in tetrahydrofuran (2 mL, 99.5 mass %), Hydrochloric acid (4 mL 36 mass %) and 2 drop of TFA was added at 25° C. The reaction mixture was stirred 25° C. for 18 h. The mixture was extracted with ethyl acetate and the organic phase was washed with water and brine. Organic layer was then dried over sodium sulfate, filtered over celite pad and evaporated to afford the crude. The crude was subject to flash chromatography over silica gel (4 g pre packed column) with Cyclohexane/Ethylacetate 99.5:0.5 to 80:20 as eluent to obtain 5-fluoro-1-hydroxy-6-(3-methoxyphenyl)-3H-2,1-benzoxaborole (0.05 g, 0.2 mmol, 97 mass %, 70% Yield) as a white solid.

LC-MS: rt 1.3 min −259.2 (Method-M2)

¹H NMR (400 MHz, DMSO-d6) δ ppm 3.82 (s, 3H) 5.00-5.07 (m, 2H) 6.97-7.02 (m, 1H) 7.03-7.12 (m, 2H) 7.32-7.44 (m, 2H) 7.76-7.89 (m, 1H) 9.09-9.42 (m, 1H)

### Example 16: Synthesis of 4-(5-chloro-1-hydroxy-3H-2,1-benzoxaborol-6-yl)-2-methyl-1,3-benzothiazole (Compound No. 13), 5-(5-chloro-1-hydroxy-3H-2,1-benzoxaborol-6-yl)-2-methyl-1,3-benzothiazole Compound No. 14), 7-(5-chloro-1-hydroxy-3H-2,1-benzoxaborol-6-yl)-2-methyl-1,3-benzothiazole Compound No. 15)

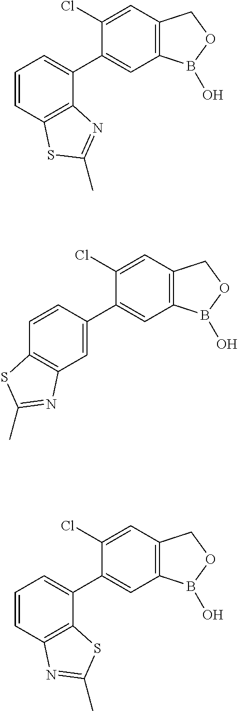 [SMILES: Cc1nc2c(-c3cc4c(cc3Cl)COB4O)cccc2s1 ; Cc1nc2cc(-c3cc4c(cc3Cl)COB4O)ccc2s1 ; Cc1nc2cccc(-c3cc4c(cc3Cl)COB4O)c2s1]

Under argon, 5-chloro-1-hydroxy-3H-2,1-benzoxaborol-6-amine (0.19 g, 1.0 mmol, 97 mass %) was suspended in acetonitrile (5.0 mL, 99.9 mass %) and 2-methyl-1,3-benzothiazole (1.0 mL, 8.0 equiv., 98 mass %) was added. Temperature of the mixture was increased to 45° C. and hydrobromic acid, 48% (0.0060 mL, 0.05 equiv., 48 mass % in water) was added followed by tert-butyl nitrite (0.20 mL, 1.50 equiv., 90 mass %) at once. The mixture was stirred for 2 h at 45° C. The mixture was fully evaporated to afford the crude which was subject to reverse phase column chromatography. Three products were obtained:

Compound No. 13: 4-(5-chloro-1-hydroxy-3H-2,1-benzoxaborol-6-yl)-2-methyl-1,3-benzothiazole (11 mg, 0.028 mmol, 80 mass %, 2.9% Yield) as resin.

¹H NMR (400 MHz, DMSO-d₆) δ ppm 2.78 (s, 3H), 5.08 (s, 2H), 7.36 (d, J=7.34 Hz, 1H), 7.60 (t, J=7.70 Hz, 1H), 7.73 (s, 1H), 7.80 (s, 1H), 7.97 (d, J=8.07 Hz, 1H), 9.35 (s, 1H)

LC-MS: RT 0.94 Min 316/318 [M+H]+

Compound No. 14: 5-(5-chloro-1-hydroxy-3H-2,1-benzoxaborol-6-yl)-2-methyl-1,3-benzothiazole (8.6 mg, 0.022 mmol, 80 mass %, 2.2% Yield) as resin.

¹H NMR (400 MHz, DMSO-d₆) δ ppm 2.83 (s, 3H), 5.05 (s, 2H), 7.51 (dd, J=8.44, 1.83 Hz, 1H), 7.68 (s, 1H), 7.78 (s, 1H), 7.98 (d, J=8.07 Hz, 1H), 8.10 (d, J=1.83 Hz, 1H), 9.33 (br. s., 1H)

LC-MS: RT 0.95 Min 316/318 [M+H]+

Compound No. 15: 7-(5-chloro-1-hydroxy-3H-2,1-benzoxaborol-6-yl)-2-methyl-1,3-benzothiazole (17 mg, 0.032 mmol, 60 mass %, 3.2% Yield) as resin.

¹H NMR (400 MHz, DMSO-d₆) δ ppm 2.73 (s, 3H), 5.07 (s, 2H), 7.38 (dd, J=7.34, 0.80 Hz, 1H), 7.48 (t, J=7.70 Hz, 1H), 7.66 (s, 1H), 7.74 (s, 1H), 8.09 (dd, J=8.07, 0.80 Hz, 1H), 9.30 (s, 1H)

LC-MS: RT 0.97 Min 316/318 [M+H]+

TABLE T1
Melting point data and/or retention times of selected compounds:

| Cpd No | Chemical structure | LC/MS | Method | melting point |
|---|---|---|---|---|
| 1 | 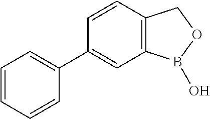 [SMILES: OB1OCc2ccc(-c3ccccc3)cc21] | RT 0.91 Min — | M2 | 140-150 |
| 2 | 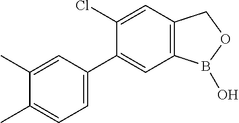 [SMILES: Cc1ccc(-c2cc3c(cc2Cl)COB3O)cc1C] | RT 1.08 Min — | M2 | 155-165 |
| 3 | 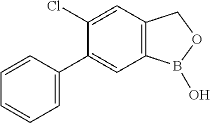 [SMILES: OB1OCc2cc(Cl)c(-c3ccccc3)cc21] | RT 1.00 Min — | M2 | 135-145 |
| 4 | 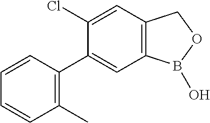 [SMILES: Cc1ccccc1-c1cc2c(cc1Cl)COB2O] | RT 1.02 Min — | M2 | solid |
| 5 | 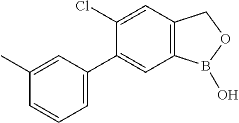 [SMILES: Cc1cccc(-c2cc3c(cc2Cl)COB3O)c1] | RT 1.04 Min — | M2 | solid |
| 6 | 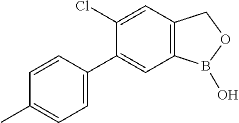 [SMILES: Cc1ccc(-c2cc3c(cc2Cl)COB3O)cc1] | RT 1.04 Min — | M2 | solid |
| 7 | 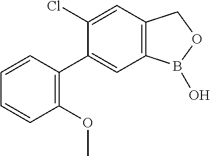 [SMILES: COc1ccccc1-c1cc2c(cc1Cl)COB2O] | RT 0.95 Min — | M2 | 90-105 |
| 8 | 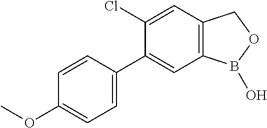 [SMILES: COc1ccc(-c2cc3c(cc2Cl)COB3O)cc1] | RT 0.97 Min — | M2 | 105-115 |
| 9 | 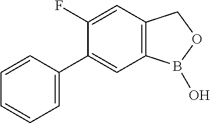 [SMILES: OB1OCc2cc(F)c(-c3ccccc3)cc21] | RT 0.93 Min 229 ES+ [M + H]+ | M2 | 142-152 |
| 10 | 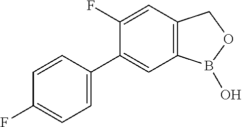 [SMILES: OB1OCc2cc(F)c(-c3ccc(F)cc3)cc21] | RT 1.19 Min 245 ES+ [M + H]− | M2 | 161-163 |
| 11 | 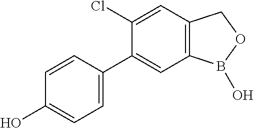 [SMILES: OB1OCc2cc(Cl)c(-c3ccc(O)cc3)cc21] | RT 0.97 Min 261 ES+ [M + H]+ | M2 | — |
| 12 | 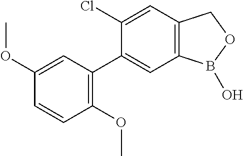 [SMILES: COc1ccc(OC)c(-c2cc3c(cc2Cl)COB3O)c1] | RT 0.94 Min — | M2 | 95-115 |
| 13 | 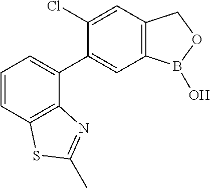 [SMILES: Cc1nc2c(-c3cc4c(cc3Cl)COB4O)cccc2s1] | RT 0.94 Min 316/318 ES+ [M + H]+ | M2 | solid |
| 14 | 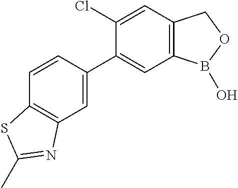 [SMILES: Cc1nc2cc(-c3cc4c(cc3Cl)COB4O)ccc2s1] | RT 0.97 Min 316/318 ES+ [M + H]+ | M2 | solid |
| 15 | 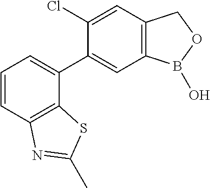 [SMILES: Cc1nc2cccc(-c3cc4c(cc3Cl)COB4O)c2s1] | RT 0.95 Min 316/318 ES+ [M + H]+ | M2 | solid |
| 16 | 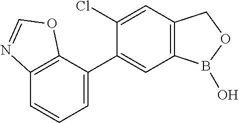 [SMILES: OB1OCc2cc(Cl)c(-c3cccc4ncoc34)cc21] | RT 0.94 Min 286/288 ES+ [M + H]+ | M2 | solid |
| 17 | 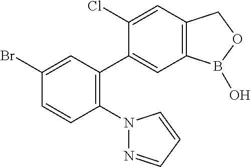 [SMILES: OB1OCc2cc(Cl)c(-c3cc(Br)ccc3-n3cccn3)cc21] | RT 1.09 Min 389/391/393 ES+ [M + H]+ | M2 | solid |
| 18 | 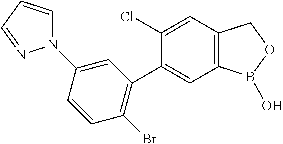 [SMILES: OB1OCc2cc(Cl)c(-c3cc(-n4cccn4)ccc3Br)cc21] | RT 1.00 Min 389/391/393 ES+ [M + H]+ | M2 | solid |
| 19 | 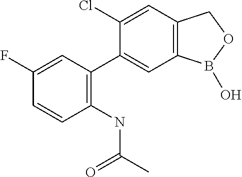 [SMILES: CC(=O)Nc1ccc(F)cc1-c1cc2c(cc1Cl)COB2O] | RT 0.81 Min 320/322 ES+ [M + H]+ | M2 | solid |
| 20 | 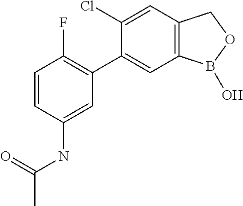 [SMILES: CC(=O)Nc1ccc(F)c(-c2cc3c(cc2Cl)COB3O)c1] | RT 0.82 Min 320/322 ES+ [M + H]+ | M2 | solid |
| 21 | 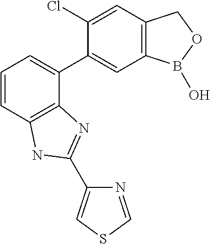 [SMILES: OB1OCc2cc(Cl)c(-c3cccc4[nH]c(-c5cscn5)nc34)cc21] | RT 0.79 Min 368/370 ES+ [M + H]+ | M2 | solid |
| 22 | 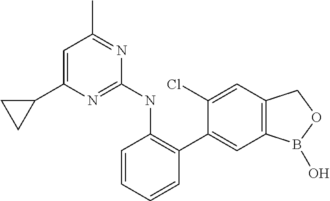 [SMILES: Cc1cc(C2CC2)nc(Nc2ccccc2-c2cc3c(cc2Cl)COB3O)n1] | RT 1.13 Min 392/394 ES+ [M + H]+ | M2 | solid |
| 23 | 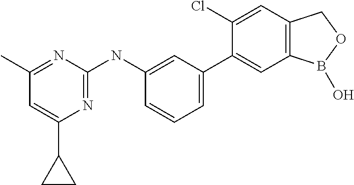 [SMILES: Cc1cc(C2CC2)nc(Nc2cccc(-c3cc4c(cc3Cl)COB4O)c2)n1] | RT 1.18 Min — | M2 | solid |
| 24 | 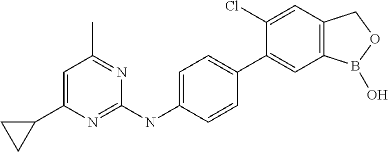 [SMILES: Cc1cc(C2CC2)nc(Nc2ccc(-c3cc4c(cc3Cl)COB4O)cc2)n1] | RT 1.18 Min — | M2 | solid |
| 25 | 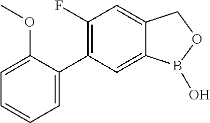 [SMILES: COc1ccccc1-c1cc2c(cc1F)COB2O] | RT 0.90 Min 259 ES+ [M + H]+ | M2 | 50-65 |
| 26 | 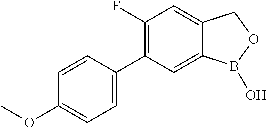 [SMILES: COc1ccc(-c2cc3c(cc2F)COB3O)cc1] | RT 0.93 Min 259 ES+ [M + H]+ | M2 | solid |
| 27 | 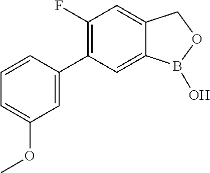 [SMILES: COc1cccc(-c2cc3c(cc2F)COB3O)c1] | RT 1.31 Min 259 ES+ [M + H]+ | M2 | 118-120 |
| 28 | 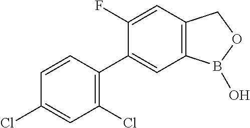 [SMILES: OB1OCc2cc(F)c(-c3ccc(Cl)cc3Cl)cc21] | RT 1.49 Min 297 ES+ [M + H]+ | M2 | Gummy mass |
| 29 | 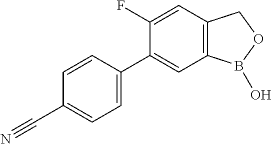 [SMILES: N#Cc1ccc(-c2cc3c(cc2F)COB3O)cc1] | RT 1.27 Min 253 ES+ [M + H]+ | M2 | 270-272 |
| 30 | 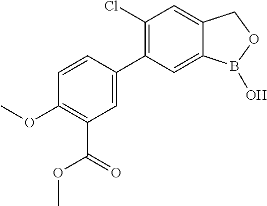 [SMILES: COC(=O)c1cc(-c2cc3c(cc2Cl)COB3O)ccc1OC] | RT 1.40 Min 331.1 [M − H]+ | M1 | — |
| 31 | 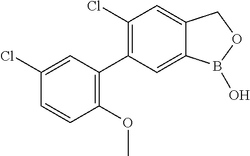 [SMILES: COc1ccc(Cl)cc1-c1cc2c(cc1Cl)COB2O] | RT 1.59 Min 307 [M − H]+ | M1 | — |
| 32 | 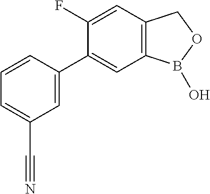 [SMILES: N#Cc1cccc(-c2cc3c(cc2F)COB3O)c1] | RT 1.76 Min 253 [M − H]+ | M2 | Gummy mass |
| 33 | 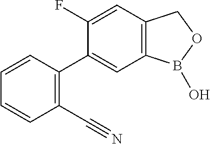 [SMILES: N#Cc1ccccc1-c1cc2c(cc1F)COB2O] | RT 1.71 Min 253 [M − H]+ | M2 | 253-255 |
| 34 | 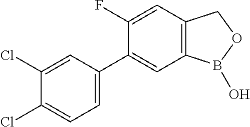 [SMILES: OB1OCc2cc(F)c(-c3ccc(Cl)c(Cl)c3)cc21] | RT 2.14 Min 297 [M − H]+ | M2 | 243-245 |
| 35 | 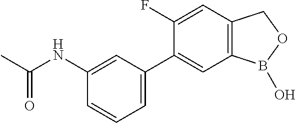 [SMILES: CC(=O)Nc1cccc(-c2cc3c(cc2F)COB3O)c1] | RT 1.54 Min 286 [M − H]+ | M2 | 199-201 |
| 36 | 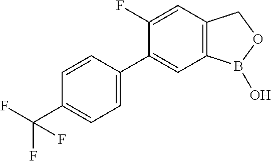 [SMILES: OB1OCc2cc(F)c(-c3ccc(C(F)(F)F)cc3)cc21] | RT 2.05 Min 297 [M − H]+ | M2 | Gummy mass |
| 37 | 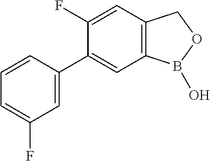 [SMILES: OB1OCc2cc(F)c(-c3cccc(F)c3)cc21] | RT 1.89 Min 246 [M − H]+ | M2 | 144-146 |
| 38 | 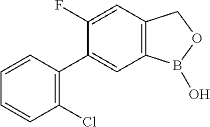 [SMILES: OB1OCc2cc(F)c(-c3ccccc3Cl)cc21] | RT 1.89 Min 262 [M − H]+ | M2 | 135-137 |

Table T1 shows all the prepared examples with selected melting point and selected NMR data for prepared compounds. CDCl₃/D₂O and DMSO are used as solvents for NMR 400 MHz measurements. No attempt is made to list all characterising data in all cases.

In Table T1 and throughout the description that follows, temperatures are given in degrees Celsius; “NMR” means nuclear magnetic resonance spectrum; MS stands for mass spectrum; “%” is percent by weight, unless corresponding concentrations are indicated in other units. The following abbreviations are used throughout this description:

| | |
|---|---|
| m.p. = melting point | b.p. = boiling point. |
| S = singlet | br = broad |
| d = doublet | dd = doublet of doublets |
| t = triplet | q = quartet |
| m = multiplet | ppm = parts per million |

The characteristic values obtained for each compound were the retention time (“Rₜ”, recorded in minutes) and the molecular ion as listed in Table 1.

The following LC-MS methods were used to characterize the compounds:

### Method: M 1

ACQUITY SQD Mass Spectrometer from Waters (Single quadrupole mass spectrometer)
Ionisation method: Electrospray
Polarity: positive ions

### Capillary (kV) 3.00, Cone (V) 20.00, Extractor (V) 3.00, Source Temperature (° C.) 150, Desolvation

### Temperature (° C.) 400, Cone Gas Flow (L/Hr) 60, Desolvation Gas Flow (L/Hr) 700

Mass range: 100 to 800 Da
DAD Wavelength range (nm): 210 to 400
Method Waters ACQUITY UPLC with the following HPLC gradient conditions
(Solvent A: Water/Methanol 9:1, 0.1% formic acid and Solvent B: Acetonitrile, 0.1% formic acid)

| Time (minutes) | A (%) | B (%) | Flow rate (ml/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

### Method: M2

### Instrumentation:—

Mass Spectrometer: 6410 Triple quadrupole Mass Spectrometer from Agilent Technologies

### HPLC: Agilent 1200 Series HPLC

### Optimized Mass Parameter

Ionisation method: Electrospray (ESI)
Polarity: positive and Negative Polarity Switch

### Scan Type: MS2 Scan

### Capillary (kV): 4.00

### Fragmentor (V): 100.00

### Gas Temperature (° C.): 350

### Gas Flow (L/min): 11

Nebulizer Gas (psi): 35
Mass range: 110 to 1000 Da
DAD Wavelength range (nm): 190 to 400
Optimized Chromatographic parameter:—

### Gradient Conditions

(Solvent A: Water, 0.1% formic acid and Solvent B: Acetonitrile, 0.1% formic acid)

| Time (minutes) | A (%) | B (%) | Flow rate (ml/min) |
|---|---|---|---|
| 0 | 90 | 10 | 1.8 |
| 2.0 | 0 | 100 | 1.8 |
| 3.0 | 0 | 100 | 1.8 |
| 3.2 | 90 | 10 | 1.8 |
| 4.0 | 90 | 10 | 1.8 |

Type of column: Waters Xterra MS C18; Column length: 30 mm; Internal diameter of column: 4.6 mm; Particle Size: 3.5μ; Temperature: 30° C.

### BIOLOGICAL EXAMPLES: FUNGICIDAL ACTION

1 Phytophthora infestans/Tomato/Leaf Disc Preventative (Late Blight)

Tomato leaf disks were placed on water agar in multiwell plates (24-well format) and sprayed with the formulated test compound diluted in water at an application rate of 200 ppm. The leaf disks were inoculated with a spore suspension of the fungus 1 day after application. The inoculated leaf disks were incubated at 16° C. and 75% relative humidity under a light regime of 24 h darkness followed by 12/12 h (light/dark) in a climate cabinet and the activity of a compound was assessed as percent disease control compared to untreated when an appropriate level of disease damage appears in untreated check leaf disks (5-7 days after application). The compounds 9 and 13 (from Table T1) at 200 ppm give at least 80% disease control in this test when compared to untreated control leaf disks under the same conditions, which show extensive disease development.

2 Plasmopara viticola/Grape/Leaf Disc Preventative (Late Blight)

Grape vine leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 19° C. and 80% relative humidity under a light regime of 12/12 h (light/dark) in a climate cabinet and the activity of a compound was assessed as percent disease control compared to untreated when an appropriate level of disease damage appears in untreated check leaf disks (6-8 days after application). The compounds 1, 3, 4, 7, 9, 10, 11, 12, 14, 15, 25 and 27 (from Table T1) at 200 ppm give at least 80% disease control in this test when compared to untreated control leaf disks under the same conditions, which show extensive disease development.

3 Puccinia recondita f. Sp. Tritici/Wheat/Leaf Disc Preventative (Brown Rust):

Wheat leaf segments cultivated variety (cv) Kanzler were placed on agar in 24-well plates and sprayed with formulated test compound diluted in water at an application rate of 200 ppm. The leaf disks were inoculated with a spore suspension of the fungus 1 day after application. The inoculated leaf segments were incubated at 19° C. and 75% relative humidity under a light regime of 12/12 h (light/dark) in a climate cabinet and the activity of a compound was assessed as percent disease control compared to untreated when an appropriate level of disease damage appears in untreated check leaf segments (7-9 days after application). The compounds 3, 4, 7, 8, 10 and 28 (from Table T1) at 200 ppm give at least 80% disease control in this test when compared to untreated control leaf disks under the same conditions, which show extensive disease development.

4 Phaeosphaeria Nodorum (Septoria nodorum)/Wheat/Leaf Disc Preventative (Glume Blotch):

Wheat leaf segments cv Kanzler were placed on agar in a 24-well plate and sprayed with formulated test compound diluted in water at an application rate of 200 ppm. The leaf disks were inoculated with a spore suspension of the fungus 2 days after application. The inoculated test leaf disks were incubated at 20° C. and 75% relative humidity under a light regime of 12/12 h (light/dark) in a climate cabinet and the activity of a compound was assessed as percent disease control compared to untreated when an appropriate level of disease damage appears in untreated check leaf disks (5-7 days after application). The compounds 1, 3, 5, 6, 7, 9 and 10 (from Table T1) at 200 ppm give at least 80% disease control in this test when compared to untreated control leaf disks under the same conditions, which show extensive disease development.

5 Pyrenophora teres/Barley/Leaf Disc Preventative (Net Blotch):

Barley leaf segments cv Hasso were placed on agar in a 24-well plate and sprayed with formulated test compound diluted in water at an application rate of 200 ppm. The leaf segments were inoculated with a spore suspension of the fungus two days after application of the test solution. The inoculated leaf segments were incubated at 20° C. and 65% relative humidity under a light regime of 12/12 h (light/dark) in a climate cabinet and the activity of a compound was assessed as disease control compared to untreated when an appropriate level of disease damage appears in untreated check leaf segments (5-7 days after application). The compound 10 (from Table T1) at 200 ppm give at least 80% disease control in this test when compared to untreated control leaf disks under the same conditions, which show extensive disease development.

6 Alternaria solani/Tomato/Leaf Disc (Early Blight)

Tomato leaf disks cultivated variety (cv.) Baby were placed on agar in multiwell plates (24-well format) and sprayed with the formulated test compound diluted in water at an application rate of 200 ppm. The leaf disks were inoculated with a spore suspension of the fungus 2 days after application. The inoculated leaf disks were incubated at 23° C./21° C. (day/night) and 80% relative humidity under a light regime of 12/12 h (light/dark) in a climate cabinet and the activity of a compound was assessed as percent disease control compared to untreated when an appropriate level of disease damage appears on untreated check disk leaf disks (5-7 days after application). The compound 1 (from Table T1) at 200 ppm give at least 80% disease control in this test when compared to untreated control leaf disks under the same conditions, which show extensive disease development.

7 Magnaporthe grisea (Pyricularia oryzae)/Rice/Leaf Disc Preventative (Rice Blast):

Rice leaf segments cv. Ballila were placed on agar in multiwell plate (24-well format) and sprayed with the formulated test compound diluted in water at an application rate of 200 ppm. The leaf segments were inoculated with a spore suspension of the fungus 2 days after application. The inoculated leaf segments were incubated at 22° C. and 80% rh under a light regime of 24 h darkness followed by 12/12 h (light/dark) in a climate cabinet and the activity of a compound was assessed as percent disease control compared to untreated when an appropriate level of disease damage appears in untreated check leaf segments (5-7 days after application). The compound 9 (from Table T1) at 200 ppm give at least 80% disease control in this test when compared to untreated control leaf disks under the same conditions, which show extensive disease development.

8 Pythium ultimum/Liquid Culture (Seedling Damping Off)

Mycelia fragments and oospores of a newly grown liquid culture of the fungus were directly mixed into nutrient broth (potato dextrose broth). After placing a DMSO solution of test compound into a 96-well format microtiter plate at an application rate of 200 ppm, the nutrient broth containing the fungal mycelia/spore mixture was added. The test plates were incubated at 24° C. and the inhibition of growth was determined photometrically 2-3 days after application. The compounds 1, 2, 3, 4, 5, 6, 7, 8, 9, 10, 11, 12, 13, 14, 15, 16, 17, 18, 19, 20, 21, 25, 26, 27, 29, 30 and 31 (from Table T1) at 200 ppm give at least 80% disease control in this test when compared to untreated control leaf disks under the same conditions, which show extensive disease development.

9 Botryotinia fuckeliana (Botrytis cinerea)/liquid culture (Gray mould):

Conidia of the fungus from cryogenic storage were directly mixed into nutrient broth (Vogels broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 3-4 days after application. The compounds 1, 3, 9, 10, 20, 21, 22, 28 and 31 (from Table T1) at 200 ppm give at least 80% disease control in this test when compared to untreated control leaf disks under the same conditions, which show extensive disease development.

10 Glomerella lagenarium (Colletotrichum Lagenarium)/Liquid Culture (Anthracnose):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was measured photometrically 3-4 days after application. The compounds 1, 2, 3, 4, 5, 6, 7, 8, 9, 10, 12, 13, 16, 17, 18, 20, 25, 26, 27 and 31 (from Table T1) at 200 ppm give at least 80% disease control in this test when compared to untreated control leaf disks under the same conditions, which show extensive disease development.

11 Mycosphaerella arachidis (Cercospora arachidicola)/Liquid Culture (Early Leaf Spot):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The compounds 1, 3, 9, 10, 20, 21, 25, 27, 28 and 31 (from Table T1) at 200 ppm give at least 80% disease control in this test when compared to untreated control leaf disks under the same conditions, which show extensive disease development.

12 Mycosphaerella graminicola (Septoria tritici)/Liquid Culture (Septoria Blotch):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The compounds 1, 2, 3, 4, 5, 6, 7, 8, 9, 10, 12, 13, 16, 17, 18, 19, 20, 25, 26, 27, 28 and 31 (from Table T1) at 200 ppm give at least 80% disease control in this test when compared to untreated control leaf disks under the same conditions, which show extensive disease development.

13 Gaeumannomyces Graminis/Liquid Culture (Take-all of Cereals):

Mycelial fragments of the fungus from cryogenic storage were directly mixed into nutrient broth (PDB potato dextrose broth). After placing a DMSO solution of test compound into a 96-well microtiter plate at an application rate of 200 ppm, the nutrient broth Cp.33, containing the fungal spores is added. The test plates were incubated at 24° C. and the inhibition of growth was determined photometrically 4-5 days after application. The compounds 1, 2, 3, 8, 9, 10, 12, 13, 16, 17, 18, 20 and 28 (from Table T1) at 200 ppm give at least 80% disease control in this test when compared to untreated control leaf disks under the same conditions, which show extensive disease development.

14 Monographella nivalis (Microdochium nivale)/liquid culture (foot rot cereals):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The compounds 1, 3, 8, 9, 10, 11, 12, 13, 14, 15, 16, 17, 18, 20, 22, 23, 24, 25, 26, 27, 29, 30, and 31 (from Table T1) at 200 ppm give at least 80% disease control in this test when compared to untreated control leaf disks under the same conditions, which show extensive disease development.

15 Fusarium culmorum/liquid culture (Head blight):

Conidia of the fungus from cryogenic storage were directly mixed into nutrient broth (PDB potato dextrose broth). After placing a (DMSO) solution of the test compounds into a microtiter plate (96-well format), the nutrient broth containing the fungal spores was added. The test plates were incubated at 24° C. and the inhibition of growth was determined visually 3-4 days after application. The compounds 3, 5, 6, 7, 9, 10, 19, 20, 25, 26, 27 and 31 (from Table T1) at 200 ppm give at least 80% disease control in this test when compared to untreated control leaf disks under the same conditions, which show extensive disease development.

16 Thanatephorus cucumeris (Rhizoctonia solani)/liquid culture (foot rot, damping-off):

Mycelia fragments of a newly grown liquid culture of the fungus were directly mixed into nutrient broth (PDB potato dextrose broth). After placing a DMSO solution of the test compounds into a 96-well microtiter plate at an application rate of 200 ppm, the nutrient broth containing the fungal material was added. The test plates were incubated at 24° C. and the inhibition of growth was determined photometrically 3-4 days after application. The compounds 3, 4, 5, 6, 7, 8, 28 and 31 (from Table T1) at 200 ppm give at least 80% disease control in this test when compared to untreated control leaf disks under the same conditions, which show extensive disease development.

17 Sclerotinia sclerotiorum/liquid culture (cottony rot):

Mycelia fragments of a newly grown liquid culture of the fungus were directly mixed into nutrient broth (PDB potato dextrose broth). After placing a (DMSO) solution of the test compounds into a microtiter plate (96-well format) the nutrient broth containing the fungal material was added. The test plates were incubated at 24° C. and the inhibition of growth was determined visually 3-4 days after application. The compounds 1, 3, 9, 10, 20, 25, 27, 28 and 31 (from Table T1) at 200 ppm give at least 80% disease control in this test when compared to untreated control leaf disks under the same conditions, which show extensive disease development.

1. A method for controlling or preventing for infestation of plants or plant propagation material and/or harvested food crops susceptible to microbial attack by treating plants or plant propagation material and/or harvested food crops with an effective amount of a benzoxaborole derivative according to formula (I) 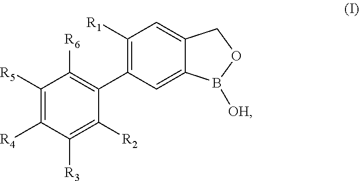
wherein
R₁ is selected from H, fluorine, chlorine, bromine, cyano, nitro, C₁-C₄alkyl which can be substituted by one to five R₉, C₁-C₄alkoxy which can be substituted by one to five R⁹, and C₁-C₄haloalkyl which can be substituted by one to five R₉ₐ;
R₂, R₃, R₄, R₅ and R₆ are independently selected from H, fluorine, chlorine, bromine, cyano, nitro, amino, hydroxyl, C₁-C₆alkyl which can be substituted by one to five R₉, C₁-C₆haloalkyl which can be substituted by one to five R₉ₐ, C₃-C₅cycloalky which can be substituted by one to five R₉, C₂-C₆alkenyl which can be substituted by one to five R₉, C₂-C₆alkynyl which can be substituted by one to five R₉, C₁-C₆alkoxy which can be substituted by one to five R₉, and C₁-C₆haloalkoxy which can be substituted by one to five R₉ₐ;
or R₂, R₃, R₄, R₅ and R₆ are independently selected from —NR₇R₈, C₃-C₆cycloalkyl, —C(O)(OH), —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O)(C₁₋₄ alkyl), —C(═N—O—(C₁₋₄ alkyl)-H, and —C(═N—O—(C₁₋₄ alkyl)-C₁-C₄alkyl;
or R₂, R₃, R₄, R₅ and R₆ are independently selected from a -X-(6 to 10 membered-aryl) group which can be substituted by one to five substituents selected halogen, C₁-C₄alkyl, C₁-C₄haloalkyl, C₁-C₄alkoxy, —CN, —NO₂, —NR⁶R⁷, C₃-C₆cycloalkyl;
or R₂, R₃, R₄, R₅ and R₆ are independently selected from a -X-linked-5- or 6-membered heteroaryl group which comprises one or two or three heteroatoms selected from or two N, O and S which can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
or R₂ and R₃, R₃ and R₄, R₄ and R₅, R₅ and R₆ can form a five- or six-membered annellated ring which comprises one or two or three heteroatoms selected from N, O and S and this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R⁷ and R⁸ are independently selected from H, —C₁₋₄alkyl —C₂₋₄alkenyl, —C₂₋₄alkynyl or combine with the interjacent nitrogen to form a five- or six-membered ring which may comprise one or two or three heteroatoms selected from N, O or S atoms in addition to the interjacent nitrogen atom this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R₉ is independently selected from halogen, C₁-C₄alkyl, C₁-C₄haloalkyl, C₁-C₄alkoxy, C₁-C₄haloalkoxy, —OH, —CN, —NO₂;
R₉ₐ is independently selected from C₁-C₄alkyl, C₁-C₄haloalkyl, C₁-C₄alkoxy, C₁-C₄haloalkoxy, —OH, —CN, —NO₂;
X is a direct bond or a bridge selected from —O—, —S(O)ₘ— or —NH—;
m is 0, 1 or 2;
or an agronomically acceptable salt or N-oxide thereof.

2. A compound of formula (I) 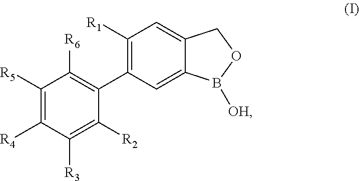
wherein
R₁ is selected from fluorine, chlorine, bromine, cyano, nitro, C₁-C₄alkyl which can be substituted by one to five R₉, C₁-C₄alkoxy which can be substituted by one to five R⁹, and C₁-C₄haloalkyl which can be substituted by one to five R₉ₐ;
R₂, R₃, R₄, R₅ and R₆ are independently selected from H, fluorine, chlorine, bromine, cyano, nitro, amino, hydroxyl, C₁-C₆alkyl which can be substituted by one to five R₉, C₁-C₆haloalkyl which can be substituted by one to five R₉ₐ, C₃-C₅cycloalky which can be substituted by one to five R₉, C₂-C₆alkenyl which can be substituted by one to five R₉, C₂-C₆alkynyl which can be substituted by one to five R₉, C₁-C₆alkoxy which can be substituted by one to five R₉, and C₁-C₆haloalkoxy which can be substituted by one to five R₉ₐ;
or R₂, R₃, R₄, R₅ and R₆ are independently selected from —NR₇R₈, C₃-C₆cycloalkyl, —C(O)(OH), —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —C(═N—O—(C₁₋₄ alkyl)-H, and —C(═N—O—(C₁₋₄ alkyl)-C₁-C₄alkyl;
or R₂, R₃, R₄, R₅ and R₆ are independently selected from a -X-(6 to 10 membered-aryl) group which can be substituted by one to five substituents selected halogen, C₁-C₄alkyl, C₁-C₄haloalkyl, C₁-C₄alkoxy, —CN, —NO₂, —NR⁶R⁷, C₃-C₆cycloalkyl;
or R₂, R₃, R₄, R₅ and R₆ are independently selected from a -X-linked-5- or 6-membered heteroaryl group which comprises one or two or three heteroatoms selected from or two N, O and S which can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
or R₂ and R₃, R₃ and R₄, R₄ and R₅, R₅ and R₆ can form a five- or six-membered annellated ring which comprises one or two or three heteroatoms selected from N, O and S and this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R⁷ and R⁸ are independently selected from H, —C₁₋₄alkyl —C₂₋₄alkenyl, —C₂₋₄alkynyl or combine with the interjacent nitrogen to form a five- or six-membered ring which may comprise one or two or three heteroatoms selected from N, O or S atoms in addition to the interjacent nitrogen atom this heterocyclic ring can be substituted by one to five substituents selected from halogen, C₁-C₄alkyl, C₁-C₄haloalkyl, C₁-C₄alkoxy, —CN, —NO₂, —NR⁶R⁷, C₃-C₆cycloalkyl;
R₉ is independently selected from halogen, C₁-C₄alkyl, C₁-C₄haloalkyl, C₁-C₄alkoxy, C₁-C₄haloalkoxy, —OH, —CN, —NO₂;
R₉ₐ is independently selected from C₁-C₄alkyl, C₁-C₄haloalkyl, C₁-C₄alkoxy, C₁-C₄haloalkoxy, —OH, —CN, —NO₂;
X is a direct bond or a bridge selected from —O—, —S(O)ₘ— or —NH—;
m is 0, 1 or 2;
or an agronomically acceptable salt or N-oxide thereof.

3. The compound of formula (I) according to claim 2 characterized in that
R₁ is fluorine, chlorine, bromine, cyano, nitro, or C₁-C₄alkyl.

4. The compound of formula (I) according to claim 2 characterized in that
R₂, R₃, R₄, R₅ and R₆ independently are H, fluorine, chlorine, bromine, cyano, nitro, amino,
or R₂, R₃, R₄, R₅ and R₆ independently are a -X-phenyl can be substituted by one to five substituents selected from F, Cl, Br,
or R₂, R₃, R₄, R₅ and R₆ independently are a -X-linked-5- or 6-membered heteroaryl group which comprises one or two or three heteroatoms selected from or two N, O and S, can be substituted by one to five substituents selected from halogen, C₁-C₄alkyl, C₃-C₆cycloalkyl,
or R₂ and R₃, R₃ and R₄, R₄ and R₅, R₅ and R₆ can form a five- or six-membered annellated ring which comprises one or two or three heteroatoms selected from or two N, O and S and this heterocyclic ring can be substituted by one to five substituents selected from C₁-C₄alkyl, C₃-C₆cycloalkyl.

5. The compound of formula (I) according to claim 2 characterized in that
R₂, R₃, R₄, R₅ and R₆ are independently selected from H, fluorine, chlorine, cyano, or R₂, R₃, R₄, R₅ and R₆ independently are a -X-linked-5- or 6-membered heteroaryl group which comprises one or two or three heteroatoms selected from or two N, O and S can be substituted by one to five substituents selected from C₁-C₄alkyl, C₃-C₆cycloalkyl,
or R₂ and R₃, R₃ and R₄, R₄ and R₅, R₅ and R₆ can form a five- or six-membered annellated ring which comprises one or two or three heteroatoms selected from or two N, O and S can be substituted by one to five substituents selected from C₃-C₆cycloalkyl.

6. The compound of formula (I) according to claim 2 characterized in that
X designates a direct bond or —NH—.

7. A compound Compounds of formula (VIII) 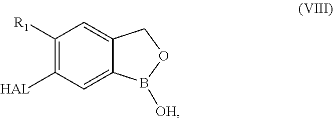
wherein
HAL is halogen;
and R₁ is H, fluorine, chlorine, bromine, cyano, nitro, C₁-C₄alkyl, C₁-C₄alkoxy, or C₁-C₄haloalkyl.

8. The method of claim 1, wherein controlling further includes controlling at least one of infestation of useful plants by phytopathogenic microorganisms and controlling phytopathogenic diseases on useful plants or plant propagation material thereof, the method comprising applying a compound of formula (I) as defined in claim 3 to the plants, to parts thereof or the locus thereof.

9. A composition for controlling and protecting against phytopathogenic microorganisms, comprising a compound of formula (I) as defined in claim 2 and at least one addition inert ingredient.

10. (canceled)

11. The composition of claim 9 further comprising at least one additional active ingredient.

12. The method of claim 1, wherein
R₁ is fluorine, chlorine, bromine, cyano, nitro, or C₁-C₄alkyl;
R₂, R₃, R₄, R₅ and R₆ independently are H, fluorine, chlorine, bromine, cyano, nitro, amino,
or R₂, R₃, R₄, R₅ and R₆ independently are a -X-phenyl can be substituted by one to five substituents selected from F, Cl, Br,
or R₂, R₃, R₄, R₅ and R₆ independently are a -X-linked-5- or 6-membered heteroaryl group which comprises one or two or three heteroatoms selected from or two N, O and S, can be substituted by one to five substituents selected from halogen, C₁-C₄alkyl, C₃-C₆cycloalkyl,
or R₂ and R₃, R₃ and R₄, R₄ and R₅, R₅ and R₆ can form a five- or six-membered annellated ring which comprises one or two or three heteroatoms selected from or two N, O and S and this heterocyclic ring can be substituted by one to five substituents selected from C₁-C₄alkyl, C₃-C₆cycloalkyl.
